(19) United States
(12) Patent Application Publication
(10) Pub. No.: US 2019/0100961 A1
(43) Pub. Date: Apr. 4, 2019

(54) MOTORIZED ROLLER SHADE CONFIGURATIONS, SYSTEMS, METHODS OF USE, AND INSTALLATION

(71) Applicants: Ben Kutell, Coral Gables, FL (US); Darrin Brunk, Gulf Breeze, FL (US); Eugene Demestre, Manakin Sabot, VA (US)

(72) Inventors: Ben Kutell, Coral Gables, FL (US); Darrin Brunk, Gulf Breeze, FL (US); Eugene Demestre, Manakin Sabot, VA (US)

(21) Appl. No.: 15/937,370

(22) Filed: Mar. 27, 2018

Related U.S. Application Data
(60) Provisional application No. 62/477,060, filed on Mar. 27, 2017.

(51) Int. Cl. E06B 9/72; E06B 9/62; E06B 9/50; E06B 9/44

(52) U.S. Cl. CPC E06B 9/72; E06B 9/62; E06B 2009/6809; E06B 9/44; E06B 9/50

(57) ABSTRACT

A motorized roller shade system is presented that includes a roller tube, shade material connected to the roller tube, a motor and a counterbalance assembly positioned within the roller tube, a motor controller connected to the motor and configured to control operation of the motor. The motorized roller shade system is powered by electrical connection to one or more batteries positioned either within the roller tube or external to the roller tube, or alternatively through an electrical connection to a lead that supplies power from an external power source. The motorized roller shade is controlled wirelessly through a wireless control as well as through a hardwired control when connected by a lead. The motorized roller shade may be installed in a variety of manners.

### CROSS REFERENCE TO RELATED APPLICATIONS

This application claims the benefit of U.S. Patent and Trademark Office Provisional Application No. 62/477,060 which was filed on Mar. 27, 2017, the entirety of which is incorporated herein fully by reference.

### FIELD OF THE DISCLOSURE

This disclosure relates generally to motorized window shades. More specifically, and without limitation, this disclosure relates to various configurations of motorized roller shades and improved manners of installation and use of motorized roller shades.

### BACKGROUND OF THE DISCLOSURE

Motorized window shades are old and well known in the art. There are countless forms of motorized window shades. A number of entities manufacture various motorized window shades including: QMotion Advanced Shading Systems, having an address of 3400 Copter Road, Pensacola, Fla. 32514; Solarfective Products Limited, having an address of 55 Hymus Rd, Scarborough, ON MIL 2C6, Canada; Lutron Electronics, Inc. having an address of 7200 Suter Road, Coopersburg, Pa. 18036-1299; HunterDouglas, having an address of 1 Blue Hill Plaza, Pearl River, N.Y. 10965; MechoSystems having an address of 42-03 35th Street, Long Island City, N.Y. 11101; Somfy Systems, having an address of 121 Herrod Blvd, Dayton, N.J. 08810; Crestron, having an address of 15 Volvo Drive, Rockleigh, N.J. 07647, to name a few.

As will be further described herein, there are a number of common motorized window shade configurations. Broad categories of motorized window shade configurations include: roller shades, honeycomb shades, slat shades (also known as Venetian shades), roman shades, drapery rods, and drapery tracks, to name a few. These motorized window shade configurations can be separated into laterally opening motorized window shades, where the shade material moves laterally from side-to-side to cover and uncover the window, and vertically opening motorized window shades, where the shade material is raised and lowered to cover and uncover the window.

Motorizing window shades provide a great number of substantial advantages over manually operated shades such as convenience, energy efficiency, and increased privacy, among countless others. By motorizing window shades this allows for remote operation of the window shade. Common forms of remote operation of motorized shades include use of a wireless control or remote application or tying the motorized shade into a home automation system or alarm system.

Motorizing window shades allows a plurality of shades to be raised and lowered with ease thereby allowing for easy optimization of the use of natural light, optimization of privacy, and optimization of energy efficiency by letting warming light into the building when it is cold outside and preventing warming light from entering the building when it is warm outside. These benefits are particularly evident in large homes or commercial buildings that include a great number of windows and a corresponding number of window shades. Motorizing these window shades allows for these motorized window shades to be precisely controlled, en masse, without the manual labor previously required to do so.

While motorized window shades provide a great number of advantages, motorized window shades present various challenges. Namely, installation of motorized window shades can be particularly challenging. This is due in part to the need to supply power to the motorized window shades. In addition, while commercially available motorized window shades provide some advantages, the commercially available motorized window shades lack various features, configurations, or improvements that would make the motorized window shades easier to use, more efficient, and provide improved functionality.

Thus, an object of the disclosure is to provide motorized window shades that improve upon the present state of the art.

Another object of the disclosure is to provide motorized window shades that are easier to install over prior art motorized window shades.

Yet another object of the disclosure is to provide motorized window shades that can be installed in new ways.

Another object of the disclosure is to provide motorized window shades that provide improved functionality over prior art motorized window shades.

Yet another object of the disclosure is to provide motorized window shades that provide improved features over prior art motorized window shades.

Another object of the disclosure is to provide motorized window shades that can be utilized with two way communication.

Yet another object of the disclosure is to provide motorized window shades that can be installed on a variety of structures.

Another object of the disclosure is to provide motorized window shades that can be installed in a variety of manners.

Yet another object of the disclosure is to provide motorized window shades that can be used in a predictive manner.

Another object of the disclosure is to provide motorized window shades that are energy efficient.

Yet another object of the disclosure is to provide motorized window shades that operate quietly.

Another object of the disclosure is to provide motorized window shades that can be powered in a variety of manners.

Yet another object of the disclosure is to provide motorized window shades that can be controlled in a variety of manners.

Another object of the disclosure is to provide motorized window shades that can be attached to vertical window frame members.

Yet another object of the disclosure is to provide motorized window shades that can be attached to horizontal window frame members.

Another object of the disclosure is to provide motorized window shades that can be installed by clamping onto window frame members.

Yet another object of the disclosure is to provide motorized window shades that vent heated air into a plenum above a ceiling.

Another object of the disclosure is to provide motorized window shades that are high quality.

Yet another object of the disclosure is to provide motorized window shades that have a long useful life.

Another object of the disclosure is to provide motorized window shades that can be installed prior to completion of construction.

Yet another object of the disclosure is to provide motorized window shades that are easy to use.

Another object of the disclosure is to provide motorized window shades that are easy to install.

Yet another object of the disclosure is to provide motorized window shades that save time.

Another object of the disclosure is to provide motorized window shades that save labor.

Yet another object of the disclosure is to provide motorized window shades that are safe to install.

Another object of the disclosure is to provide motorized window shades that are safe to use.

Yet another object of the disclosure is to provide motorized window shades that are convenient to use.

Another object of the disclosure is to provide motorized window shades that are energy efficient.

Yet another object of the disclosure is to provide motorized window shades that have a rugged design.

Another object of the disclosure is to provide motorized window shades that can be used in association with a building control system or automation system.

These and countless other objects, features, or advantages of the disclosure will become apparent from the specification and claims.

### SUMMARY OF THE DISCLOSURE

A motorized roller shade system is presented that includes a roller tube, shade material connected to the roller tube, a motor and a counterbalance assembly positioned within the roller tube, a motor controller connected to the motor and configured to control operation of the motor. The motorized roller shade system is powered by electrical connection to one or more batteries positioned either within the roller tube or external to the battery tube, or alternatively through an electrical connection to a lead that supplies power from an external power source. The motorized roller shade is controlled wirelessly through a wireless control as well as through a hardwired control when connected by a lead. The motorized roller shade may be installed in a variety of manners. In one arrangement, the motorized roller shade is installed using mounting brackets that are installed during construction and after construction is completed the motorized roller shade is clipped into the mounting brackets using mounting clips thereby saving time and effort. In another arrangement, the motorized roller shade is installed using window frame clamps that clamp onto the window frame members of a window without fasteners penetrating the window frame members. In another arrangement, the motorized roller shade is installed into a pushup hood that receives a pushup clip therein. In one arrangement, the motorized roller shade is installed flush with and/or sealed to the ceiling while leaving a gap between the window and the shade material that facilitates venting of heated air into the plenum positioned above the ceiling. As one configuration, the roller shade is installed with a manual control assembly that is easily replaced by sliding the manual control assembly outward from the end of the roller tube and replacing it with a motor control assembly that is slid into the end of the roller shade while the same counterbalance assembly facilitates manual movement as well as motorized movement.

### BRIEF DESCRIPTION OF THE DRAWINGS

FIG. 1 is a front elevation view of a window frame clamp, the view showing the clamping member formed of a center wall that connects to a pair of end walls that form a receiving space therein; the view showing fastening members formed of a fastener and a tightening member connected to the end walls with a pad connected to the inward end of the fasteners; the view showing a receiving space between the center wall and opposing end walls, and between opposing fastening members and pads, the receiving space formed to receive a window frame member that the window frame clamp attaches to; the view showing a mounting plate connected to the clamping member and extending outwardly therefrom;

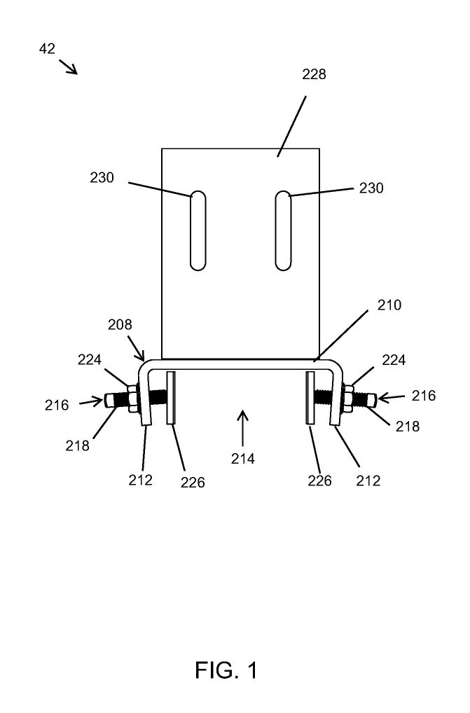

FIG. 2 is a rear elevation view of a window frame clamp, the view showing the clamping member formed of a center wall that connects to a pair of end walls that form a receiving space therein; the view showing fastening members formed of a fastener and a tightening member connected to the end walls with a pad connected to the inward end of the fasteners; the view showing a receiving space between the center wall and opposing end walls, and between opposing fastening members and pads, the receiving space formed to receive a window frame member that the window frame clamp attaches to; the view showing a mounting plate connected to the clamping member and extending outwardly therefrom;

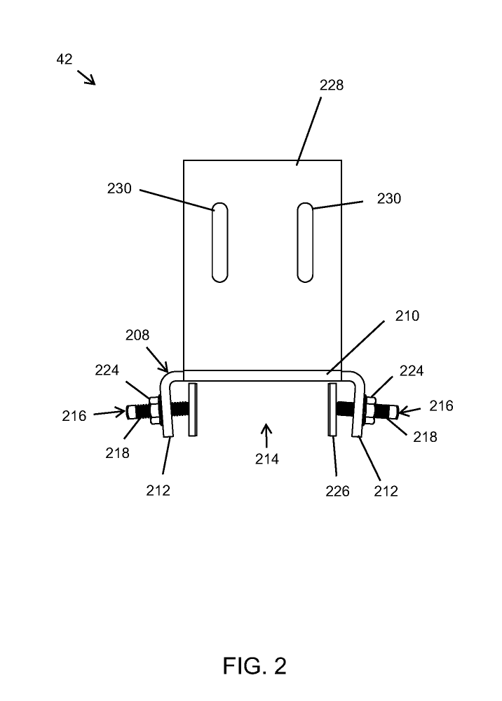

FIG. 3 is a side elevation view of a window frame clamp, the view showing a pair of fastening members formed of a fastener and a tightening member connected to the end wall of a clamping member; the view showing a mounting plate extending in approximate perpendicular alignment to the clamping member;

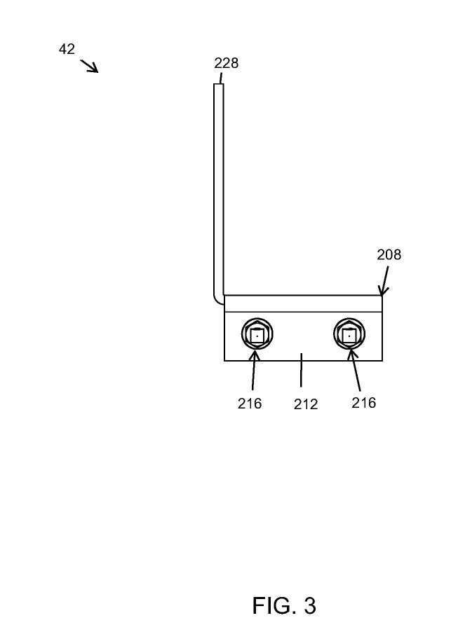

FIG. 4 is a perspective view of the rear window frame clamp, the view showing the clamping member formed of a center wall that connects to a pair of end walls that form a receiving space therein; the view showing fastening members formed of a fastener and a tightening member connected to the end walls with a pad connected to the inward end of the fasteners; the view showing a receiving space between the center wall and opposing end walls, and between opposing fastening members and pads, the receiving space formed to receive a window frame member that the window frame clamp attaches to; the view showing a mounting plate connected to the clamping member and extending outwardly therefrom;

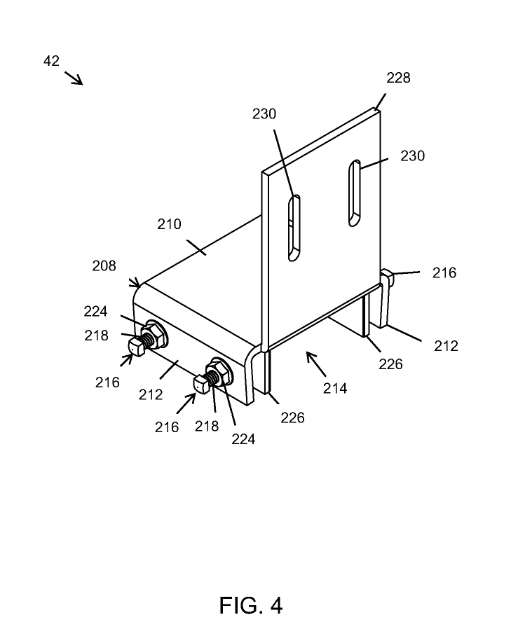

FIG. 5 is a perspective view of the front a window frame clamp, the view showing the clamping member formed of a center wall that connects to a pair of end walls that form a receiving space therein; the view showing fastening members formed of a fastener and a tightening member connected to the end walls with a pad connected to the inward end of the fasteners; the view showing a receiving space between the center wall and opposing end walls, and between opposing fastening members and pads, the receiving space formed to receive a window frame member that the window frame clamp attaches to; the view showing a mounting plate connected to the clamping member and extending outwardly therefrom;

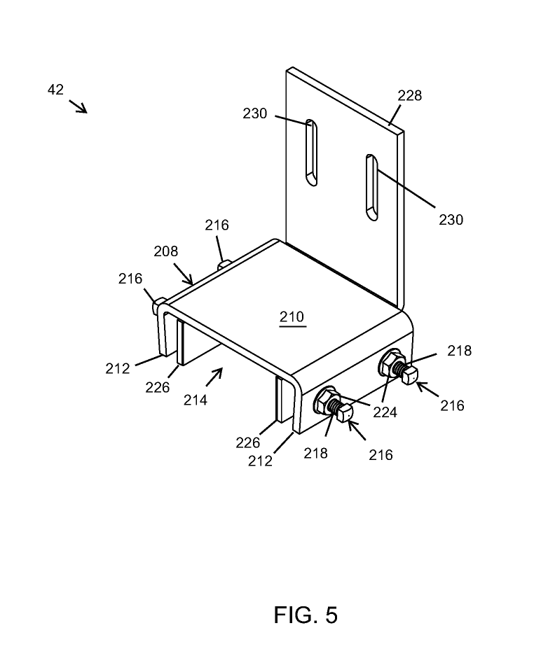

FIG. 6 is an exploded perspective view of FIG. 4;

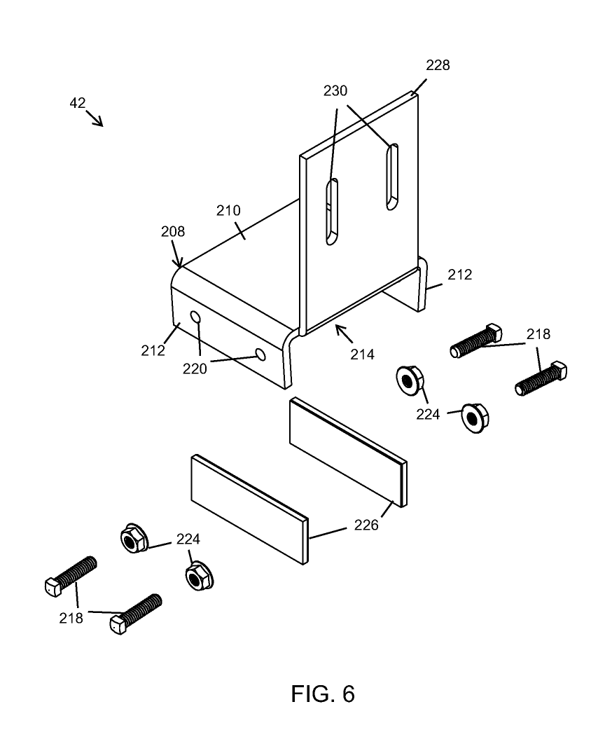

FIG. 7 is an exploded perspective view of FIG. 5;

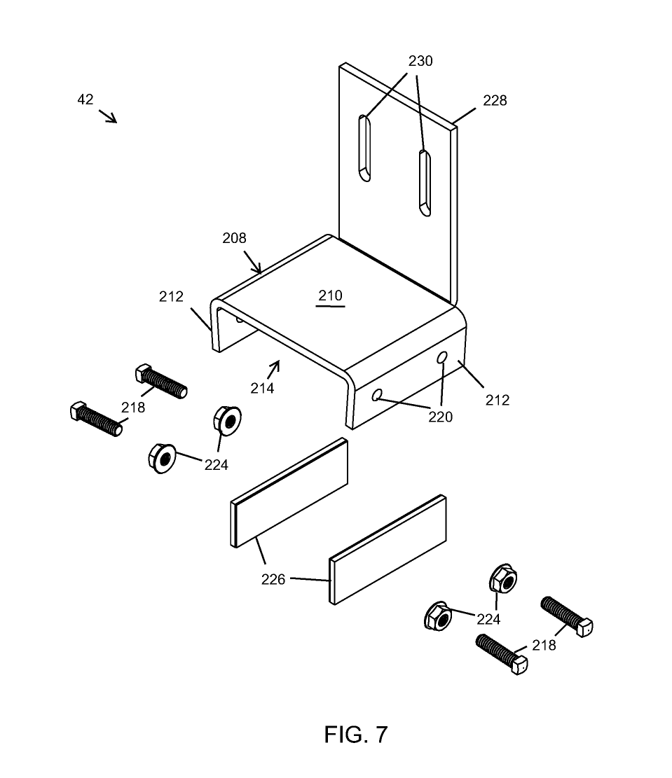

FIG. 8 is a side elevation view of a motor control assembly, the view showing a lead having a socket entering the outward end of the motor control assembly; the view showing the stop collar positioned at the outward end of the motor control assembly having an axle and bearing members; the view showing the motor housing holding the printed circuit board therein; the view showing a drive wheel having mounting features connected to an output shaft of a gear box assembly at the inward end of the motor control assembly;

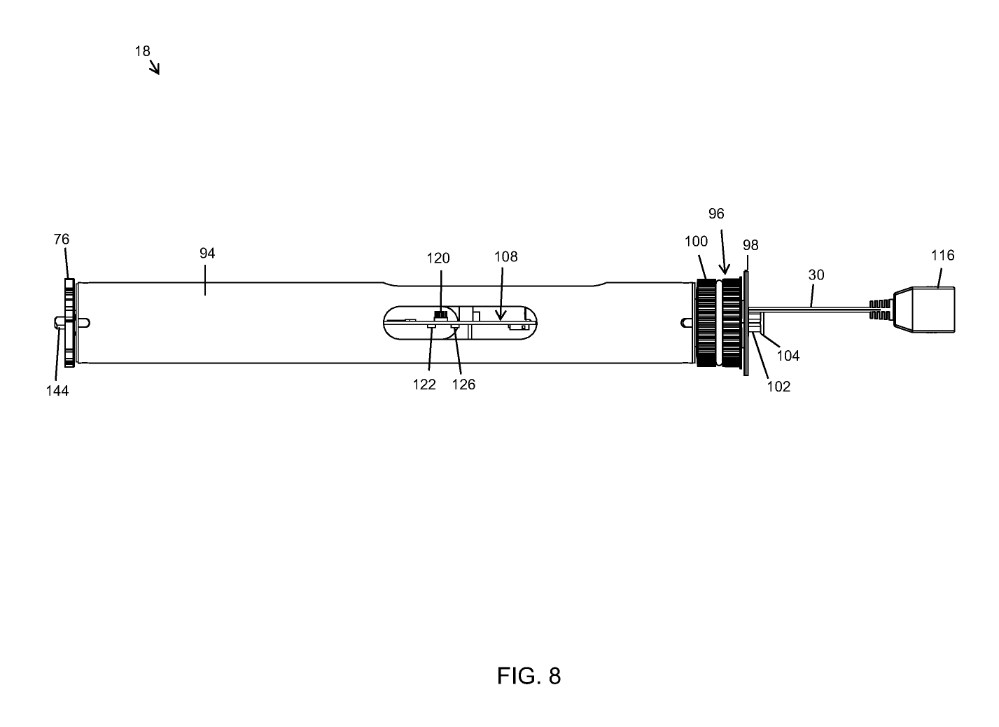

FIG. 9 is another side elevation view of a motor control assembly, the view similar to the view shown in FIG. 8 taken at a different angle;

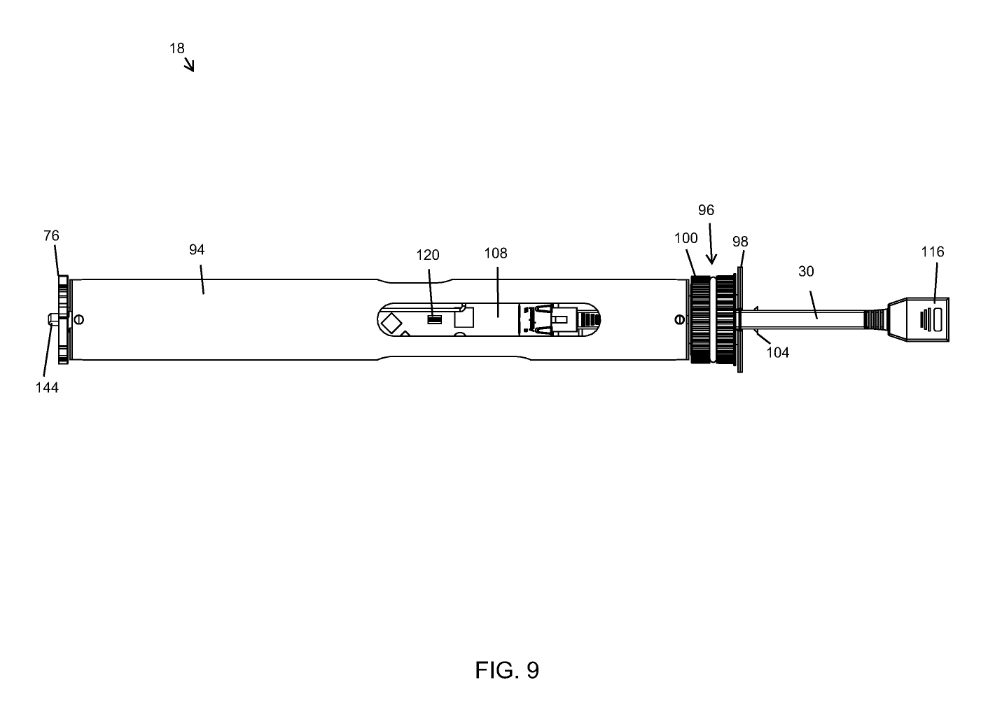

FIG. 10 is an end elevation view of a motor control assembly;

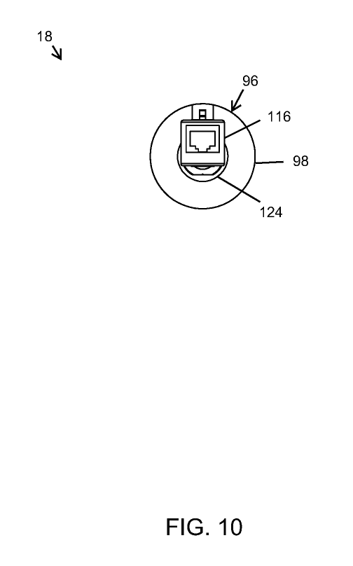

FIG. 11 is a perspective view of a motor control assembly, the view showing a lead having a socket entering the outward end of the motor control assembly; the view showing the stop collar positioned at the outward end of the motor control assembly having an axle and bearing members; the view showing the motor housing holding the printed circuit board therein; the view showing a drive wheel having mounting features at the inward end of the motor control assembly;

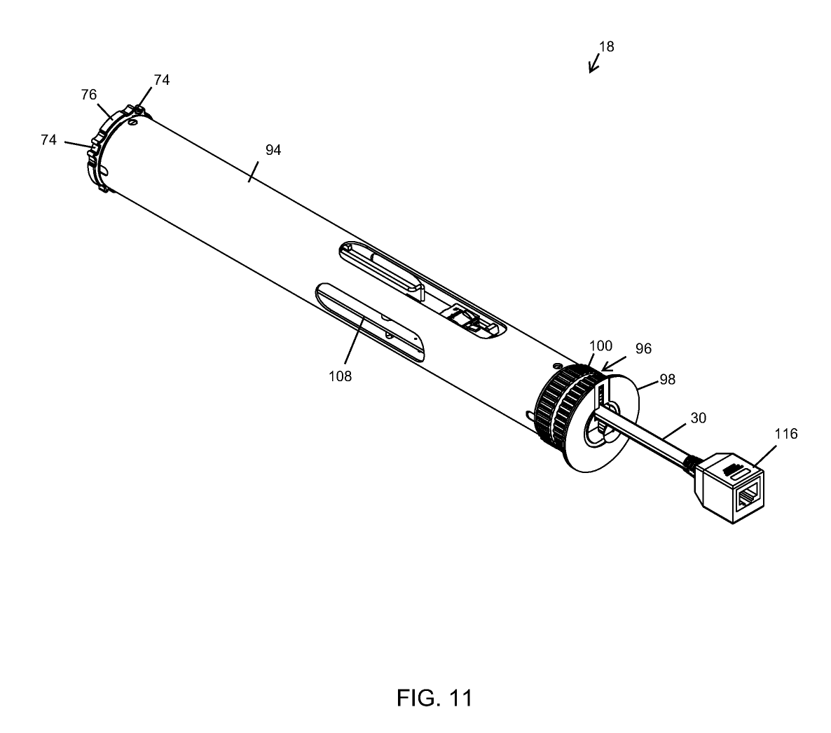

FIG. 12 is a side cut-away elevation view of a motor control assembly, the view showing a lead having a socket entering the outward end of the motor control assembly; the view showing the stop collar positioned at the outward end of the motor control assembly having an axle and bearing members; the view showing the motor housing holding the printed circuit board therein; the view showing the motor and gear box assembly connected to the inward end of the printed circuit board; the view showing a drive wheel having mounting features connected to an output shaft of a gear box assembly at the inward end of the motor control assembly; the view showing the lead connecting to a socket of the printed circuit board by a plug;

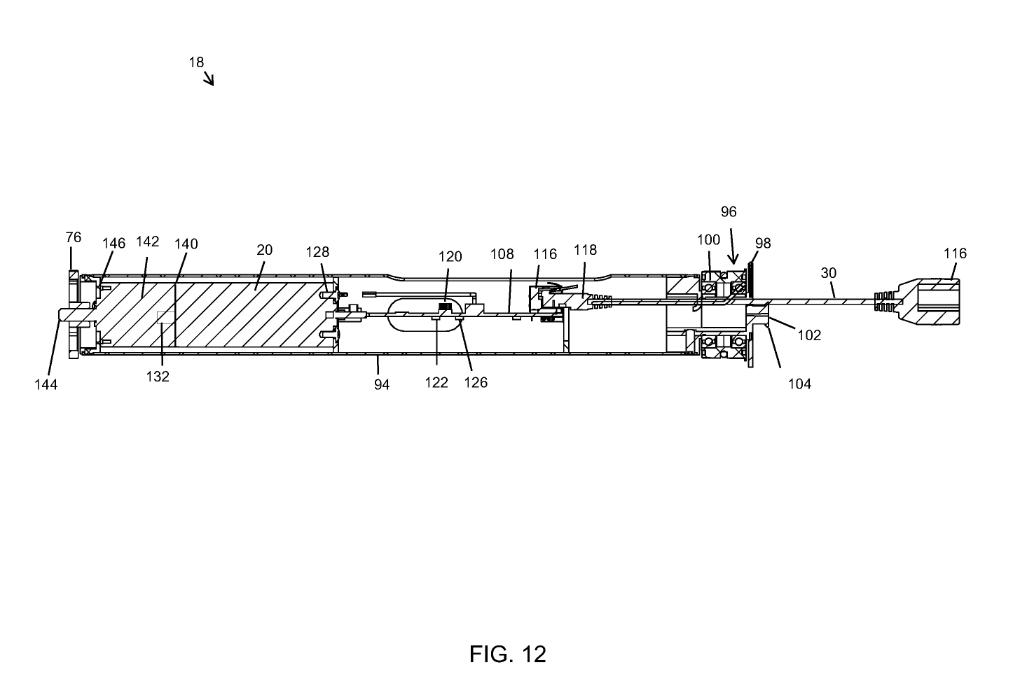

FIG. 13 is an exploded perspective view of the motor control assembly, the view taken from the outward end of the motor control assembly;

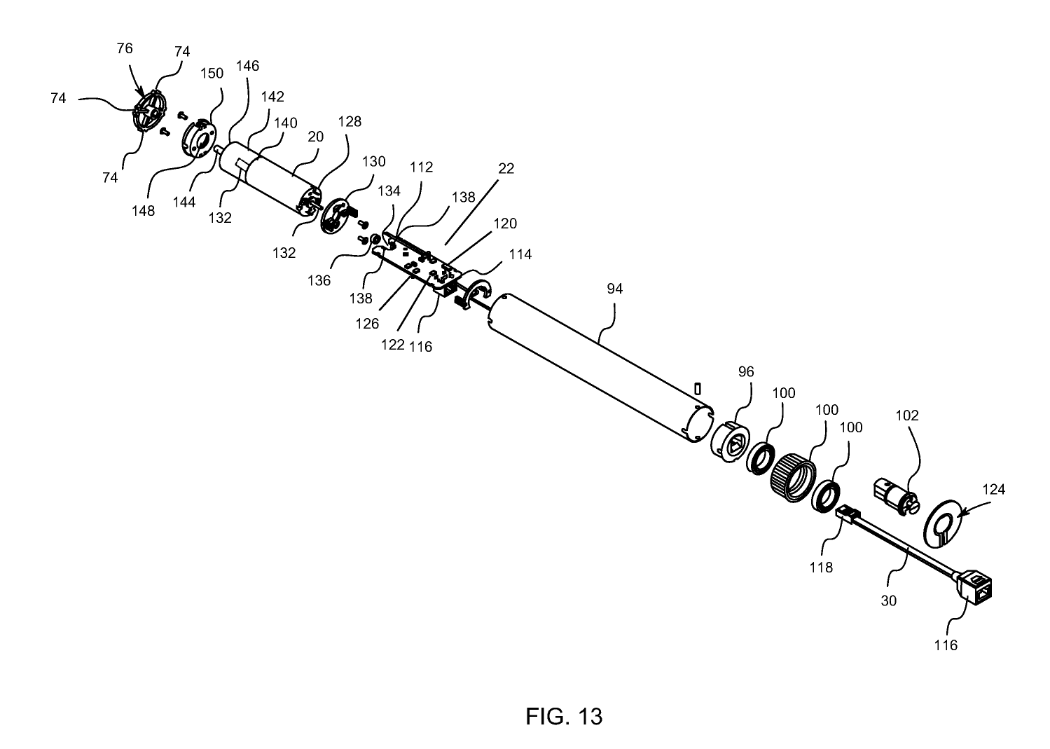

FIG. 14 is another exploded perspective view of the motor control assembly, the view taken from the outward end of the motor control assembly;

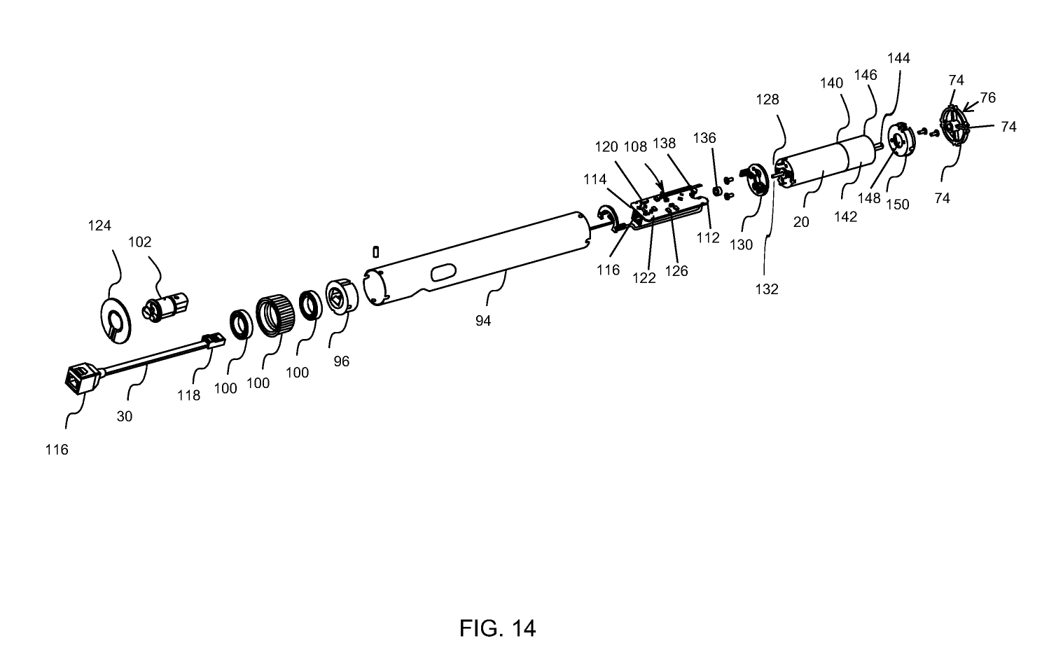

FIG. 15 is a side elevation view of a counterbalance assembly, the view showing a stop collar connected to the exterior end of the counterbalance assembly having an axle extending outwardly therefrom; the view showing a pair of spring housings connected to the inward end of the stop collar by locking features, the two spring housings connected to one another by locking features; the view showing a cover connected to the inward end of the two joined spring housings;

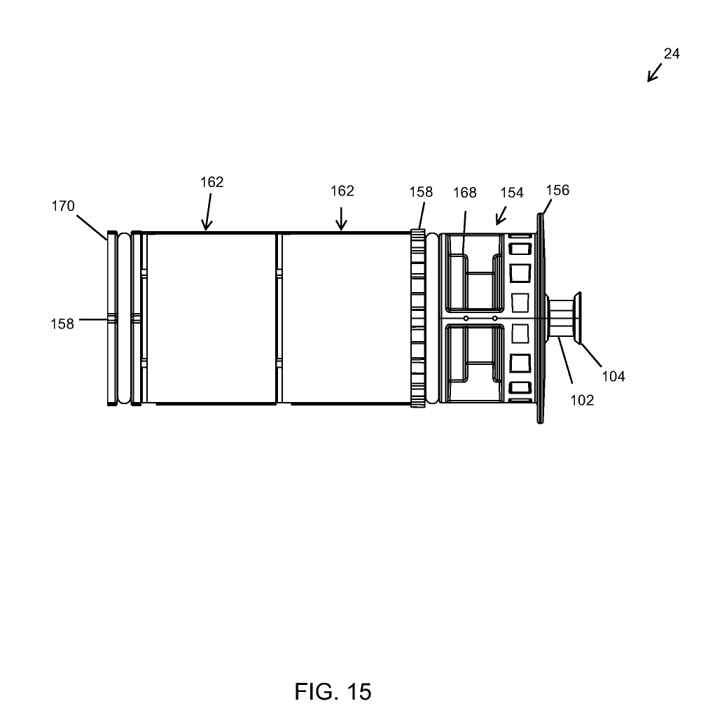

FIG. 16 is a side elevation view of a counterbalance assembly from another angle, the view showing a stop collar connected to the exterior end of the counterbalance assembly having an axle extending outwardly therefrom; the view showing a pair of spring housings connected to the inward end of the stop collar by locking features, the two spring housings connected to one another by locking features; the view showing a cover connected to the inward end of the two joined spring housings; the view showing the outward ends of springs held within the spring housings;

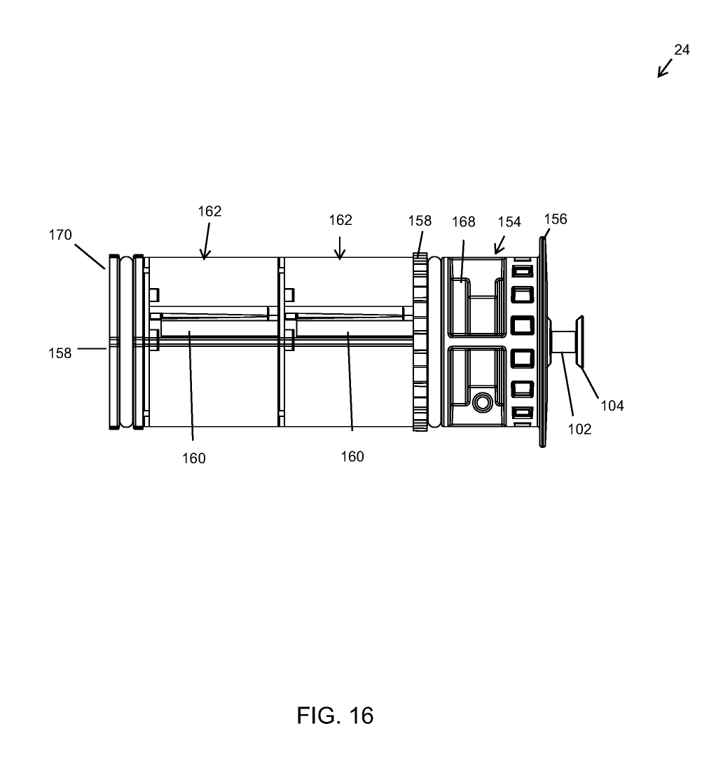

FIG. 17 is a side elevation view of the exterior end of a counterbalance assembly, the view showing a stop collar connected to the exterior end of the counterbalance assembly having an axle extending outwardly therefrom;

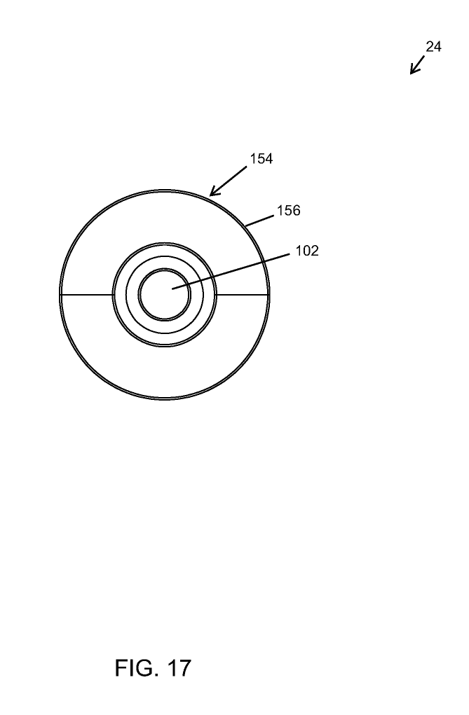

FIG. 18 is a perspective view of a counterbalance assembly from another angle, the view showing a stop collar connected to the exterior end of the counterbalance assembly having an axle extending outwardly therefrom; the view showing a pair of spring housings connected to the inward end of the stop collar by locking features, the two spring housings connected to one another by locking features; the view showing a cover connected to the inward end of the two joined spring housings; the view showing the outward ends of springs held within the spring housings;

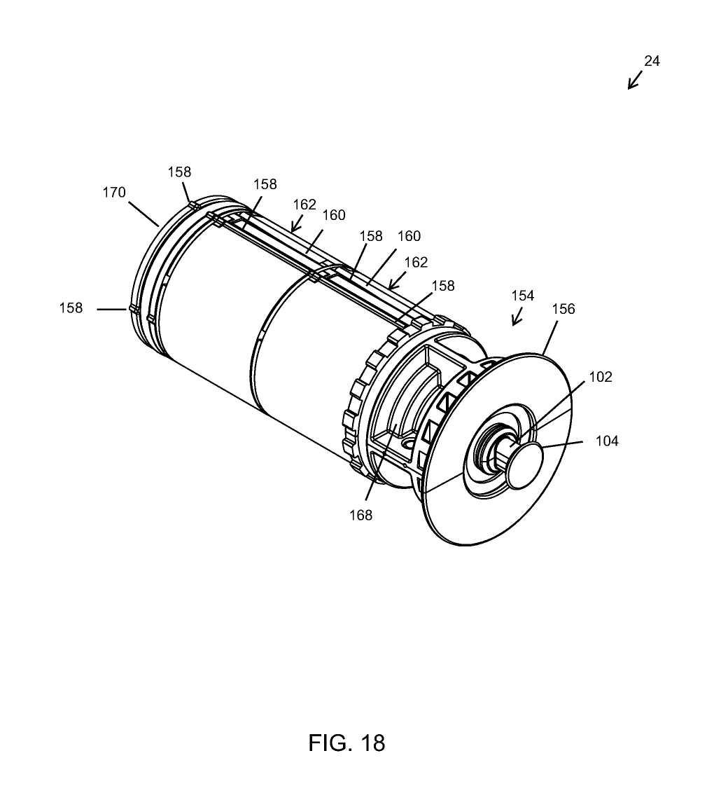

FIG. 19 is a side cut-away elevation view of a counterbalance assembly from another angle, the view showing a stop collar connected to the exterior end of the counterbalance assembly having an axle extending outwardly therefrom; the view showing a pair of spring housings connected to the inward end of the stop collar by locking features, the two spring housings connected to one another by locking features; the view showing a cover connected to the inward end of the two joined spring housings; the view showing the outward ends of springs held within the spring housings;

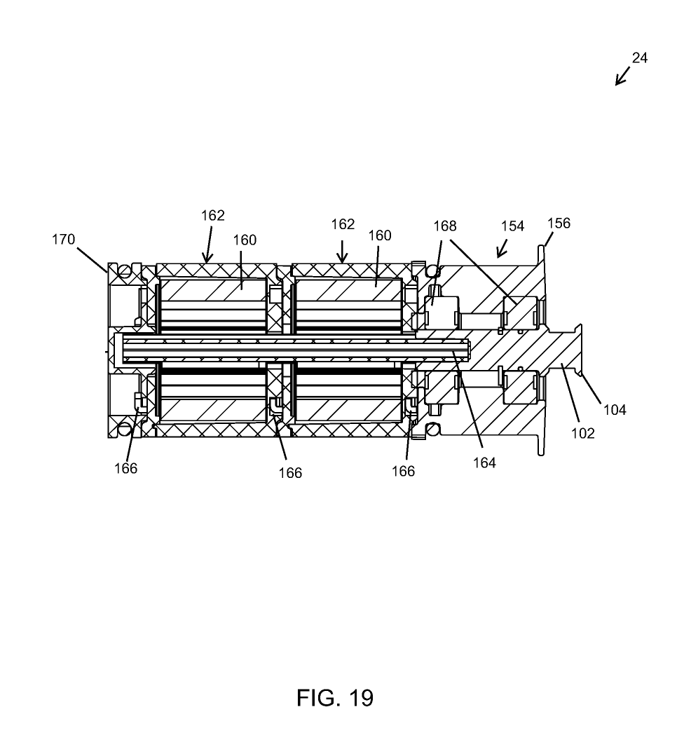

FIG. 20 is an exploded perspective view of a counterbalance assembly, the view showing the shaft that connects to the axle and extends through the center of the spring housings, the view showing the shaft having features in its exterior surface that engage the interior end of the springs and holds the interior end of the spring when rotated in a first direction thereby allowing loading of a force within the springs when rotated in the first direction but allows the interior end of the spring to jump over the features in the shaft when the counterbalance assembly is over rotated in a second direction which is opposite the first direction so as to prevent back winding the springs or breaking the springs; the view also showing the locking features of the spring housings, stop collar and cover that engage one another that allow the modular assembly of the counterbalance assembly from any number of spring housings in a quick, efficient and easy manner, allowing the assembly of a counterbalance assembly using any combination of springs;

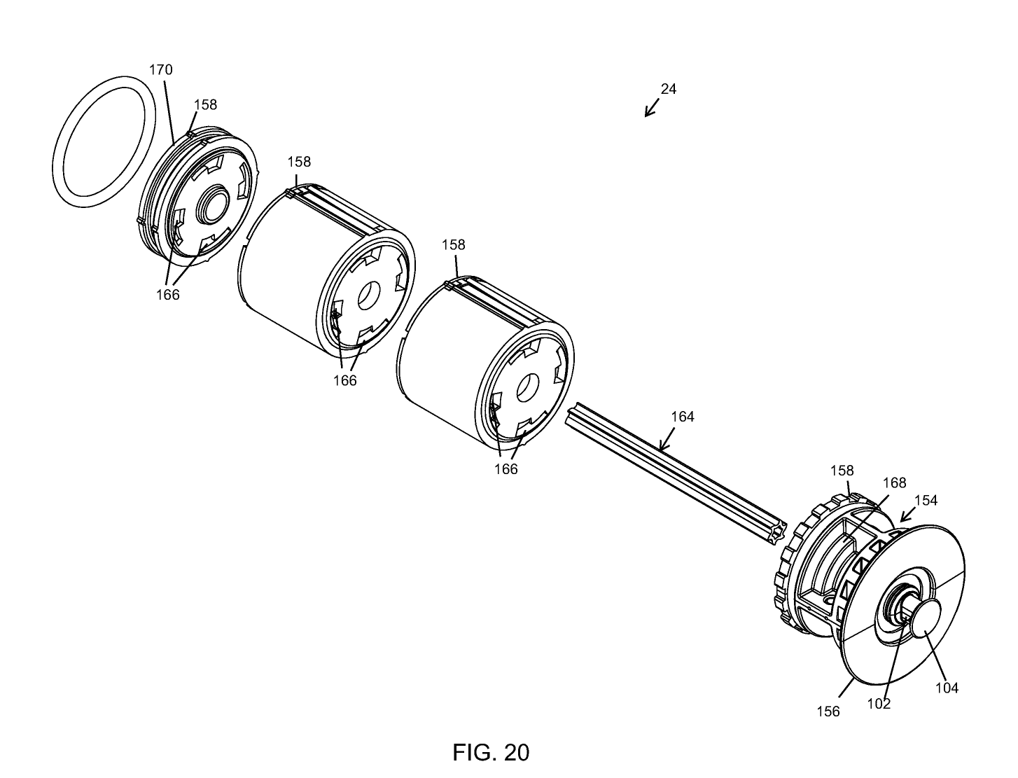

FIG. 21 is a side elevation view of a mounting bracket and mounting clip arrangement, the view showing the mounting bracket having an upper wall, back wall, corner section and a forward wall, the mounting bracket having mounting features including a recess in the rearward surface of the forward wall with a corresponding stop surface in the upper wall and a recess in the forward surface of rear wall with a corresponding stop surface; the view showing the mounting clip having an upper wall, back wall, corner section and a forward wall, the mounting clip having mounting features including a mounting arm having a corresponding stop surface in the upper wall and a protrusion having a corresponding stop surface in the back wall; the view showing the mounting clip partially installed in the mounting bracket with the forward end of mounting arm of mounting clip placed in the recess in the back surface of forward wall of mounting bracket however the protrusion in the back surface of the rear wall of the mounting clip is yet to engage the recess in the forward surface of the back wall of the mounting bracket; the view showing that all that is needed to lock the mounting clip on the mounting bracket is to rotate the rearward end of the mounting clip upward upon the mounting bracket;

FIG. 22 is a side elevation view of a mounting bracket and mounting clip arrangement similar to the view shown in FIG. 21, this view showing the rearward end of the mounting clip further rotated upward as compared to FIG. 21; the view showing upper/rearward surface of the protrusion in the lower rearward surface of the back wall of mounting clip in engagement with the angled surface in the lower end of the back wall of mounting bracket;

FIG. 23 is a side elevation view of a mounting bracket and mounting clip arrangement similar to the view shown in FIGS. 21 and 22, this view showing the rearward end of the mounting clip further rotated upward as compared to FIG. 22; the view showing stop surface of the protrusion in the lower rearward surface of the back wall of mounting clip about to pass the stop surface of the recess in the forward surface of the back wall of the mounting bracket;

FIG. 24 is a side elevation view of a mounting bracket and mounting clip arrangement similar to the view shown in FIGS. 21 and 22 and 23, this view showing stop surface of the protrusion in the lower rearward surface of the back wall of mounting clip in locked engagement with the stop surface of the recess in the forward surface of the back wall of the mounting bracket;

FIG. 25 is a front elevation view of a roller shade system having a manual control assembly connected to one end of the roller tube, the view showing the fascia and a cord extending downward from the manual control assembly that is used to operate the manual control assembly; the view showing the roller shade attached to mounting brackets;

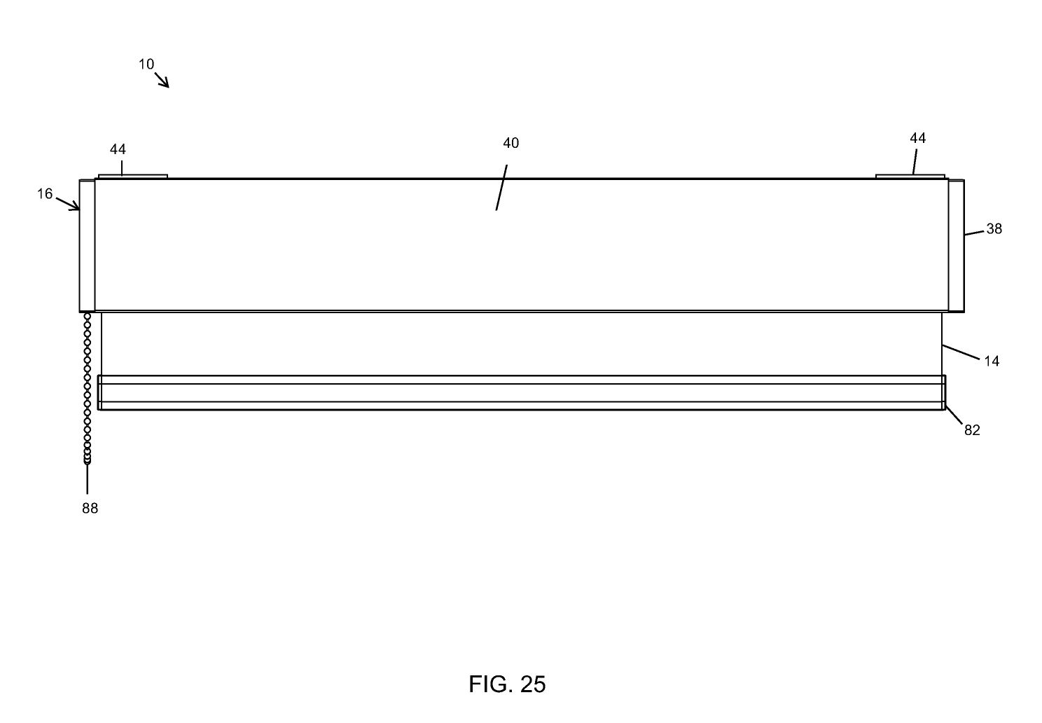

FIG. 26 is a rear elevation view of the manually operable roller shade system shown in FIG. 25 having a manual control assembly connected to one end of the roller tube, the view showing the hard stop member connected to an end plate on one side of the roller tube and a manual control assembly positioned on the opposite end of the roller tube; the view showing a cord extending downward from the manual control assembly that is used to operate the manual control assembly; the view showing the roller shade attached to mounting brackets by mounting clips;

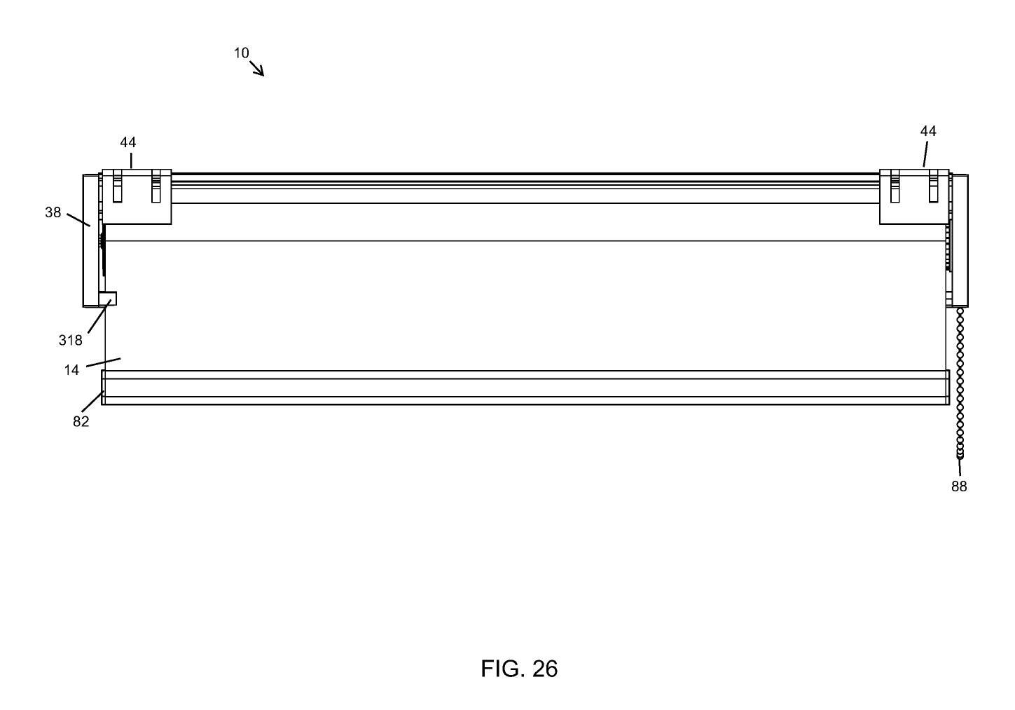

FIG. 27 is a top elevation view of the manually operable roller shade system shown in FIGS. 25 and 26 having a manual control assembly connected to one end of the roller tube, the view showing the roller shade attached to mounting brackets by mounting clips;

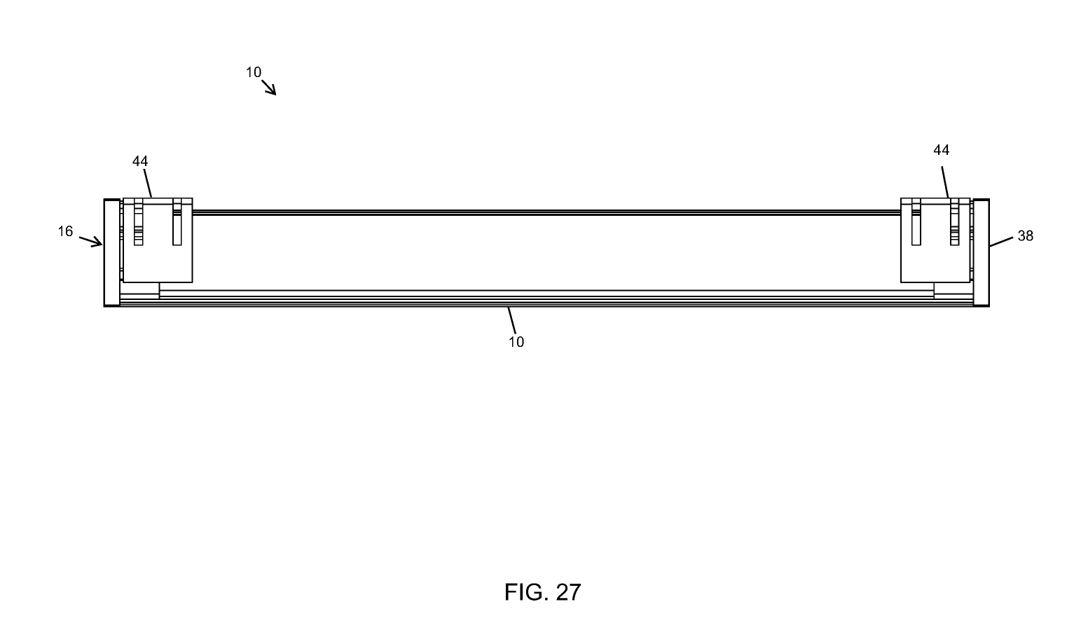

FIG. 28 is a side elevation view of the manually operable roller shade system shown in FIGS. 25-27, the view showing a first side of the roller shade system;

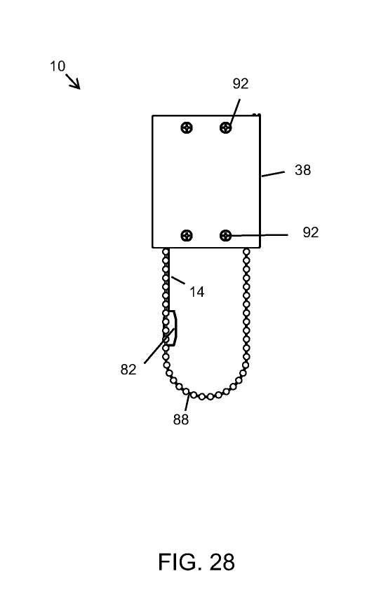

FIG. 29 is a side elevation view of the manually operable roller shade system shown in FIGS. 25-28, the view showing the addition of mounting brackets;

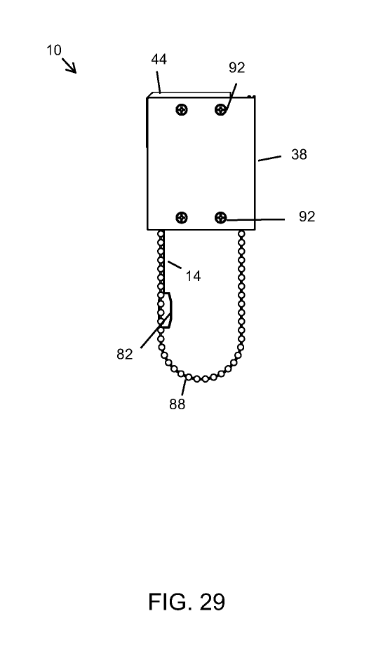

FIG. 30 is a front perspective view of the manual roller shade system shown in FIGS. 25-29 having a manual control assembly connected to one end of the roller tube, the view showing the fascia and a cord extending downward from the manual control assembly that is used to operate the manual control assembly; the view showing the roller shade attached to mounting brackets;

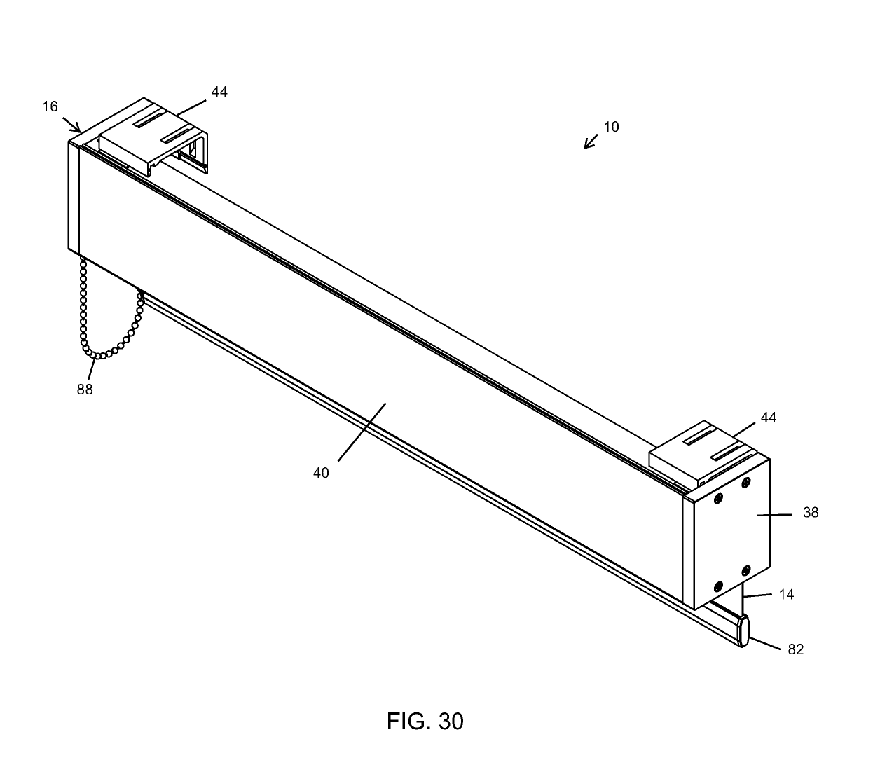

FIG. 31 is a rear perspective view of the manual roller shade system shown in FIGS. 25-30 having a manual control assembly connected to one end of the roller tube, the view showing the fascia and a cord extending downward from the manual control assembly that is used to operate the manual control assembly; the view showing the roller shade attached to mounting brackets;

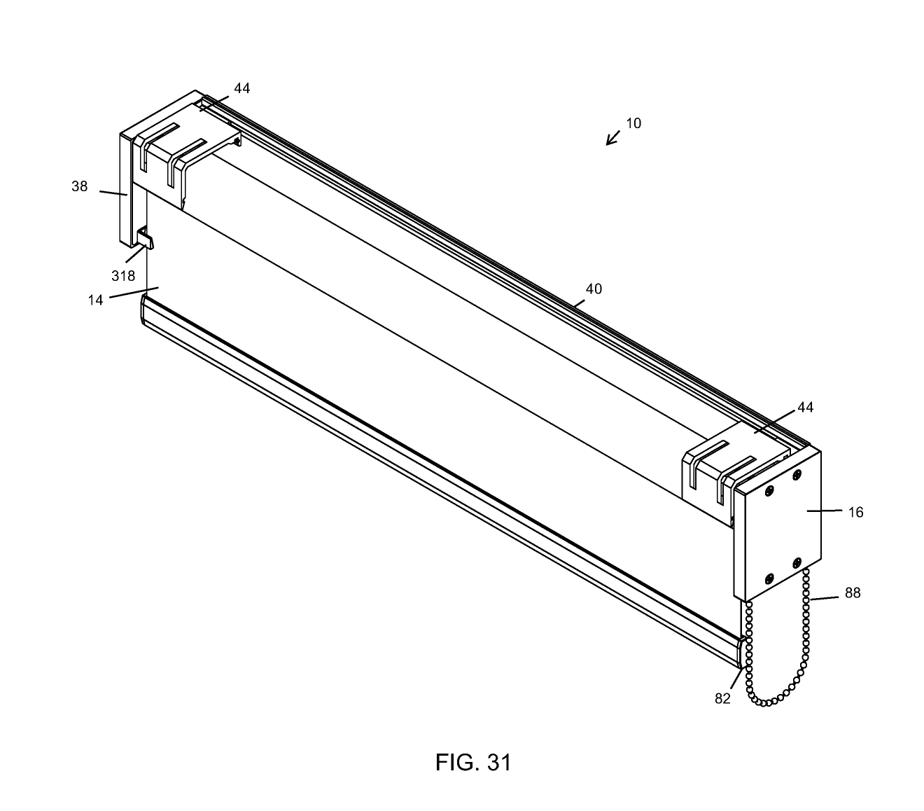

FIG. 32 is a partial exploded elevation view of the rear side of the manual roller shade system shown in FIGS. 25-31 having a manual control assembly connected to one end of the roller tube, the view showing the fascia and a cord extending downward from the manual control assembly that is used to operate the manual control assembly; the view showing the mounting brackets, mounting clips and manual control assembly exploded from the roller tube;

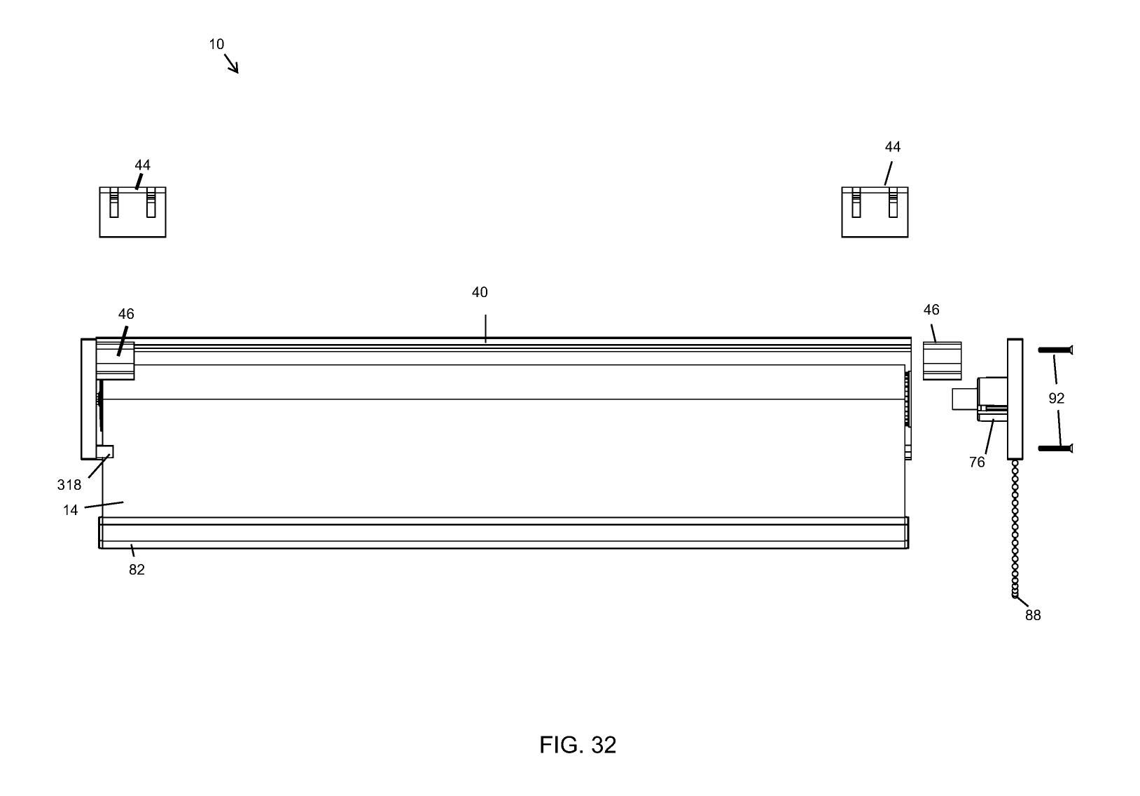

FIG. 33 is a partial exploded perspective view of the front side of the manual roller shade system shown in FIGS. 25-32 having a manual control assembly connected to one end of the roller tube, the view showing the fascia and a cord extending downward from the manual control assembly that is used to operate the manual control assembly; the view showing the mounting brackets, mounting clips, and manual control assembly exploded from the roller tube;

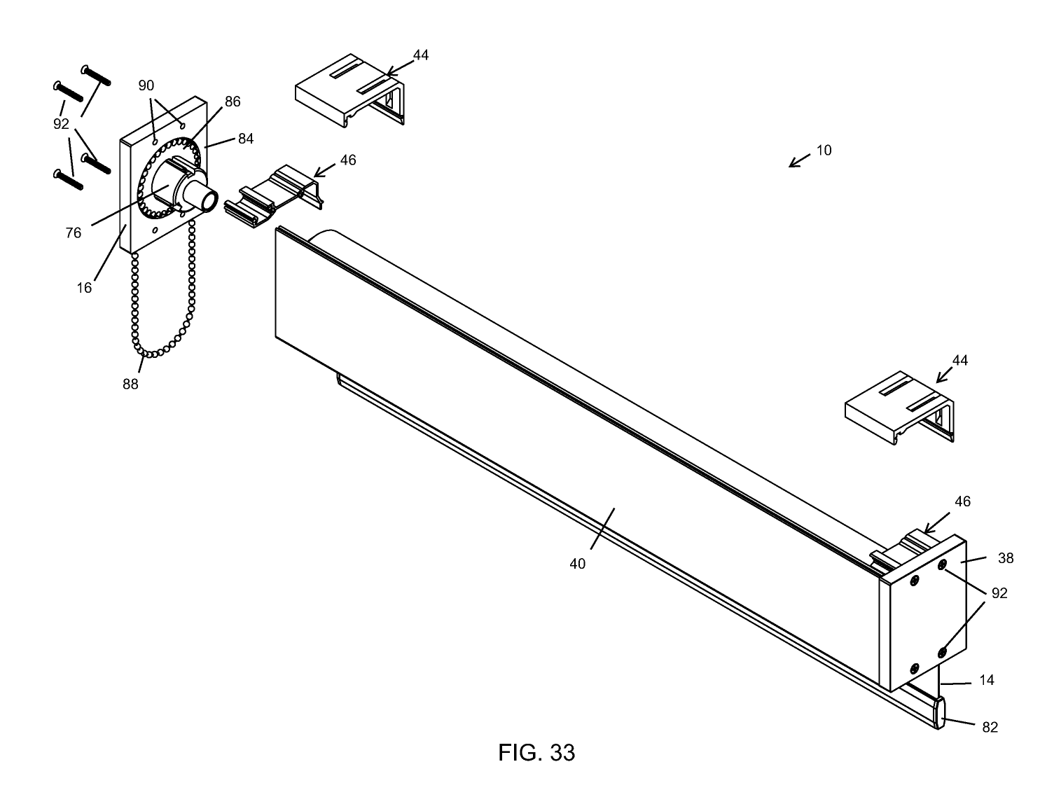

FIG. 34 is a partial exploded perspective view of the rear side of the manual roller shade system shown in FIGS. 25-33 having a manual control assembly connected to one end of the roller tube, the view showing the fascia and a cord extending downward from the manual control assembly that is used to operate the manual control assembly; the view showing the mounting brackets, mounting clips, and manual control assembly exploded from the roller tube;

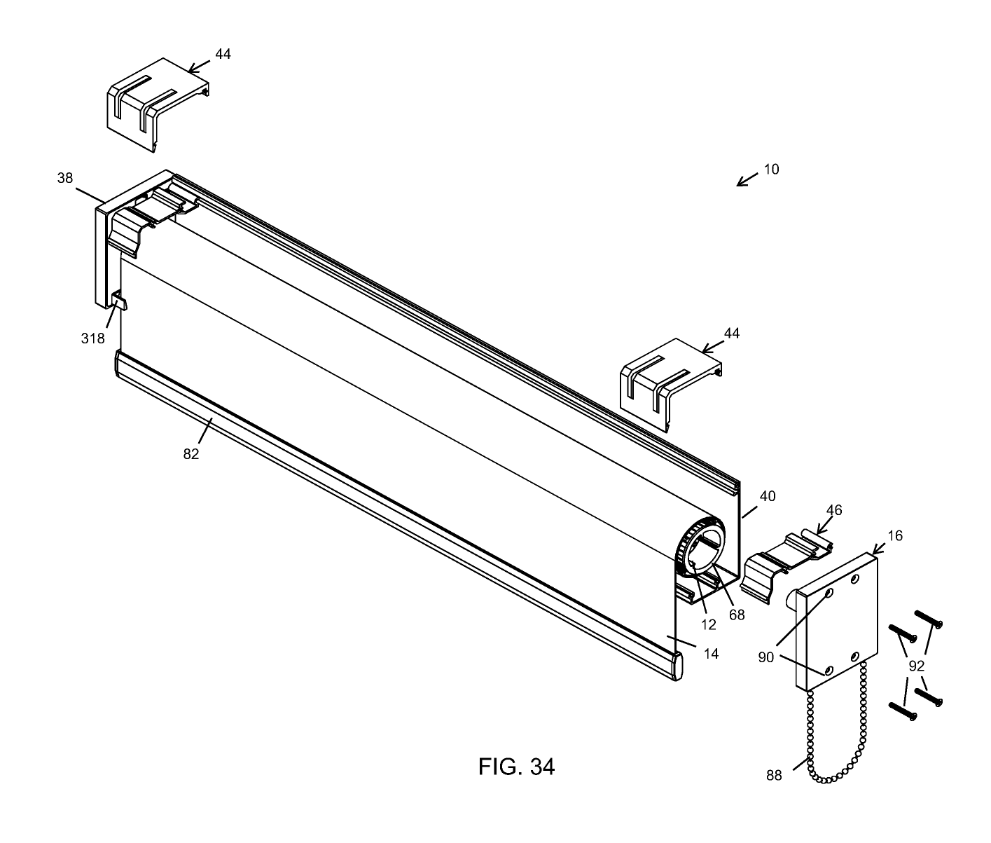

FIG. 35 is a front elevation view of a motorized roller shade system powered by electrical connection to a lead having a socket, the view showing a fascia, end caps connected to the outward ends of the fascia, shade material, and a bottom bar hanging down from the fascia;

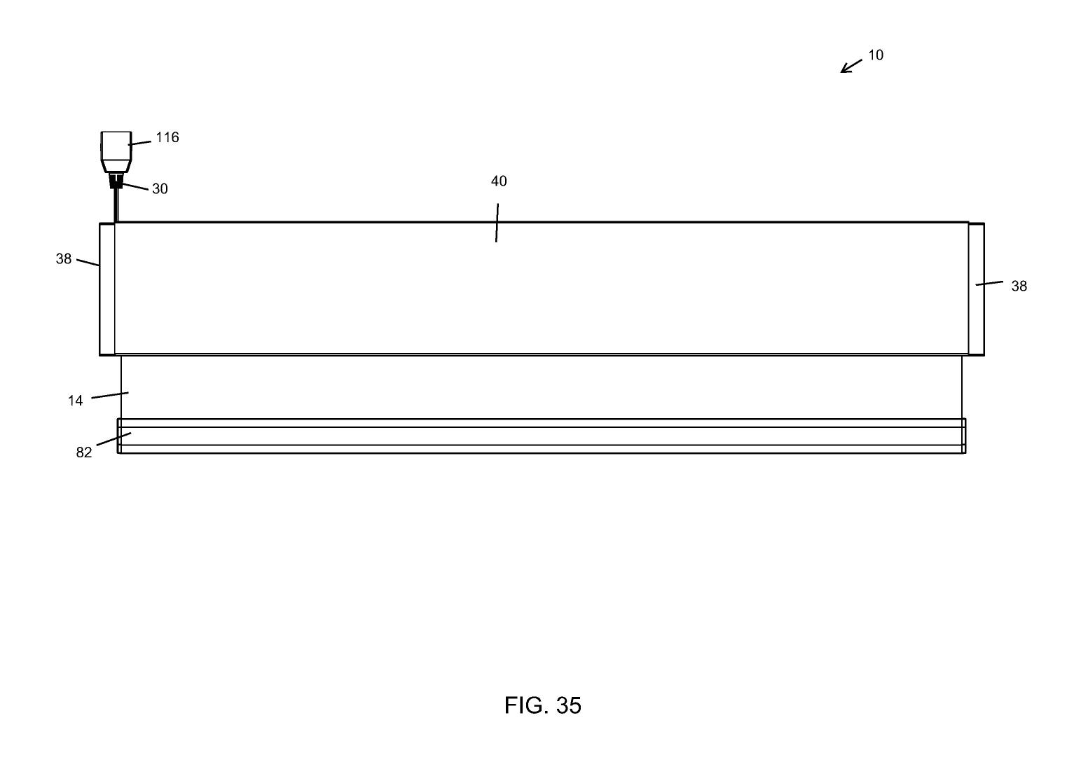

FIG. 36 is a front elevation view of a motorized roller shade system shown in FIG. 35, the view showing the addition of mounting brackets to the motorized roller shade system;

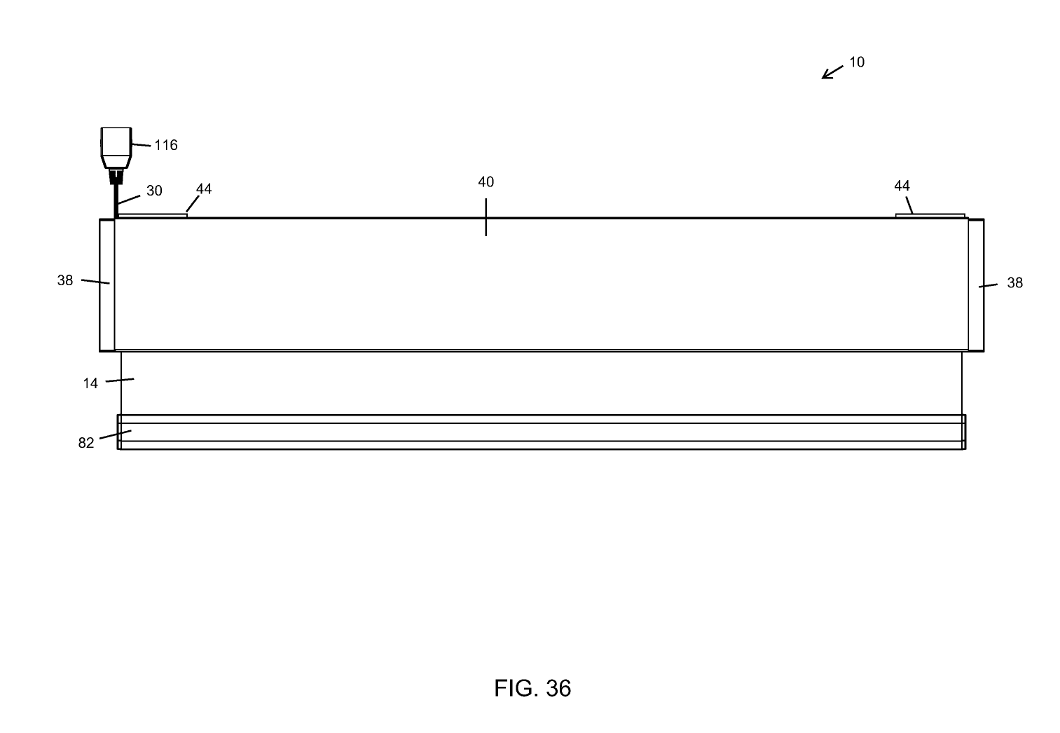

FIG. 37 is a rear elevation view of a motorized roller shade system shown in FIGS. 35 and 36 powered by electrical connection to a lead having a socket, the view showing a fascia, mounting clips connected to the fascia and end caps connected to the outward ends of the fascia, shade material and a bottom bar hanging down from the fascia; the view also showing a hard stop member connected to the end caps and positioned around the shade material above the bottom bar;

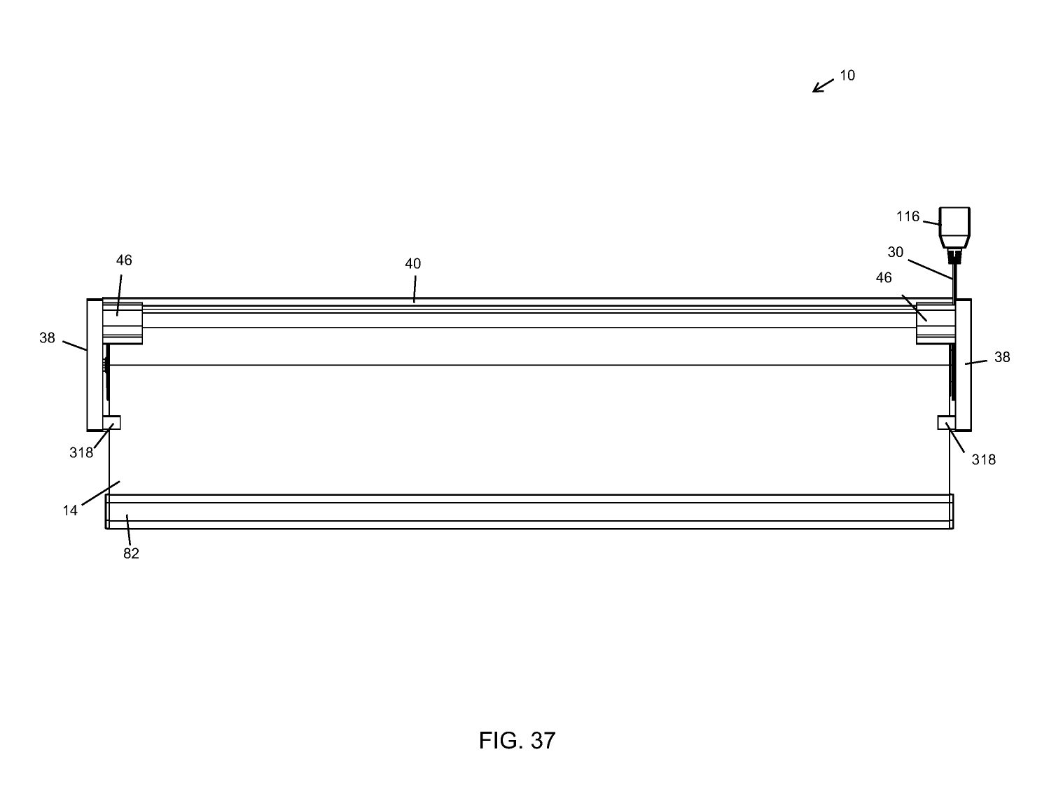

FIG. 38 is a rear elevation view of a motorized roller shade system shown in FIG. 37 with the addition of mounting brackets added to the mounting clips;

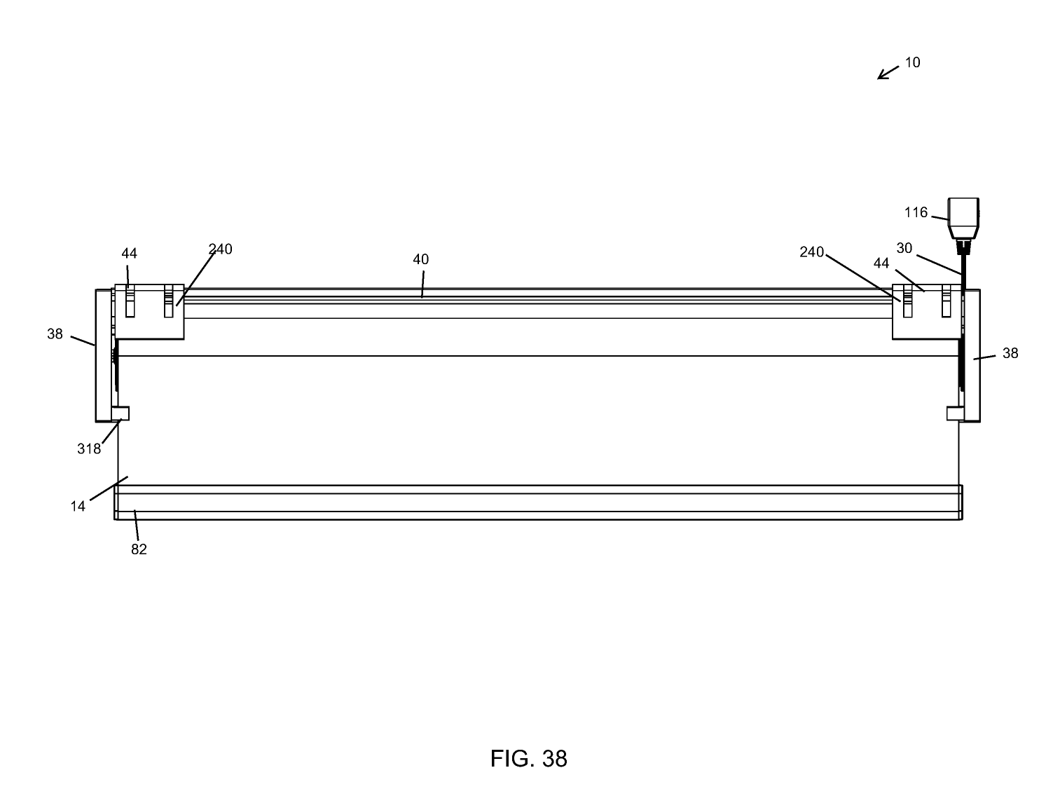

FIG. 39 is a top elevation view of the motorized roller shade system shown in FIGS. 35-38, the view showing mounting clips connected to the end caps without the installation of mounting brackets;

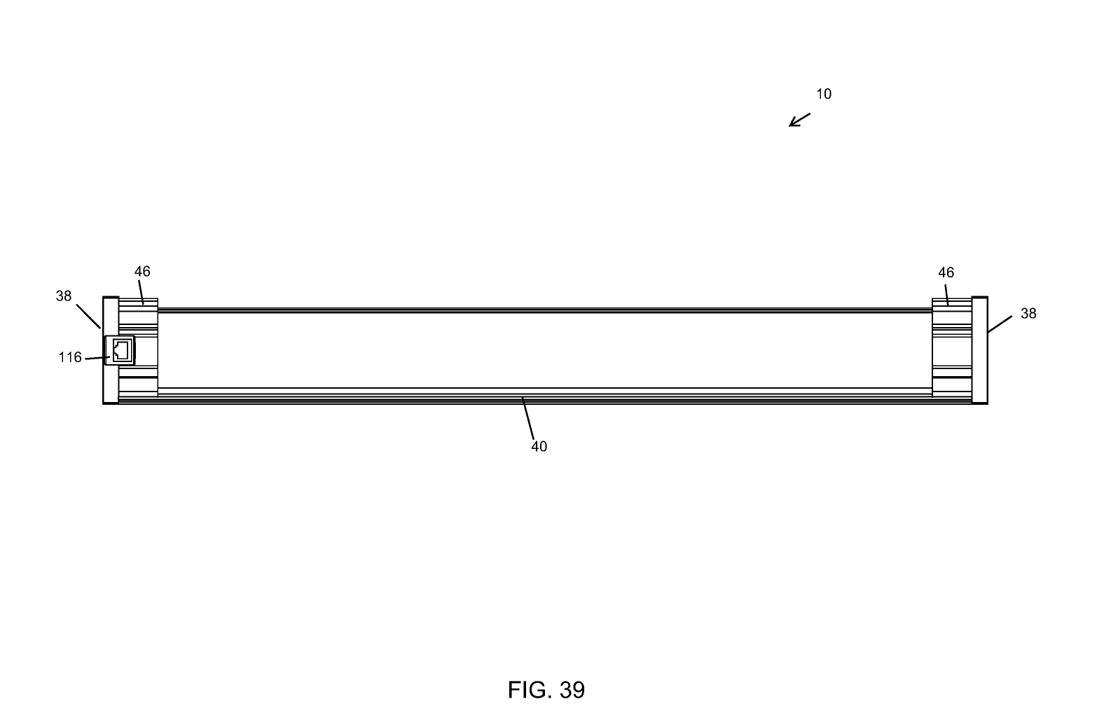

FIG. 40 is a top elevation view of the motorized roller shade system shown in FIG. 40 with the addition of mounting brackets to the mounting clips;

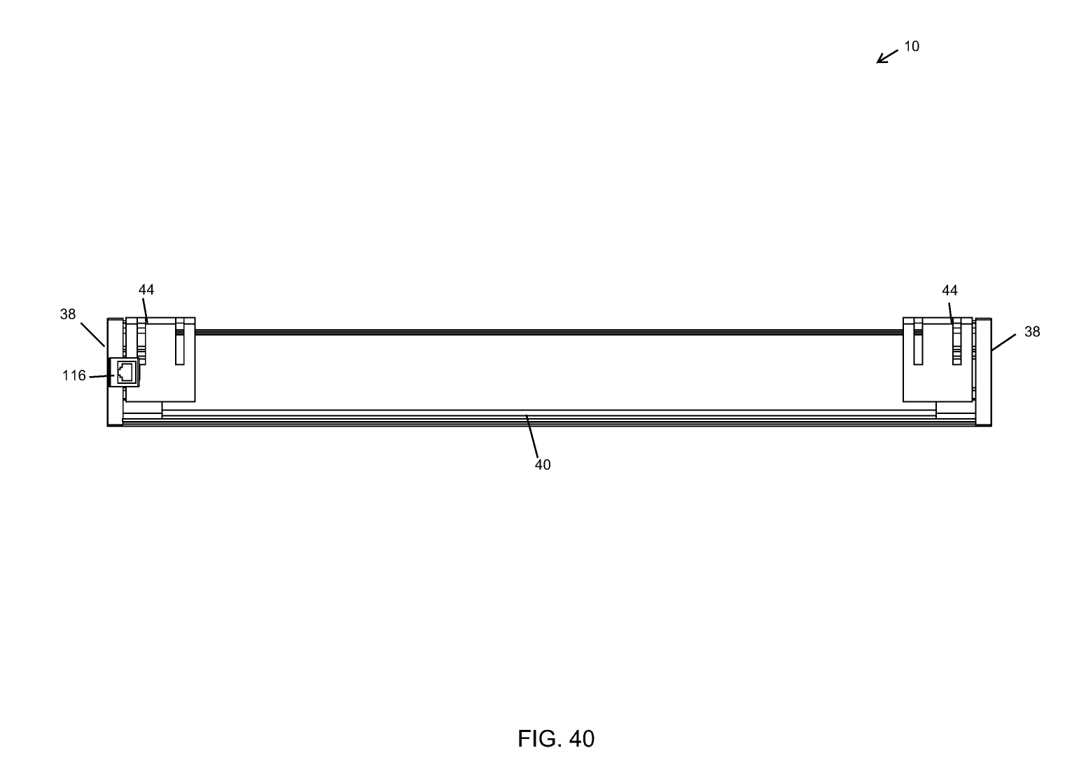

FIG. 41 is a side elevation view of the motorized roller shade system shown in FIGS. 35-40 the view showing a motorized roller shade system powered by electrical connection to a lead having a socket, the view showing a fascia, end caps connected to the outward ends of the fascia, shade material, and a bottom bar hanging down from the fascia;

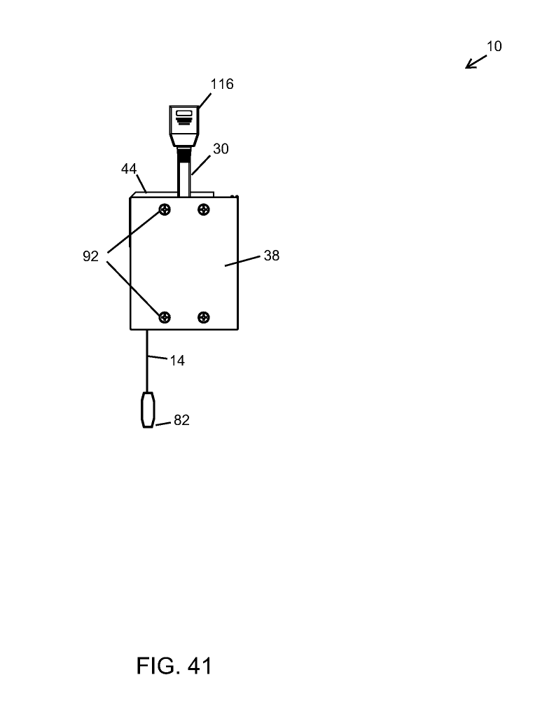

FIG. 42 is a front perspective view of the motorized roller shade system shown in FIGS. 35-41 the view showing a motorized roller shade system powered by electrical connection to a lead having a socket, the view showing a fascia, end caps connected to the outward ends of the fascia, shade material and a bottom bar hanging down from the fascia; the view showing mounting clips connected to the upper ends of end plates;

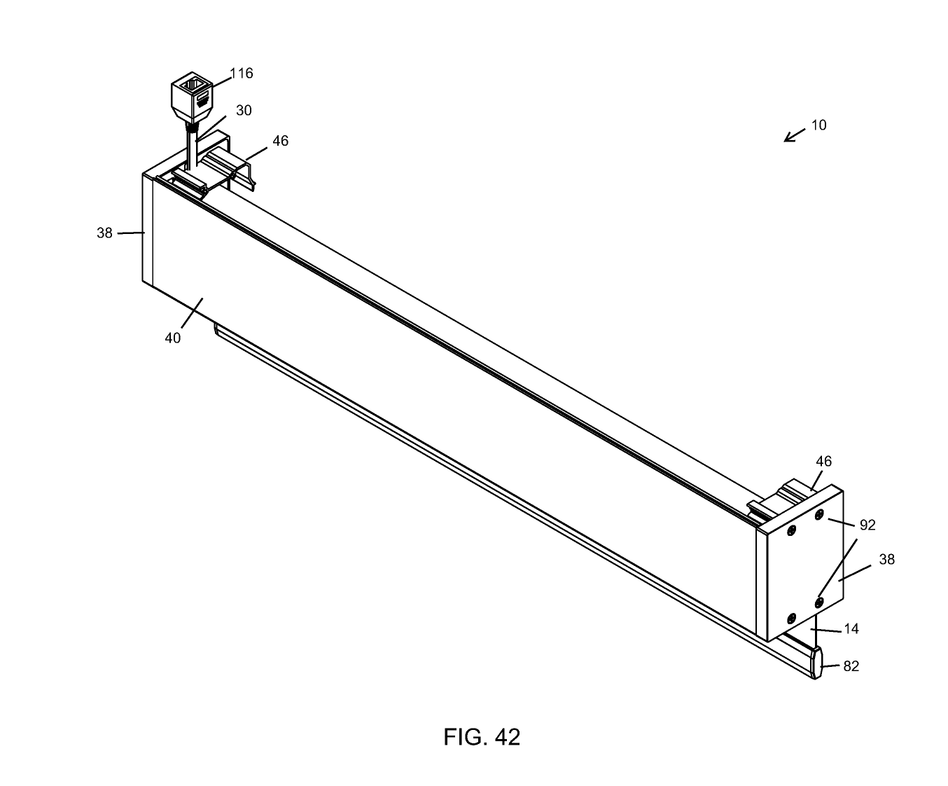

FIG. 43 is a front perspective view of the motorized roller shade system shown in FIG. 43 with the addition of mounting brackets to the mounting clips;

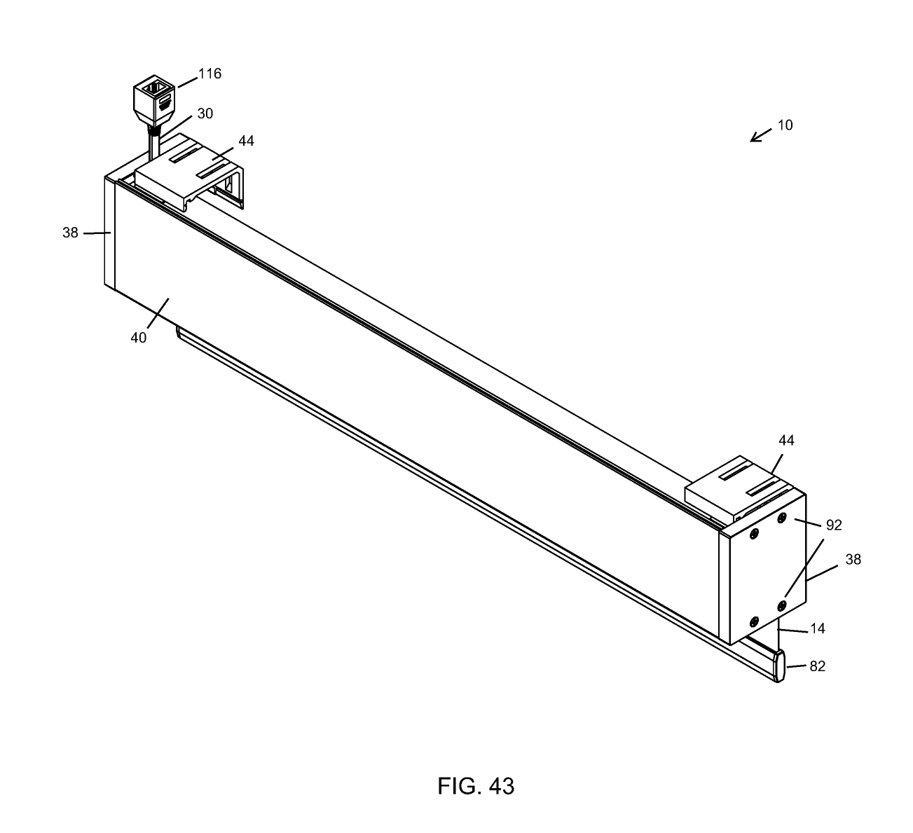

FIG. 44 is a rear perspective view of the motorized roller shade system shown in FIGS. 35-43 the view showing a motorized roller shade system powered by electrical connection to a lead having a socket, the view showing a fascia, end caps connected to the outward ends of the fascia, shade material, and a bottom bar hanging down from the fascia; the view showing mounting clips connected to the upper ends of end plates; the view also showing a hard stop member connected to the end caps and positioned around the shade material above the bottom bar;

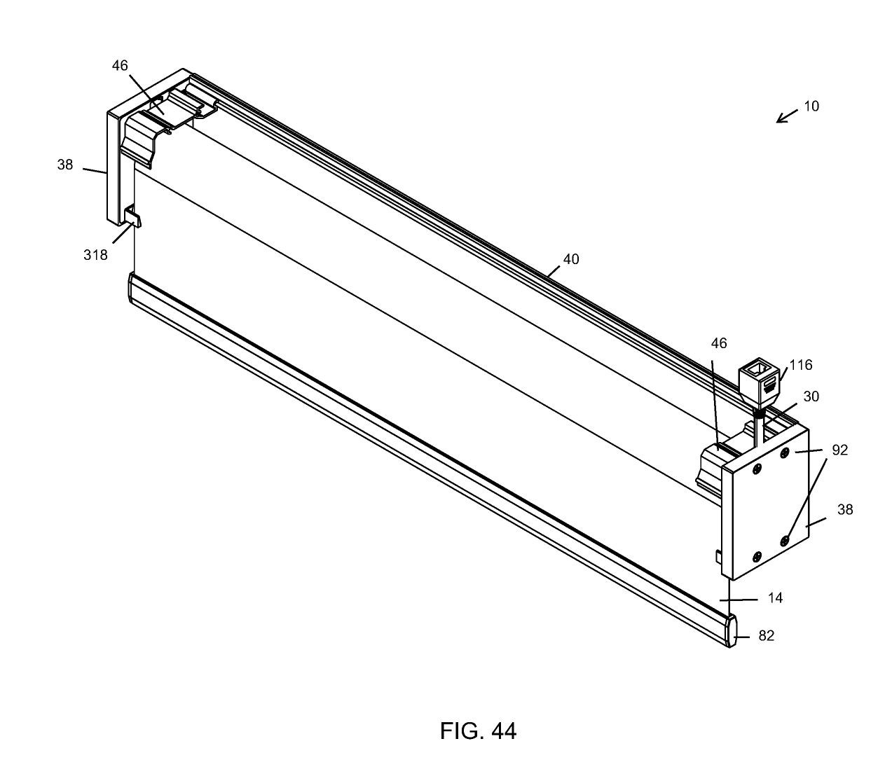

FIG. 45 is an exploded front elevation view of the motorized roller shade system shown in FIGS. 35-44, the view showing a motor control assembly removed from the roller tube; the view showing the end cap and end plate in exploded form; the view showing the mounting brackets and mounting clips in exploded form;

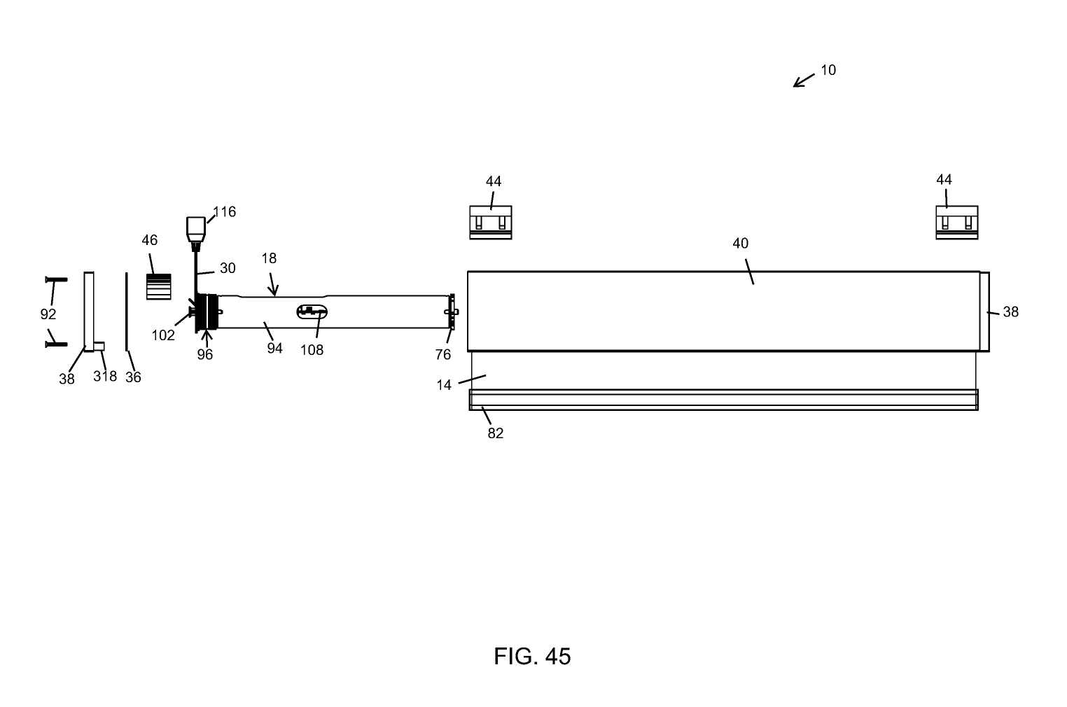

FIG. 46 is an exploded rear elevation view of the motorized roller shade system shown in FIGS. 35-45, the view showing a motor control assembly removed from the roller tube; the view showing the end cap and end plate in exploded form; the view showing the mounting brackets and mounting clips in exploded form;

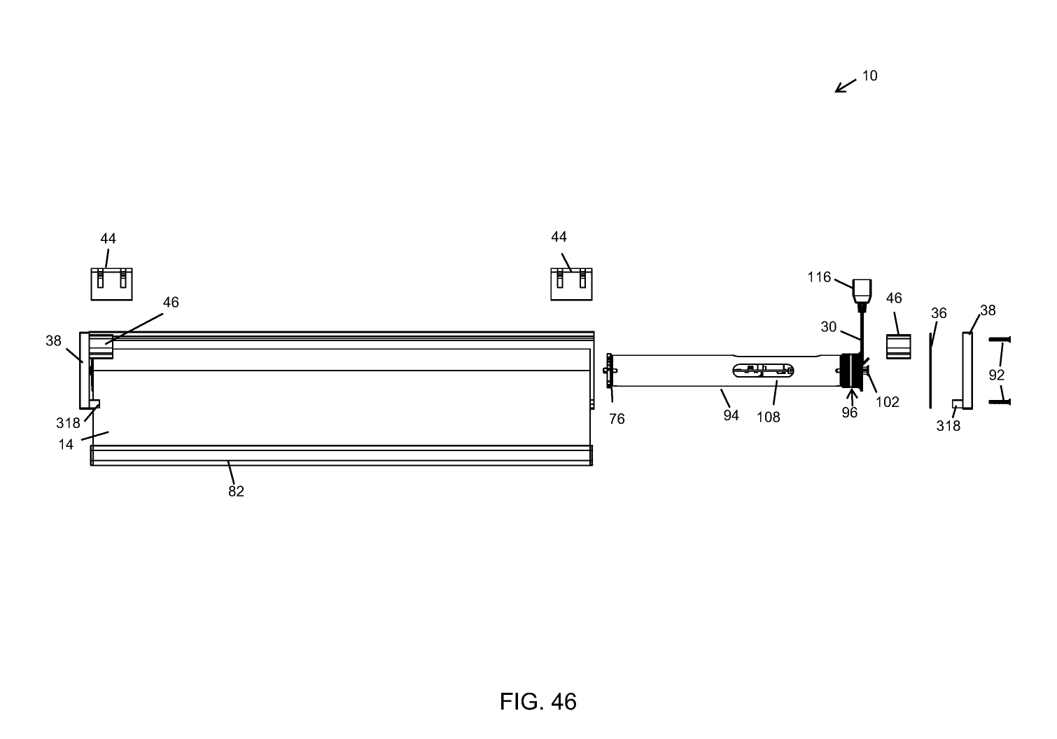

FIG. 47 is an exploded top elevation view of the motorized roller shade system shown in FIGS. 35-46, the view showing a motor control assembly removed from the roller tube; the view showing the end cap and end plate in exploded form;

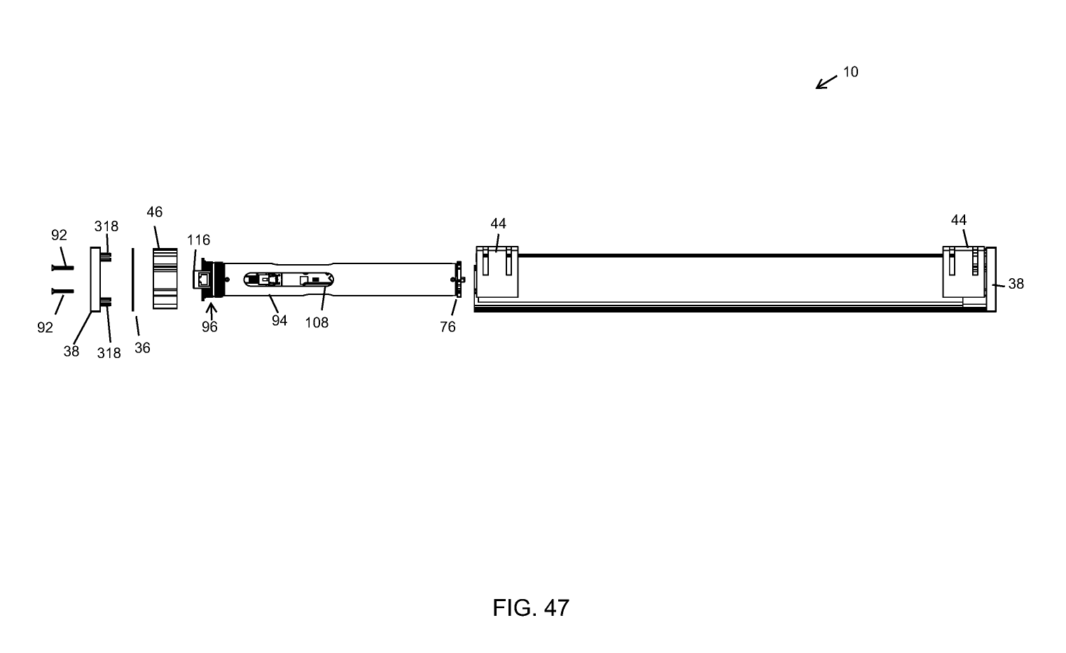

FIG. 48 is an exploded rear perspective view of the motorized roller shade system shown in FIGS. 35-47, the view showing a motor control assembly removed from the roller tube; the view showing the end cap and end plate in exploded form; the view showing the mounting brackets and mounting clips in exploded form; the view showing the mounting feature of the forward wall of the fascia; the view showing the screw bosses in the bottom wall of the fascia that connect to the openings in the end plate and end cap;

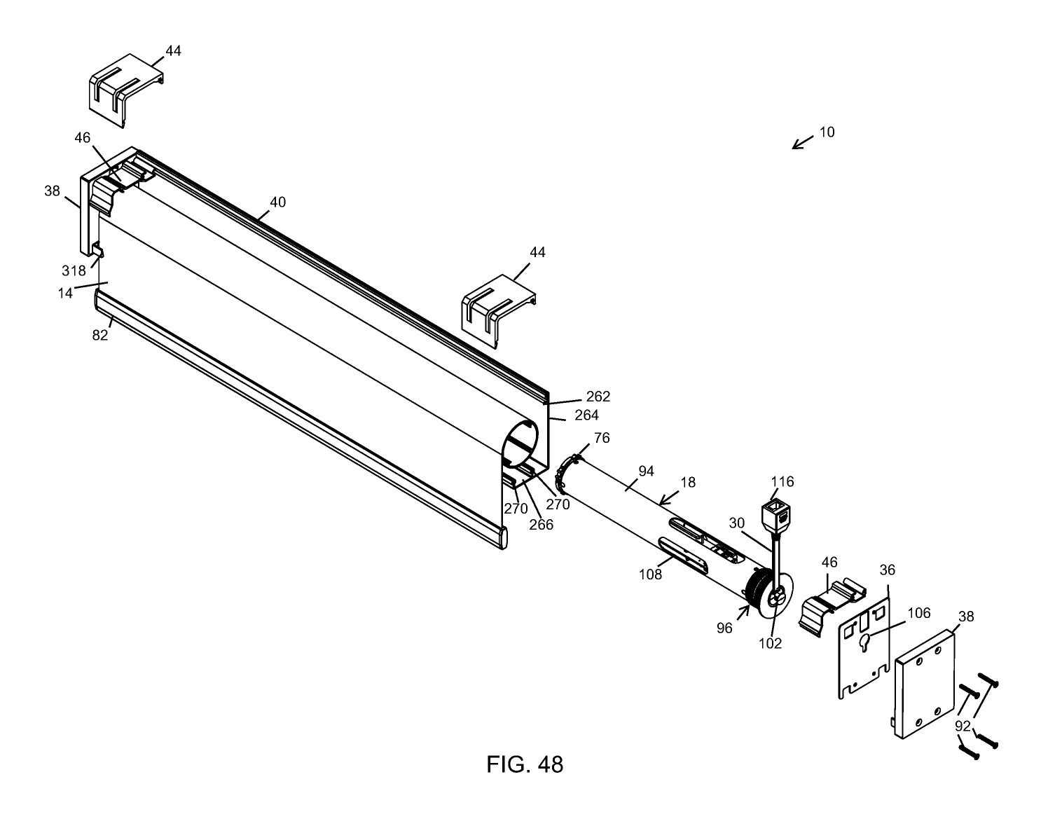

FIG. 49 is an exploded front perspective view of the motorized roller shade system shown in FIGS. 35-48, the view showing a motor control assembly removed from the roller tube; the view showing the end cap and end plate in exploded form; the view showing the mounting brackets and mounting clips in exploded form; the view showing the mounting feature of the forward wall of the fascia;

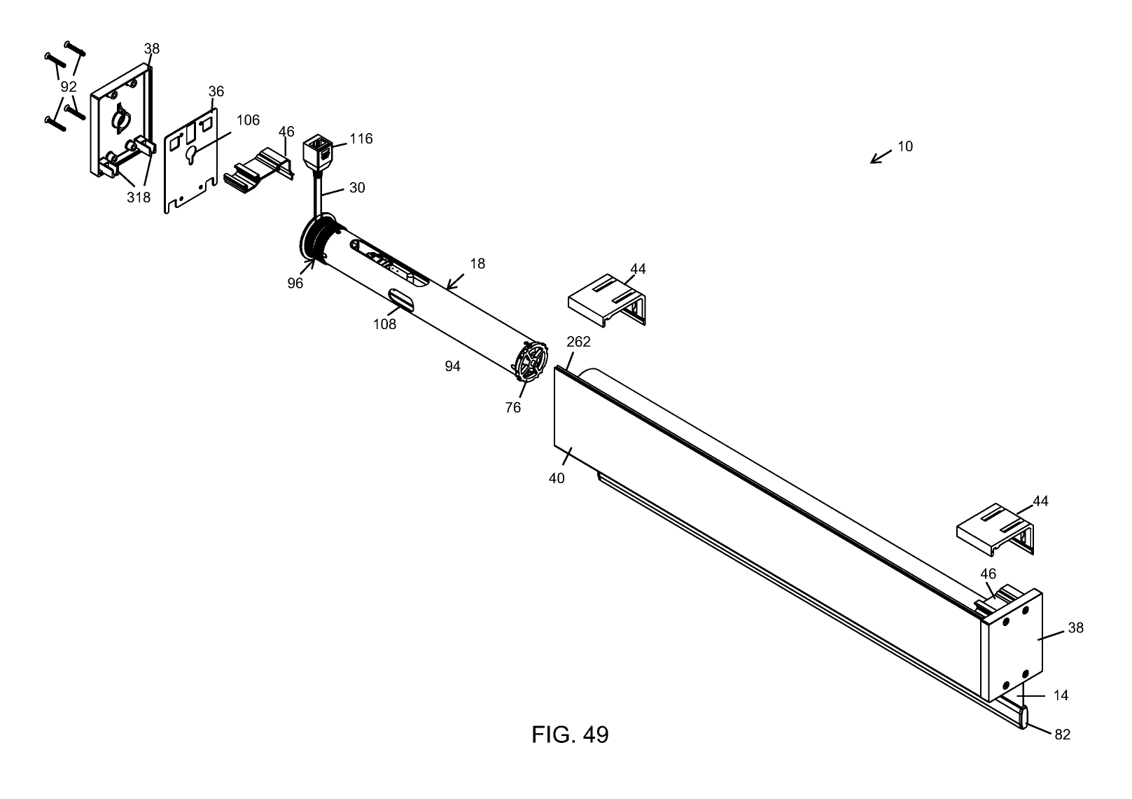

FIG. 50 is further exploded front perspective view of the motorized roller shade system shown in FIG. 49, the view showing a motor control assembly removed from the roller tube; the view showing the end cap and end plate in exploded form; the view showing the mounting brackets and mounting clips in exploded form; the view showing the mounting feature of the forward wall of the fascia and the screw bosses in the bottom wall of the fascia; the view also showing the counterbalance assembly removed from the roller tube;

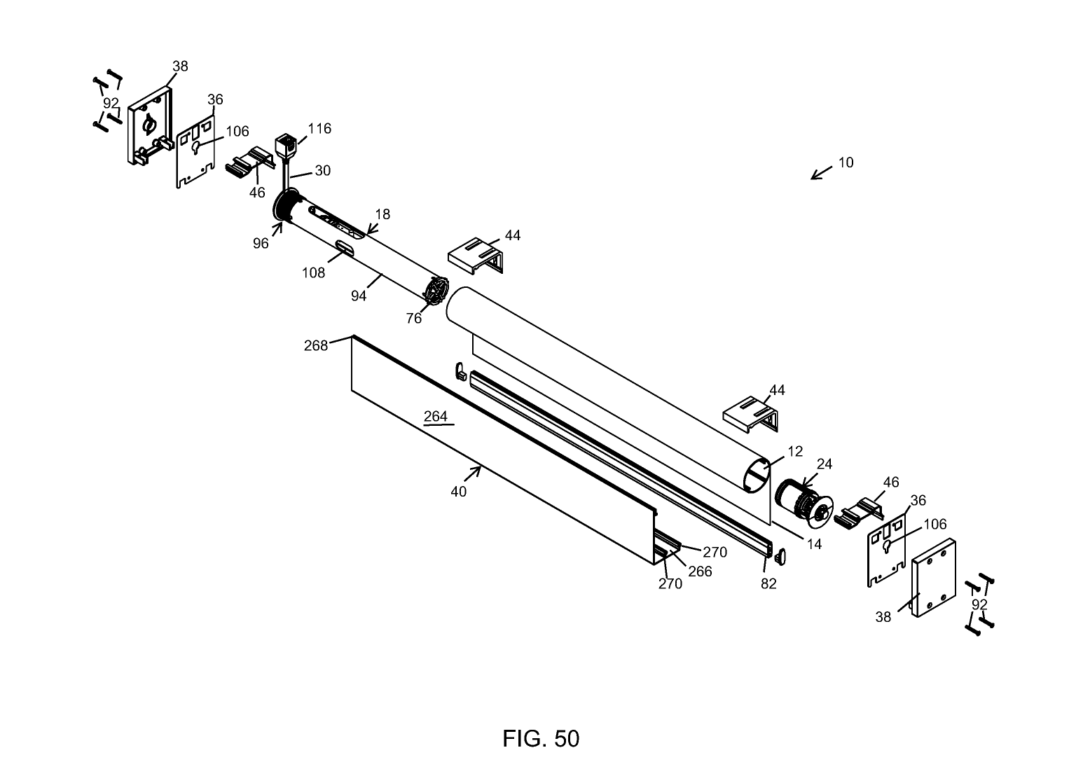

FIG. 51 is a front elevation cut-away view of the motorized roller shade system shown in FIGS. 35-50, the view showing a motor control assembly positioned within the roller tube; the view showing the end cap and end plate connected to the end of the roller tube; the view showing the mounting brackets and mounting clips connected to the end plates and end caps; the view also showing the counterbalance assembly positioned within the roller tube;

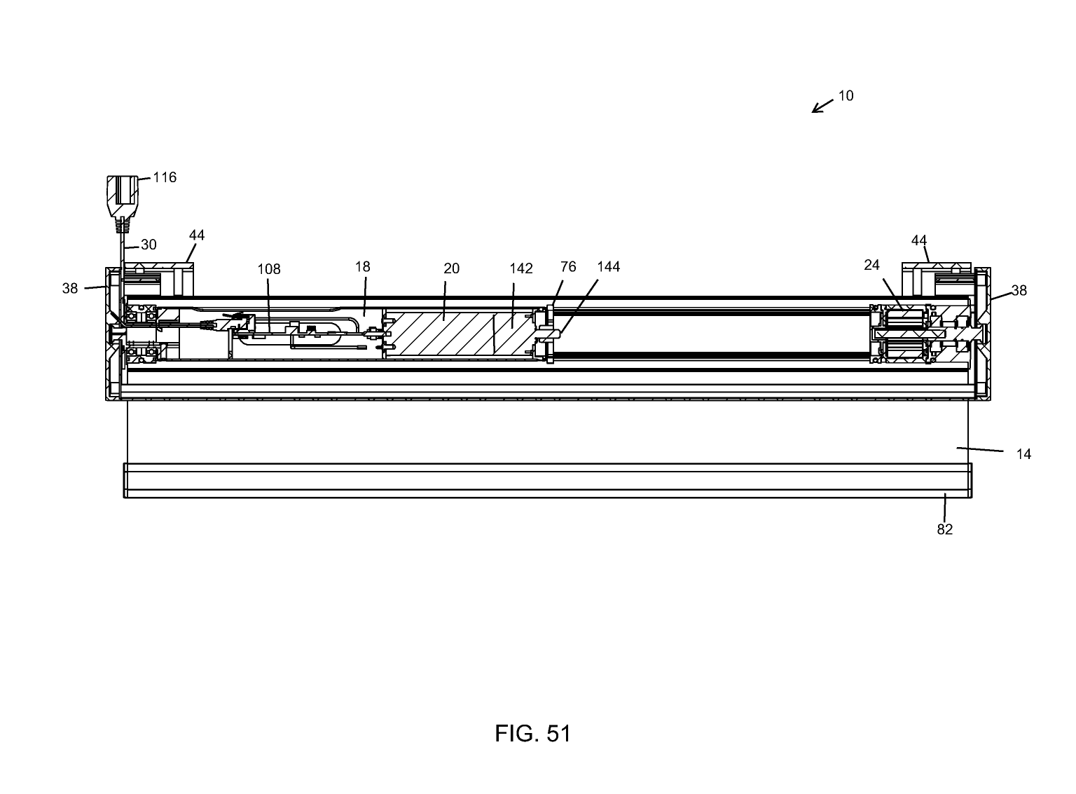

FIG. 52 is a front elevation view of a motorized roller shade system that is installed using a pair of pushup hoods that connect to pushup clips installed at opposing ends of the roller tube; the view showing the motorized roller shade system installed in the pushup hoods;

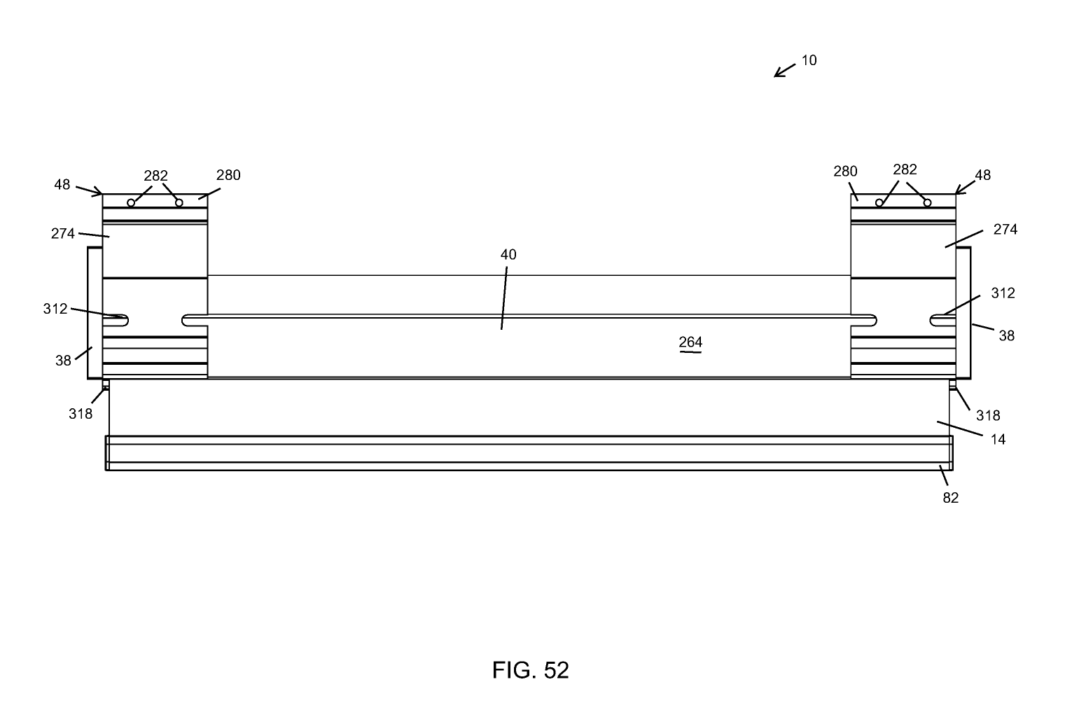

FIG. 53 is a rear elevation view of a motorized roller shade system that is installed using a pair of pushup hoods that connect to pushup clips installed at opposing ends of the roller tube; the view showing the motorized roller shade system installed in the pushup hoods;

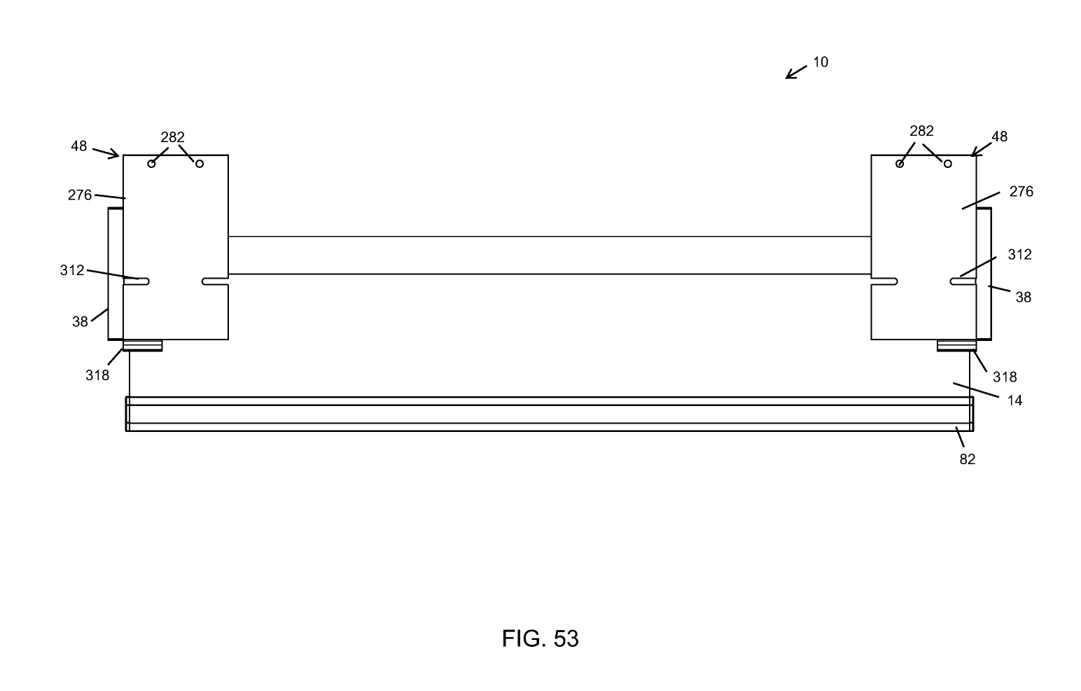

FIG. 54 is a front elevation view of a motorized roller shade system that is installed using a pair of pushup hoods that connect to pushup clips installed at opposing ends of the roller tube; the view showing the motorized roller shade system removed from the pushup hoods, the view showing the pushup clips connected to the end plates and end caps and the fascia;

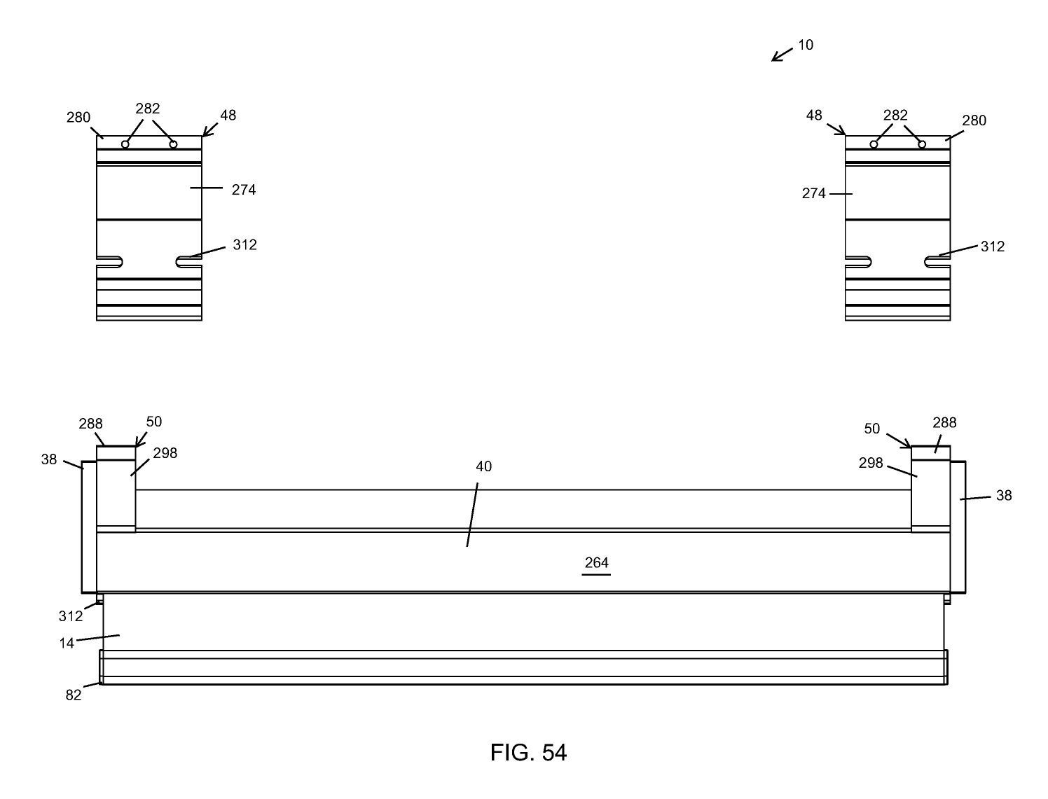

FIG. 55 is a rear elevation view of a motorized roller shade system that is installed using a pair of pushup hoods that connect to pushup clips installed at opposing ends of the roller tube; the view showing the motorized roller shade system removed from the pushup hoods, the view showing the pushup clips connected to the end plates and end caps;

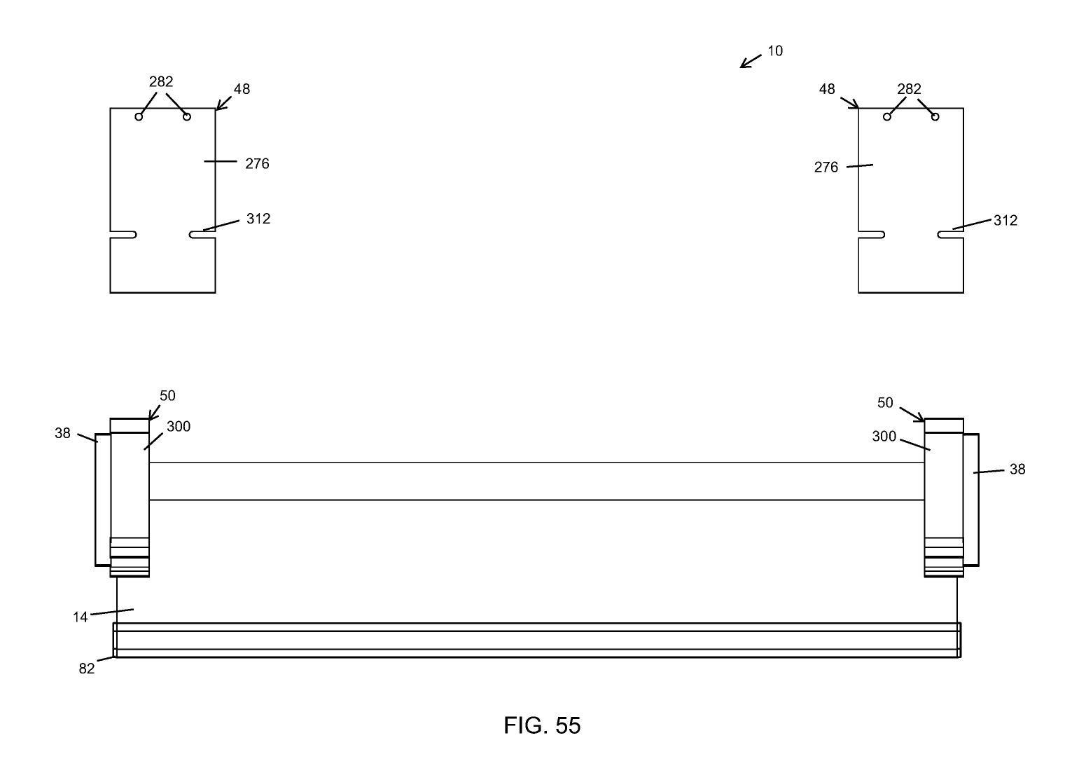

FIG. 56 is a front perspective view of a motorized roller shade system that is installed using a pair of pushup hoods that connect to pushup clips installed at opposing ends of the roller tube; the view showing the motorized roller shade system installed in the pushup hoods;

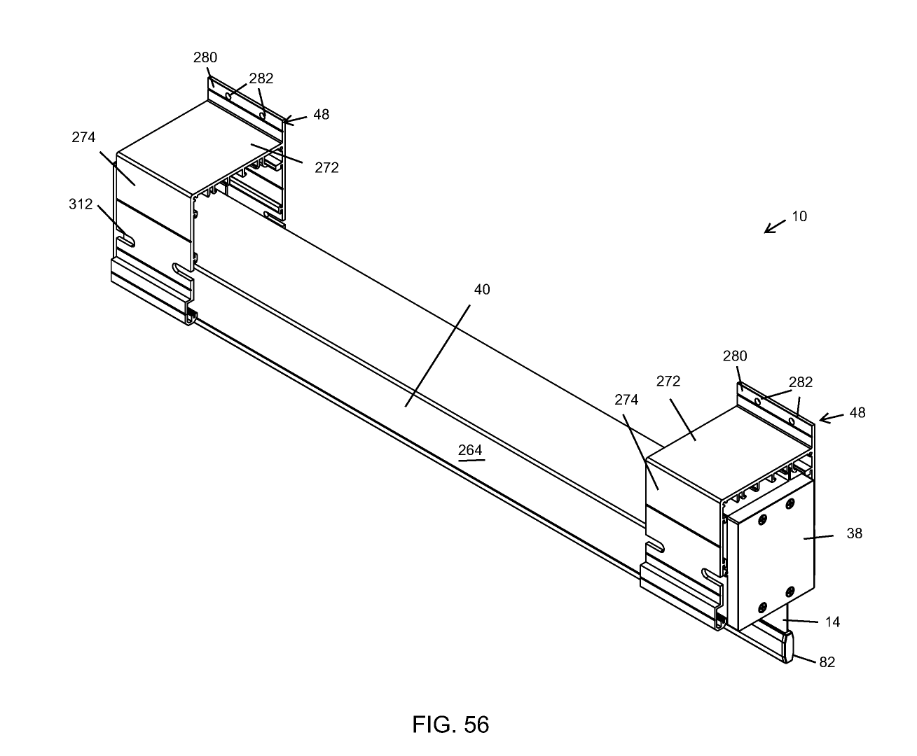

FIG. 57 is a rear perspective view of a motorized roller shade system that is installed using a pair of pushup hoods that connect to pushup clips installed at opposing ends of the roller tube; the view showing the motorized roller shade system installed in the pushup hoods;

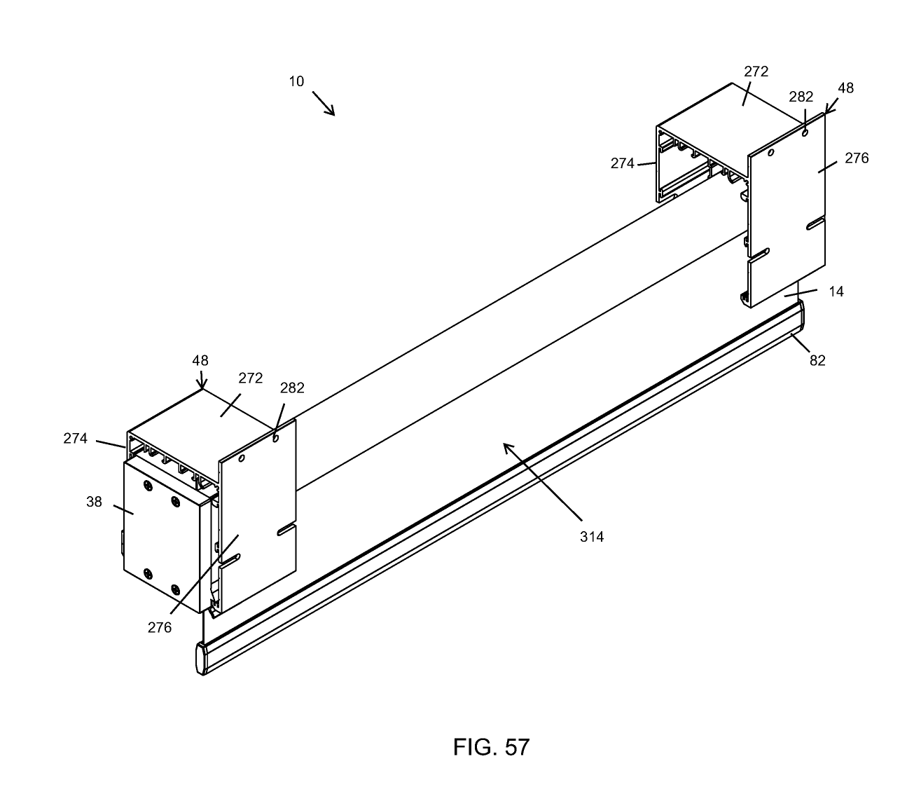

FIG. 58 is a rear perspective view of a motorized roller shade system that is installed using a pair of pushup hoods that connect to pushup clips installed at opposing ends of the roller tube; the view showing the motorized roller shade system removed from the pushup hoods; the view showing the pushup clips connected to the end plates and end caps; the view also showing the gap positioned between the exterior surface of the shade material and the pushup clips through which heated air trapped between the shade material and the window travels upward and into the plenum above the ceiling;

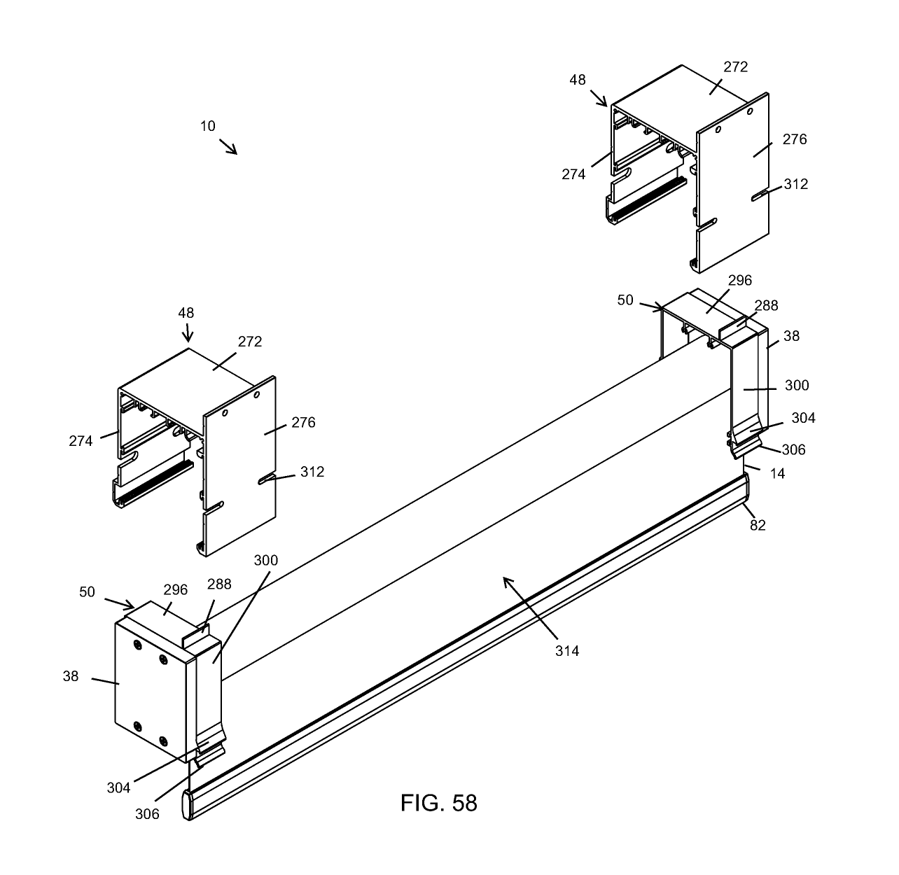

FIG. 59 is a front perspective exploded view of a motorized roller shade system that is installed using a pair of pushup hoods and pushup clips, the view showing the roller tube with shade material wrapped around the roller tube, a counterbalance assembly configured to be positioned in one end of the roller tube and a motor control assembly having a lead that is configured to receive power as well as control signals configured to be positioned in an opposite end of the roller tube, end plates and end caps configured to be connected to the ends of the roller tube, a fascia configured to connect to the pushup clips and end plates and end caps; pushup clips configured to connect to the end plates and end caps as well as the fascia, and pushup hoods configured to receive the assembled motorized roller shade assembly having pushup clips;

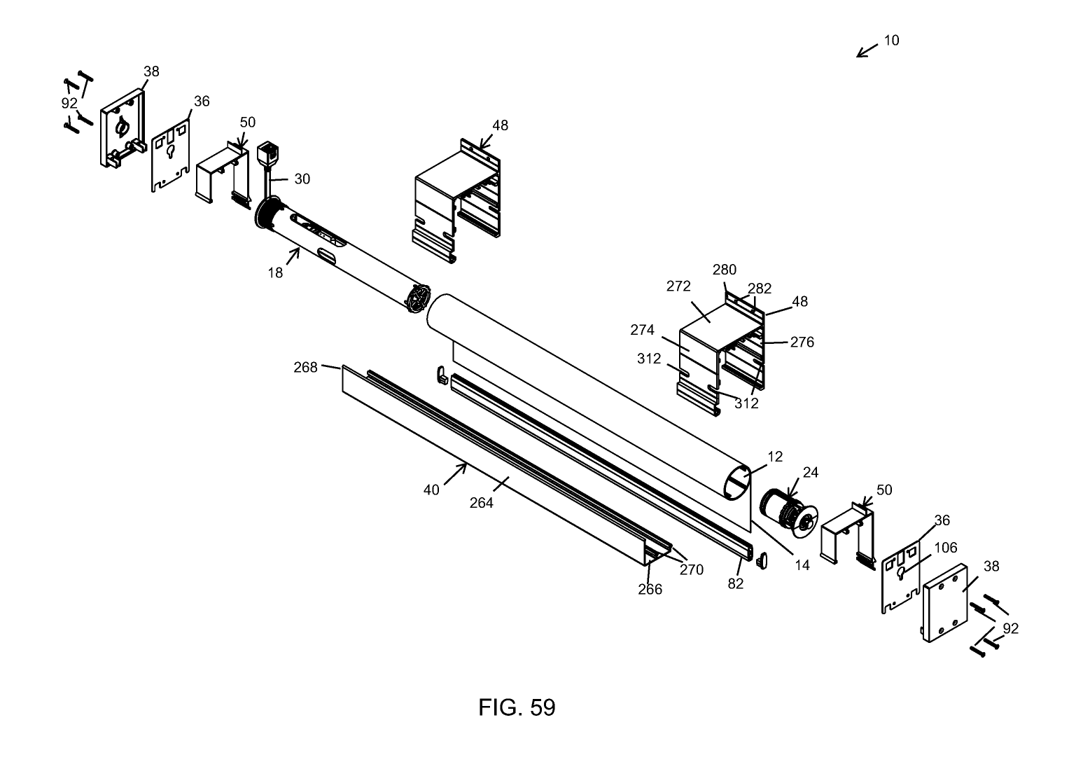

FIG. 60 is a side elevation view of a motorized roller shade system that is installed using a pair of pushup hoods that connect to pushup clips installed at opposing ends of the roller tube; the view showing the motorized roller shade system installed within the pushup hoods; the view showing the lock feature of the pushup clip in locked engagement with the lock feature of the pushup hood;

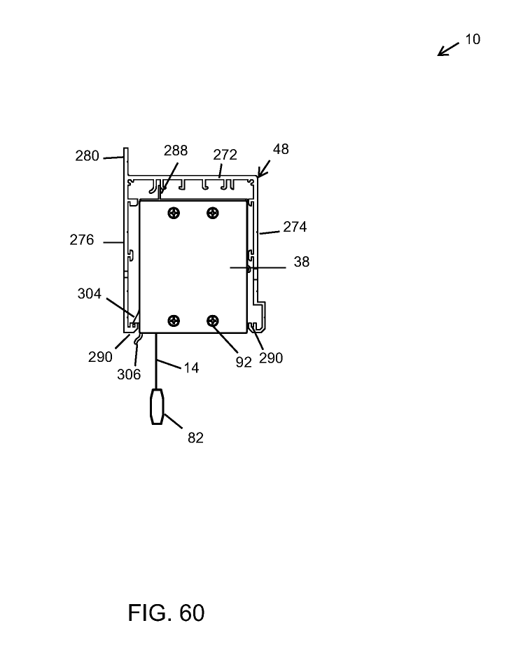

FIG. 61 is a side elevation view of a motorized roller shade system that is installed using a pair of pushup hoods that connect to pushup clips installed at opposing ends of the roller tube; the view showing the motorized roller shade system removed from within the pushup hoods; the view showing the angled surface and lock feature of the pushup clip that is configured to engage the guide member of the pushup hood and lock with the lock feature of the pushup hood once the motorized roller shade system is fully inserted within the pushup hood;

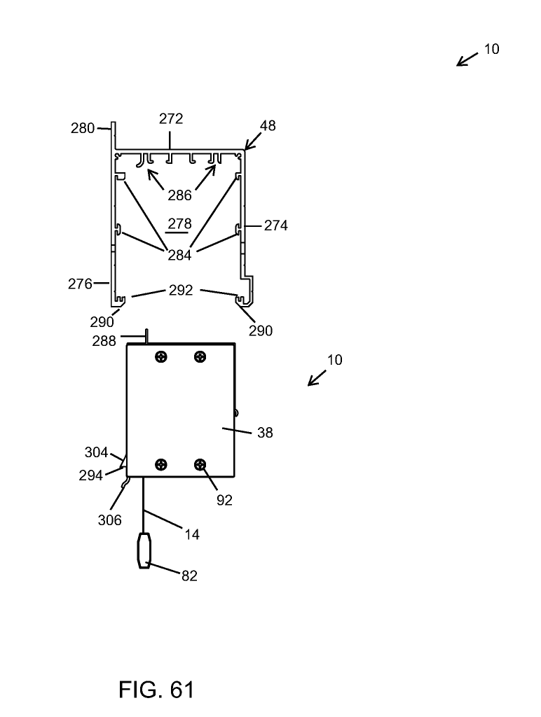

FIG. 62 is a side elevation cut-away view of a motorized roller shade system that is installed using a pair of pushup hoods that connect to pushup clips installed at opposing ends of the roller tube; the view showing the motorized roller shade system installed within the pushup hoods; the view showing the angled surface and lock feature of the pushup clip that is configured to engage the guide member of the pushup hood and lock with the lock feature of the pushup hood once the motorized roller shade system is fully inserted within the pushup hood; the view showing the lock feature of the pushup clip in locked engagement with the lock feature of the pushup hood; the view also showing the hollow interior of the roller tube;

FIG. 63 is a side elevation cut-away view of a motorized roller shade system that is installed using a pair of pushup hoods that connect to pushup clips installed at opposing ends of the roller tube; the view showing the motorized roller shade system in the process of being installed with the angled surface of the rear wall of pushup clip in engagement with the guide member in the lower edge of rear wall of the pushup hood thereby causing the rear wall of the pushup clip to flex or bend inward thereby allowing insertion into the hollow interior of the pushup hood; the view showing the angled surface and lock feature of the pushup clip that is configured to engage the guide member of the pushup hood and lock with the lock feature of the pushup hood once the motorized roller shade system is fully inserted within the pushup hood; the view showing the lock feature of the pushup clip in locked engagement with the lock feature of the pushup hood; the view also showing the hollow interior of the roller tube;

FIG. 64 is a front elevation view of a motorized roller shade system that is installed using a pair of pushup hoods that connect to pushup clips installed at opposing ends of the roller tube; the view showing the motorized roller shade system installed in the pushup hoods; the view also showing a window frame clamp connected to each pushup hood which is configured to clamp the pushup hood to a window frame member thereby installing the pushup hood to a window frame member without using fasteners that penetrate the window frame member; the view showing the mounting plate of the window frame clamp bolted to the upper wall of the pushup hood using fasteners;

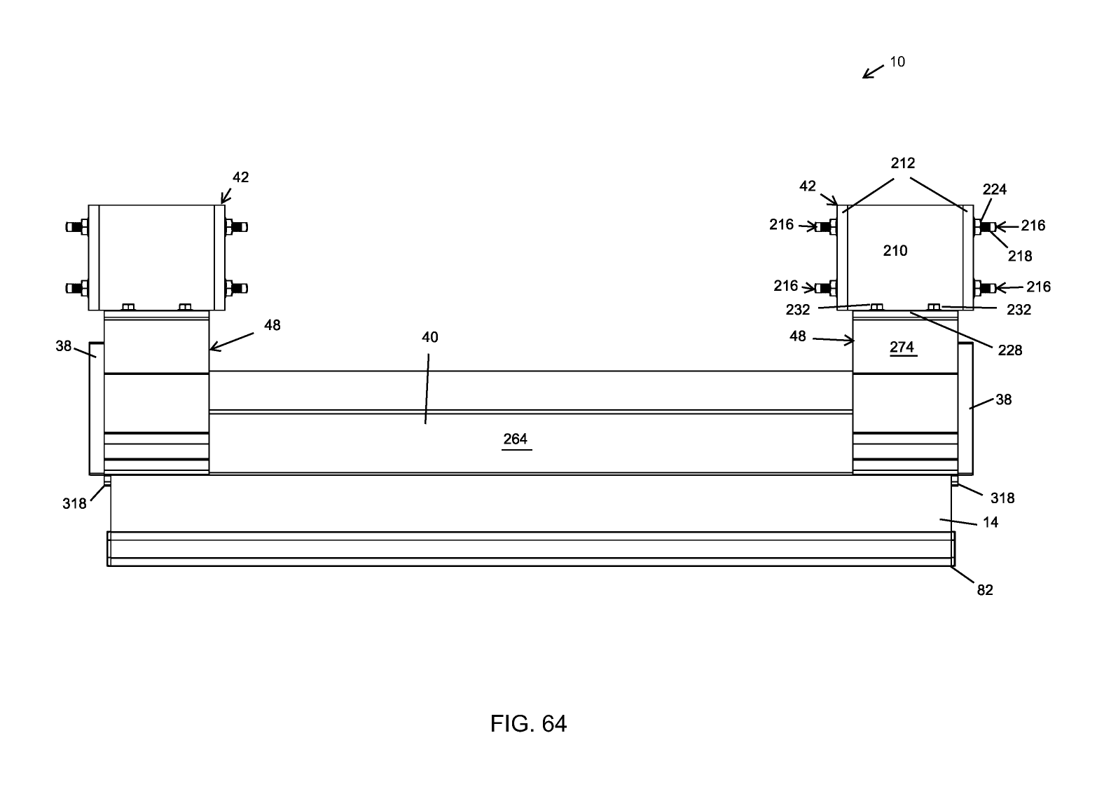

FIG. 65 is a rear elevation view of a motorized roller shade system that is installed using a pair of pushup hoods that connect to pushup clips installed at opposing ends of the roller tube; the view showing the motorized roller shade system installed in the pushup hoods; the view also showing a window frame clamp connected to each pushup hood which is configured to clamp the pushup hood to a window frame member thereby installing the pushup hood to a window frame member without using fasteners that penetrate the window frame member; the view showing the mounting plate of the window frame clamp connected to the upper wall of the pushup hood;

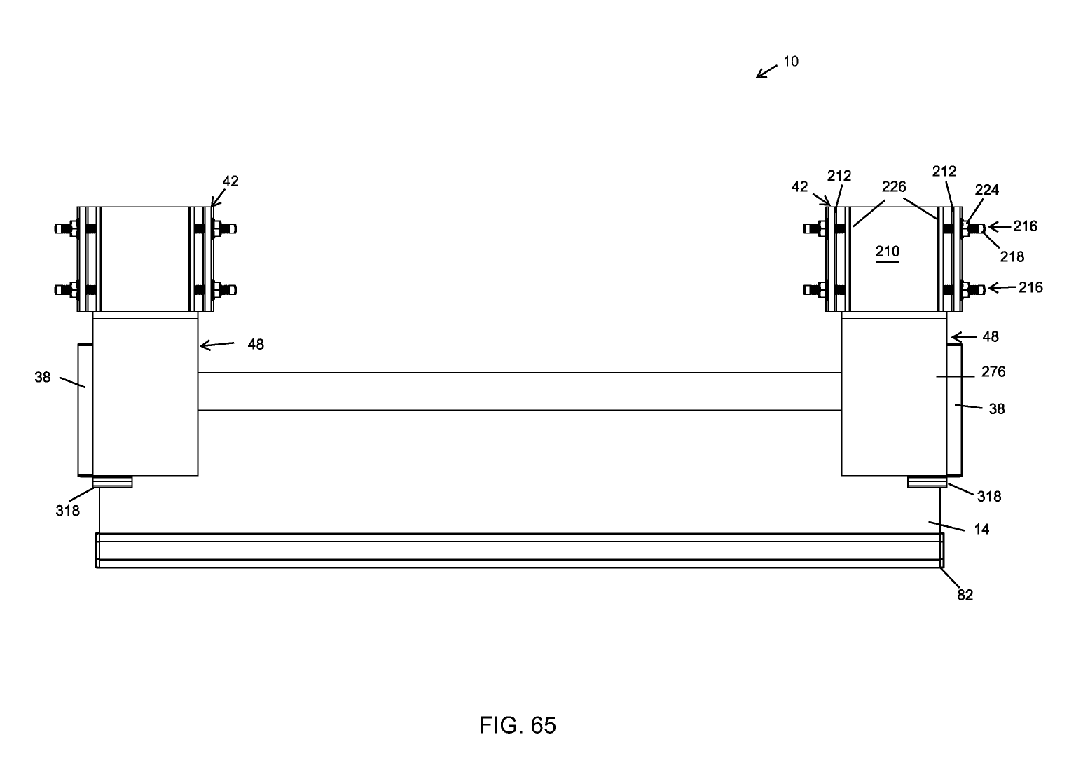

FIG. 66 is a side elevation view of a motorized roller shade system that is installed using a pair of pushup hoods that connect to pushup clips installed at opposing ends of the roller tube; the view showing the motorized roller shade system installed in the pushup hoods; the view also showing a window frame clamp connected to each pushup hood which is configured to clamp the pushup hood to a window frame member thereby installing the pushup hood to a window frame member without using fasteners that penetrate the window frame member; the view showing the mounting plate of the window frame clamp bolted to the upper wall of the pushup hood using fasteners;

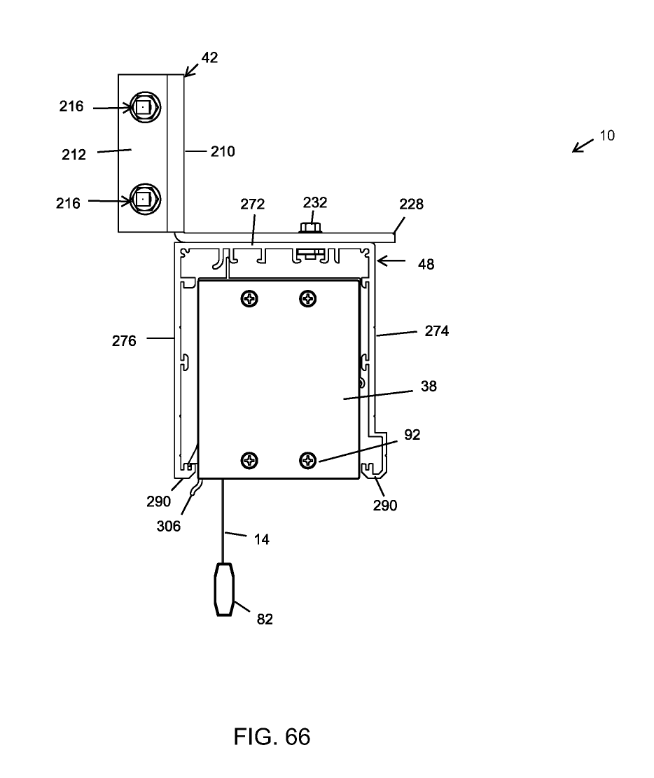

FIG. 67 is a front perspective view of a motorized roller shade system that is installed using a pair of pushup hoods that connect to pushup clips installed at opposing ends of the roller tube; the view showing the motorized roller shade system installed in the pushup hoods; the view also showing a window frame clamp connected to each pushup hood which is configured to clamp the pushup hood to a window frame member thereby installing the pushup hood to a window frame member without using fasteners that penetrate the window frame member; the view showing the mounting plate of the window frame clamp bolted to the upper wall of the pushup hood using fasteners;

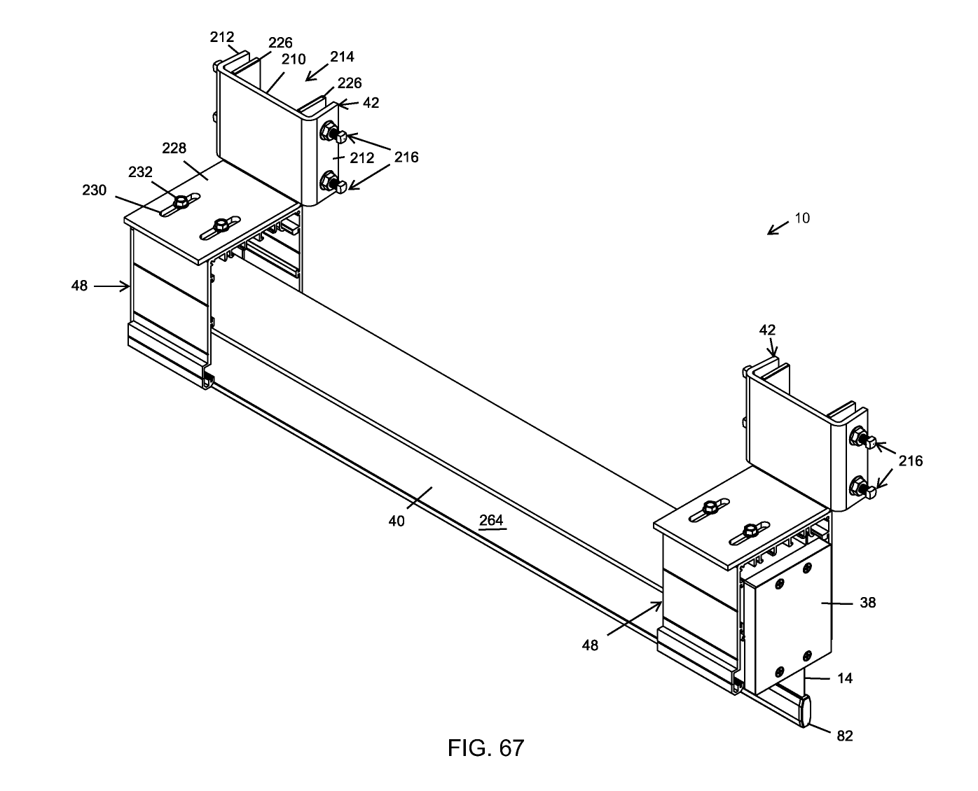

FIG. 68 is a rear perspective view of a motorized roller shade system that is installed using a pair of pushup hoods that connect to pushup clips installed at opposing ends of the roller tube; the view showing the motorized roller shade system installed in the pushup hoods; the view also showing a window frame clamp connected to each pushup hood which is configured to clamp the pushup hood to a window frame member thereby installing the pushup hood to a window frame member without using fasteners that penetrate the window frame member; the view showing the mounting plate of the window frame clamp bolted to the upper wall of the pushup hood using fasteners;

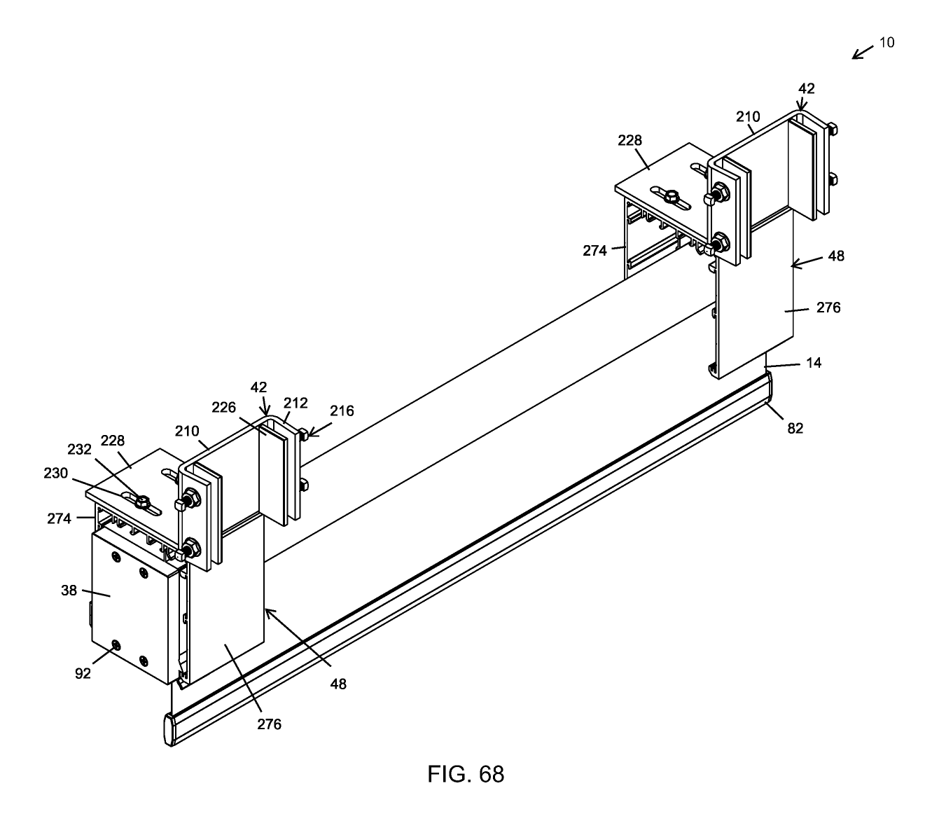

FIG. 69 is a front exploded perspective view of a motorized roller shade system that is installed using a pair of pushup hoods that connect to pushup clips installed at opposing ends of the roller tube; the view also showing a window frame clamp configured to connect to each pushup hood which is configured to clamp the pushup hood to a window frame member thereby installing the pushup hood to a window frame member without using fasteners that penetrate the window frame member; the view showing the window frame clamps exploded from the pushup hoods which are exploded from the motorized roller shade system having pushup clips connected to the end plates and end caps as well as the fascia;

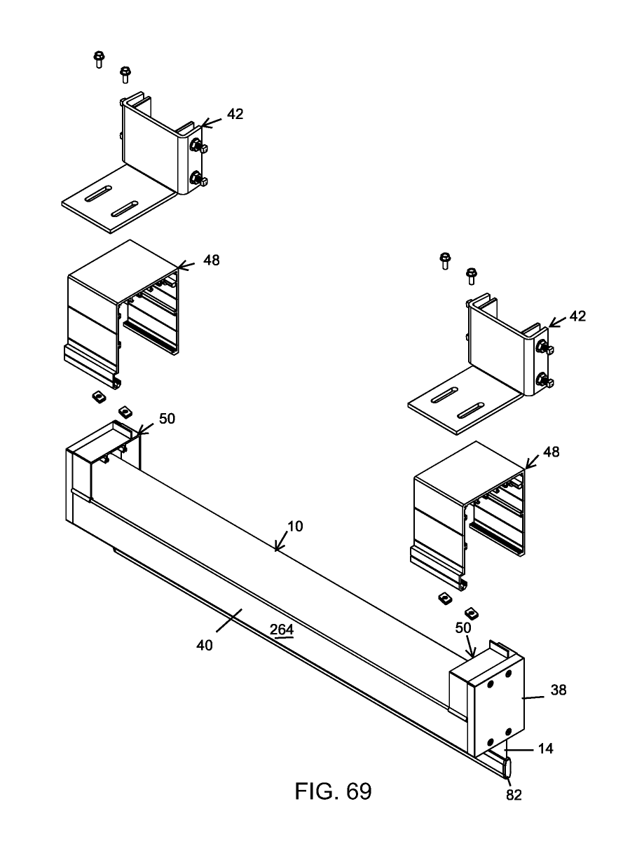

FIG. 70 is a side elevation view of a motorized roller shade system that is installed using a pair of pushup hoods that connect to pushup clips installed at opposing ends of the roller tube; the view showing the motorized roller shade system installed in the pushup hoods; the view showing the forward side of the pushup hood connected to and/or sealed to a ceiling or ceiling tile having a plenum positioned above the ceiling; the view showing a T-shaped ceiling bracket connected to and partially positioned between the forward end of the pushup hood and the ceiling that helps to seal the pushup hood to the ceiling as well as provide support for the ceiling or ceiling tile; the view showing the bottom of the fascia in approximate alignment with the bottom surface of the bottom surface of the ceiling; the view also showing the gap positioned between the rear surface of the shade material and the pushup clips through which heated air trapped between the shade material and the window travels upward and into the plenum above the ceiling;

FIG. 71 is a perspective view of a motorized roller shade system that is installed using a pair of pushup hoods that connect to pushup clips installed at opposing ends of the roller tube; the view showing the motorized roller shade system installed in the pushup hoods; the view showing the forward side of the pushup hood connected to and/or sealed to a ceiling or ceiling tile having a plenum positioned above the ceiling; the view showing a T-shaped ceiling bracket connected to and partially positioned between the forward end of the pushup hood and the ceiling that helps to seal the pushup hood to the ceiling as well as provide support for the ceiling or ceiling tile; the view showing the bottom of the fascia in approximate alignment with the bottom surface of the bottom surface of the ceiling;

FIG. 72 is a perspective view of a wireless control used to control the operation of motorized roller shade system through the transmission of wirelessly control signals;

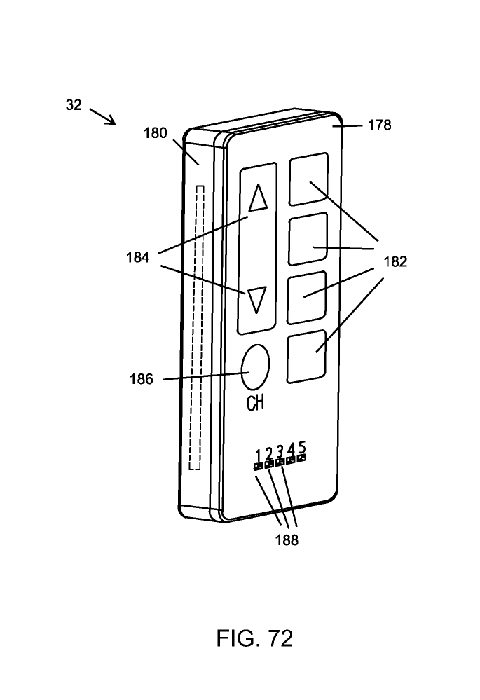

FIG. 73 is a perspective view of a hardwired control used to control the motorized roller shade system through the transmission of control signals over wired communication through a lead connected to the hardwired control and the motorized roller shade system;

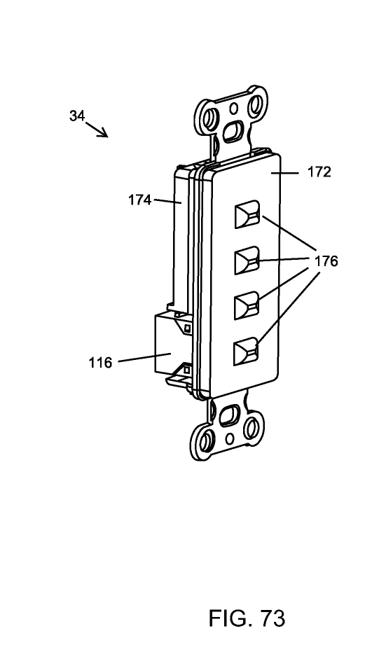

FIG. 74 is a side elevation view of a plurality of motor control assemblies with battery tubes attached thereto that house a plurality of batteries including an eight D-cell battery tube, a six D-cell battery tube, a four D-cell battery tube, a three D-cell battery tube, and a three AA-cell battery tube as examples. These motor control assemblies can be swapped into the roller tube of the manually controlled roller shades shown herein utilizing the same counterbalance assembly thereby quickly and easily converting a manually controlled roller shade to a motor controlled roller shade;

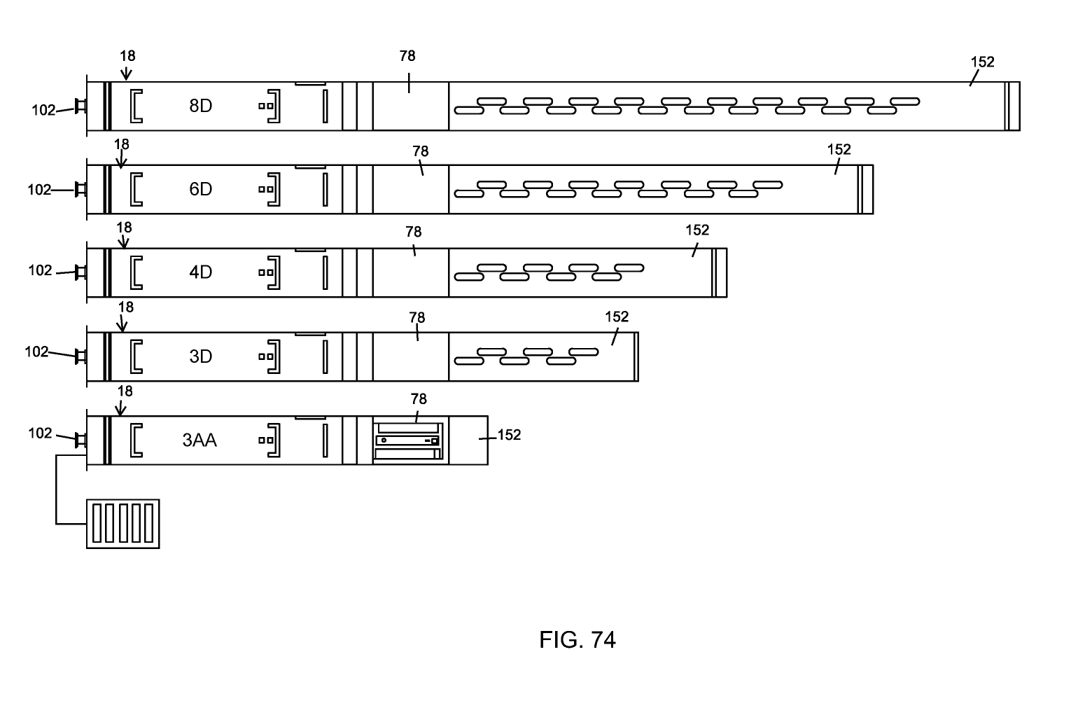

FIG. 75 is a perspective view of an exemplary motorized roller shade system, the view showing a pair of motorized roller shades connected to a power panel by a hardwired lead that provides power and control signals to the motorized roller shades; the view showing a hardwired control connected to the power panel by a hardwired lead that transmits power and control signals to the motorized roller shades through the power panel; the view also showing a wireless control that can take the form of a wireless remote control, a cell phone, a tablet or any other electronic device that is configured to transmit wireless signals that are then used to control the motorized roller shades; the view also showing a gateway that serves as a repeater or middleman device that receives control signals from the wireless control, stores them and rebroadcasts them to the motorized roller shades; the view also showing a battery powered motorized roller shade wirelessly connected to the system and controlled wirelessly;

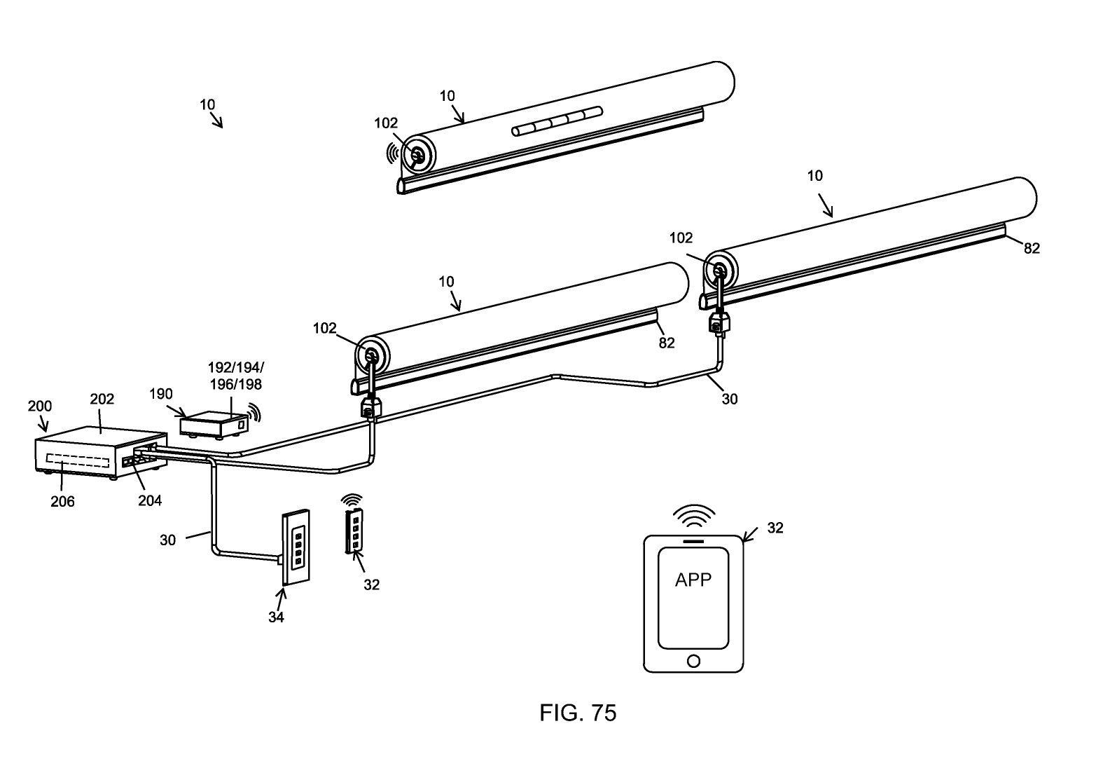

FIG. 76 is a side cut-away elevation view of a motorized roller shade the view showing the motor control assembly positioned within the hollow interior of the roller tube, the motor control assembly having a battery tube connected to its inward end, the battery tube configured to receive a plurality of batteries therein, the battery tube having an aperture configured to facilitate the insertion and removal of the batteries through the sidewall of the roller tube thereby obviating the need to remove that battery tube from the roller tube in order to replace the batteries; the view also showing a counterbalance assembly having a plurality of springs positioned within the hollow interior of the roller tube on an end opposite the motor control assembly;

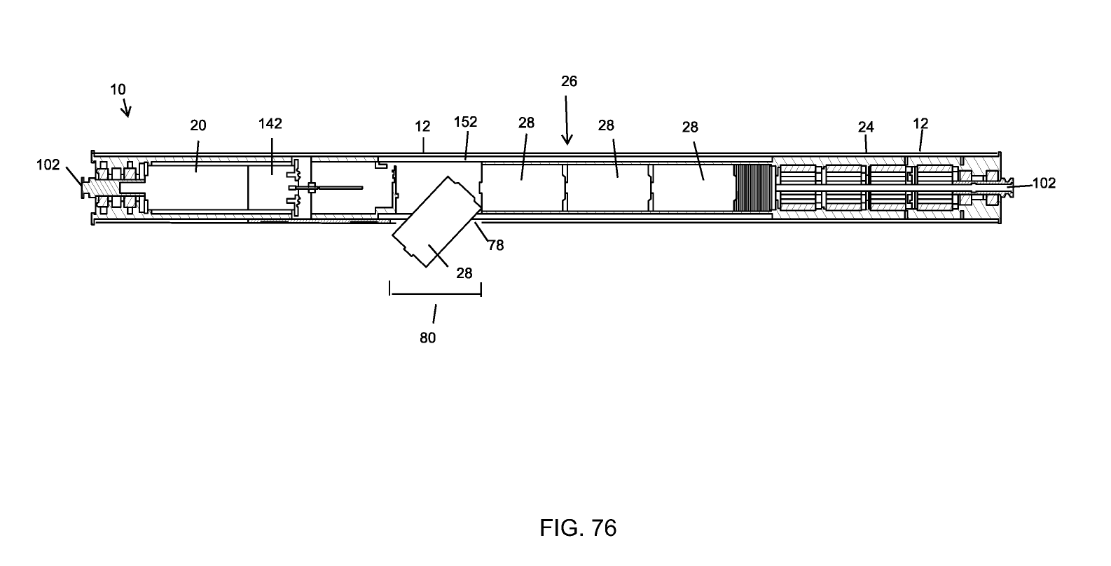

FIG. 77 is a perspective view of a motorized roller shade having an external battery tube that houses a plurality of batteries, the external battery tube connected to the motorized roller shade by a lead;

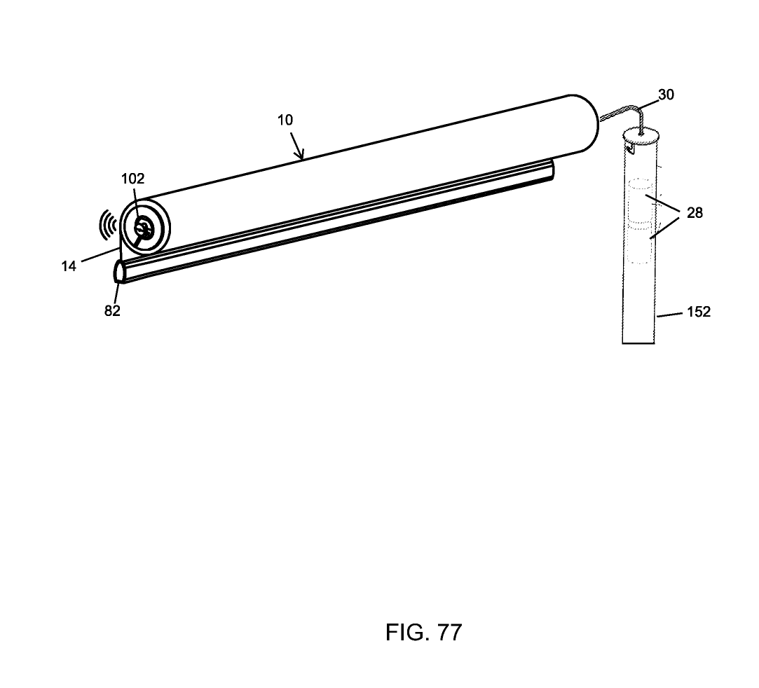

FIG. 78 is a front, or room-side, perspective view of a motorized roller shade system that is installed using a pair of pushup hoods that connect to pushup clips installed at opposing ends of the roller tube; the view showing the motorized roller shade system installed in the pushup hoods; the view also showing a window frame clamp connected to each pushup hood which clamp the pushup hood to a window frame member thereby installing the pushup hood to a window frame member without using fasteners that penetrate the window frame member; the view showing the mounting plate of the window frame clamp bolted to the upper wall of the pushup hood using fasteners;

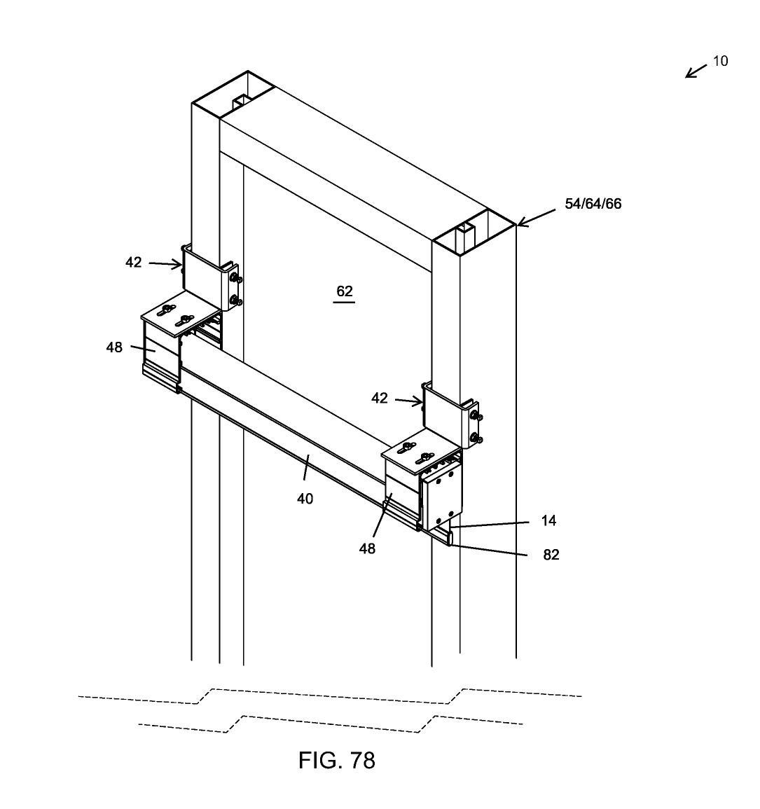

FIG. 79 is a side elevation cut-away view of a motorized roller shade system that is installed using a pair of window frame clamps connected pushup hoods that connect to pushup clips installed at opposing ends of the roller tube; the view showing the motorized roller shade system installed in the pushup hoods; the view showing the forward side of the pushup hood connected to and/or sealed to a ceiling or a ceiling tile having a plenum positioned above the ceiling; the view showing a T-shaped ceiling bracket connected to and partially positioned between the forward end of the pushup hood and the ceiling that helps to seal the pushup hood to the ceiling as well as provide support for the ceiling or ceiling tile; the view showing the bottom of the fascia in approximate alignment with the bottom surface of the bottom surface of the ceiling; the view also showing the gap positioned between the rear surface of the shade material and the pushup clips through which heated air trapped between the shade material and the window travels upward and into the plenum above the ceiling;

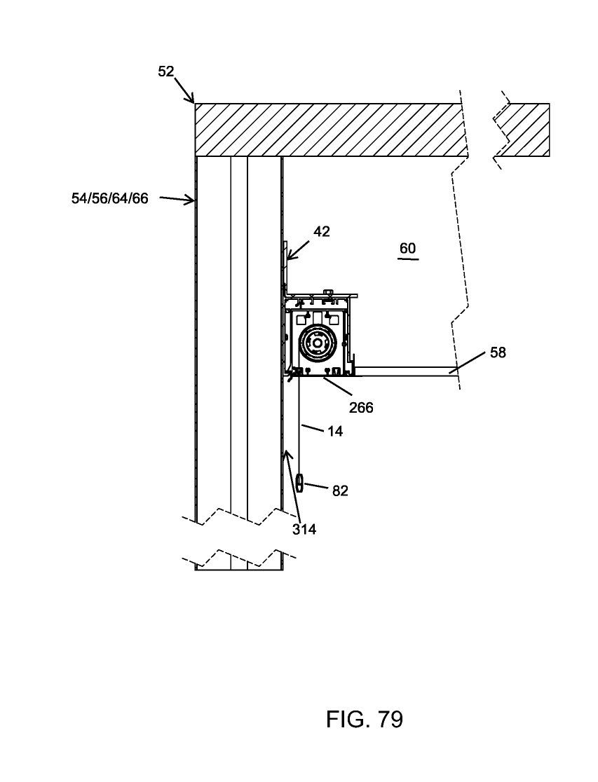

FIG. 80 is a side elevation view of a motorized roller shade system that is installed using a pair of window frame clamps connected pushup hoods that connect to pushup clips installed at opposing ends of the roller tube; the view showing the motorized roller shade system installed in the pushup hoods; the view showing the forward side of the pushup hood connected to and/or sealed to a ceiling or ceiling tile having a plenum positioned above the ceiling; the view showing a T-shaped ceiling bracket connected to and partially positioned between the forward end of the pushup hood and the ceiling that helps to seal the pushup hood to the ceiling as well as provide support for the ceiling or ceiling tile; the view showing the bottom of the fascia in approximate alignment with the bottom surface of the bottom surface of the ceiling; the view also showing the gap positioned between the rear surface of the shade material and the pushup clips through which heated air trapped between the shade material and the window travels upward and into the plenum above the ceiling.

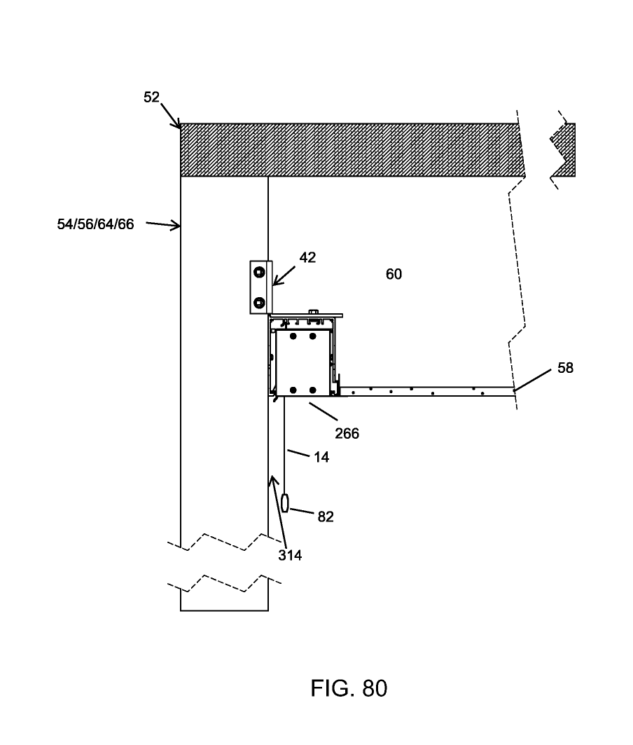

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the disclosure.

Also, while reference is made to a roller shade or roller shades herein, this too is not meant to be limiting and is instead reference to a roller shade or roller shades is merely for purposes of clarity and reference to a roller shade or roller shades is merely one example. It is hereby contemplated that the teachings herein are applicable to any form of a window shade or architectural covering.

With reference to the figures, a motorized roller shade system, methods of use and installation is presented with reference to reference numeral 10 (or simply system 10). The system 10 is formed of any suitable size, shape, design and configuration. In one arrangement, as is shown, the system 10 includes the components of a roller tube 12, shade material 14, a manual control assembly 16, a motor control assembly 18 having a motor 20 and motor controller 22, a counterbalance assembly 24, a first power source 26 including at least one battery 28, a lead 30, a wireless control 32, a hardwired control 34, end plates 36, end caps 38, fascia 40, first and second window frame clamps 42, first and second mounting brackets 44 that receive first and second mounting clips 46, first and second pushup hoods 48 that receive first and second pushup clips 50, among other components as is described herein. The system 10 is installed in a building 52 having a structural member 54 that may be an interior wall 56 and/or ceiling 58 with a plenum 60 positioned above the ceiling 58, and includes a window 62 having a window frame 64 having window frame members 66, among other components as is described herein.

Motorized Roller Shade System

With reference to the figures, a motorized roller shade system 10 is presented. Motorized roller shade system 10 is formed of any suitable size, shape and design and is configured to be installed in building 52 adjacent window 62, either in wall 56 and/or ceiling 58 and serves to move shade material 14 between an open position, wherein the shade material 14 is in a fully raised position with the shade material 14 wrapped around the roller tube 12, and a closed position, wherein the shade material 14 is in a fully lowered position with the shade material 14 unwrapped from around the roller tube 12.

In the arrangement shown, as one example, motorized roller shade system 10 includes a roller tube 12. Roller tube 12 is formed of any suitable size, shape and design and is configured to support shade material 14 and facilitate the raising and lowering of shade material 14. In the arrangement shown, roller tube 12 is an elongated generally cylindrical member that extends a length between opposing ends 68. In the arrangement shown, as one example, roller tube 12 is generally consistent in size and shape from end 68 to end 68, thereby allowing the roller tube 12 to be formed of an extrusion.

Roller Tube:

In the arrangement shown, as one example, roller tube 12 includes a hollow interior 70 that extends all or a portion of the length of roller tube 12 and includes a plurality of mounting features 72 therein. Mounting features 72 are any feature that break up the generally cylindrical interior surface of the hollow interior 70 and are used to engage corresponding mounting features 74 of the drive wheel 76 of the manual control assembly 16 and/or motor control assembly 16 in mating fashion so as to facilitate the transition of torque and/or rotation. In the arrangement shown, mounting features 72 of roller tube 12 are formed of a plurality of protrusions or rails that extend inward into the hollow interior 70 from the sidewall of roller tube 12 a distance. However, it is also contemplated that mounting features 72 may be formed of grooves or recesses in the sidewall of roller tube 12. Alternatively, mounting features 72 may be formed of a combination of protrusions or rails as well as grooves or recesses. The mounting features 74 of drive wheel 76 have a corresponding structure so that the two components mate with one another and allow the manual control assembly 16 or motor control assembly 18 to be slid into an end 68 of the roller tube 12.

One benefit to the mounting features 72 is that they may provide increased strength and rigidity to roller tube 12, which can be increasingly important in longer and larger shades. In some arrangements, roller tube 12 may also include mounting features 72 in the exterior surface of the roller tube 12 that may also increase strength and rigidity as well as facilitate connection of the shade material 14 to the roller tube 12.

In one arrangement, when motorized roller shade system 10 is powered by power source 26 which is formed of a plurality of batteries 28 that are held within the hollow interior 70 of roller tube 12, an aperture 78 is positioned in the sidewall of roller tube 12 that allows the insertion and removal of batteries 28 thereby facilitating easier removal and replacement of batteries 28. When not in use, a door 80 covers the aperture 78 so as to continue the generally cylindrical exterior shape of the roller tube 12. A similar aperture 78 may be placed in battery tube 152 when it is connected to motor control assembly 18. This aperture 78 in battery tube 152 is configured to align with the aperture 78 in the roller tube 12 when motor control assembly 18 with attached battery tube 152 is positioned within the roller tube 12. This alignment of the aperture 78 in roller tube 12 with the aperture 78 in battery tube 152 facilitates the removal of batteries 28 without removing the battery tube 152 and motor control assembly 18 from the roller tube 12.

Shade Material:

Shade material 14 is formed of any suitable size, shape and design and is configured to move between a fully raised position, wherein the shade material 14 is wrapped around the roller tube, and a fully closed position, wherein the shade material 14 is fully deployed from the roller tube 12. To facilitate this functionality, shade material 14 is any flexible material and can range from a thick or blackout material that blocks most or all light from passing through the shade material 14 to a sheer material or translucent material that allows some or most of the light to pass through the shade material 14, or anywhere between those two extremes. In the arrangement shown, shade material 14 extends a length from an upper end to a lower end. The upper end of the shade material 14 connects to the roller tube 12 and the lower end connects to a bottom bar 82. Bottom bar 82 adds weight to the lower end of the shade material 14 and helps the shade material 14 hang in a flat and straight manner. In a fully open position, bottom bar 82 is positioned adjacent the roller tube 12, or as close to the roller tube 12 as the arrangement will allow, and near the upper end of the window 62. In a fully closed position, bottom bar 82 is positioned away from the roller tube 12, or as far away from the roller tube 12 as the arrangement will allow, and near the lower end of the window 62.

Manual Control Assembly:

Roller shade system 10 is operable by manual control, through the use of manual control assembly 16, as well as through motorized control, through the use of motor control assembly 18. Manual control assembly 16 is formed of any suitable size, shape and design and is configured to facilitate manual movement of the roller tube 12 so as to facilitate manual raising and lowering of the shade material 14 between an open position and a closed position. In the arrangement shown, as one example, manual control assembly 16 includes a housing member 84 that holds a clutch member 86 that engages a chain, beaded cable or cord 88 that hangs down from the housing member 86. The clutch member 86 connects to drive wheel 76 that extends outward from the clutch member 86.

Drive wheel 76 is sized and shaped to fit within an end 68 of roller tube 12 and as such, when the hollow interior 70 of roller tube 12 is cylindrical in shape, drive wheel 76 is also generally cylindrical in shape. To facilitate the transfer of torque or rotation, drive wheel 76 includes mounting features 74 that mate with the mounting features 72 of roller tube 12 such that the drive wheel 76 may be inserted within the roller tube 12. However, any other form of connection is hereby contemplated for use, such as connecting to the external surface of the roller tube 12, screwing, bolting, welding, adhering, snap fitting, friction fitting or connecting the two components together by any other manner method or means. As such, the manual control assembly 16 is configured to be inserted at least partially within the roller tube 12.

Alternatively, mounting features 72 may be formed of a combination of protrusions or rails as well as grooves or recesses. The mounting features 74 of drive wheel 76 have a corresponding structure so that the two components mate with one another and allow the manual control assembly 16 or motor control assembly 18 to be slid into an end 68 of the roller tube 12.

In the arrangement shown, housing member 84 includes a plurality of openings 90 that are configured to receive fasteners 92, such as screws, bolts or the like therein. Fasteners 92 extend through housing member 84 and attach to other components of the roller shade assembly 10 thereby affixing the manual control assembly 16 to the roller shade assembly 10. In the arrangement shown, the fasteners 92 pass through the housing member 84 and threadably engage mounting clips 46 and/or fascia 40 thereby connecting these components together.

When manual control assembly 16 is installed in an end 68 of the roller tube 12, cord 88 hangs down from the manual control assembly 16. To operate the manual control assembly 16, the cord 88 is pulled in the direction the shade material 14 is to be deployed. As cord 88 is pulled, the engagement between cord 88 and clutch member 86 causes drive wheel 76 to rotate thereby causing the shade material 14 to wrap-around or unwrap-from roller tube 12.

To install manual control assembly 16, the mounting features 74 of drive wheel 76 of manual control assembly 16 are aligned with the mounting features 72 of roller tube 12. Once aligned, the drive wheel 76 is slid into the hollow interior 70 of the roller tube 12 until fully inserted. Once fully inserted, fasteners 92 are passed through openings 90 and tightened against or into mounting clip 46 and/or fascia 40 thereby tightening these components together.

To remove the manual control assembly 16, fasteners 92 are removed and the manual control assembly 16 is pulled away from the roller tube 12 thereby removing the drive wheel 76 form the hollow interior 70 of the roller tube 12, which is a fast and easy process. Once removed, the manual control assembly 16 can be replaced with a motor control assembly 18 by simply aligning the mounting features 74 of drive wheel 76 of motor control assembly 18 with the mounting features 72 of the roller tube 12. Once aligned, the drive wheel 76 is slid into the hollow interior 70 of the roller tube 12 until fully inserted.

In this way, a manually operated roller shade can be quickly and easily converted to a motorized roller shade. One benefit of this arrangement is the same counterbalance assembly 24 is used to facilitate manual operation as well as motorized operation. That is, when the roller shade 10 is properly counterbalanced, such that the counterbalance assembly 24 provides a proper counterbalance force that counteracts the weight of the shade material 14 and bottom bar 82, very little energy is required to move the shade material 14 between an open position and a closed position. This proper counterbalancing makes manual operation of the shade material 14 easy and light. This proper counterbalancing also allows motorized operation of the shade material 14 while using minimal power consumption. This minimal power consumption allows the motorized roller shade 10 to be powered by batteries 28 while providing elongated battery life. This minimal power consumption allows the motorized roller shade 10 to be connected to and powered by electrical lead 30 that is only capable of carrying a minimal amount of power, such as a Category 5, Category 5e or Category 6 Ethernet cable or something similar as is further described herein.

Motor Control Assembly:

Roller shade system 10 is operable by motorized control, through the use of motor control assembly 18 by replacing manual control assembly 16 with motor control assembly 18. Motor control assembly 18 is formed of any suitable size, shape and design and is configured to facilitate motorized movement of the roller tube 12 so as to facilitate motorized raising and lowering of the shade material 14 between an open position and a closed position. In the arrangement shown, as one example, motor control assembly 18 includes a motor housing 94 that houses and holds motor 20 and motor controller 22. In the arrangement shown, as one example, motor housing 94 is a generally elongated member that is cylindrical in shape. Motor control assembly extends a length from an outward end to an inward end.

A stop collar 96 is connected to the outward end of the motor housing 94. Stop collar 96 is formed of any suitable size, shape and design and is configured to engage an end 68 of the roller tube 12 and facilitate rotatable connection to roller tube 12. The outward end of stop collar 96 includes a flange 98 that is larger than the hollow interior 70 of roller tube 12 and thereby prevents insertion of the motor controller assembly 18 into hollow interior 70 beyond flange 98. One or more bearing members 100 are positioned just inward of flange 98 and are configured to engage and support roller tube 12 while also facilitating rotation of roller tuber 12.

An axle 102 extends outward from the outward end of stop collar 96. Axle 102 extends outward from stop collar 96 a distance before terminating in a flange 104 that is wider than the other portions of axle 102. In the arrangement shown, the shaft of axle 102 between the exterior surface of stop collar 96 and the inward surface of flange 104 is formed of a non-round shape. As one example, as is shown, this portion of the shaft of axle 102 has a rounded upper surface and a rounded lower surface with elongated straight walls that extend between the upper rounded end and the lower rounded end; however any other non-round shape is hereby contemplated for use such as square, rectangular, triangular, heptagonal, hexagonal, octagonal or the like. The non-round shape of this portion of the shaft of axle 102 is configured to be received within a mating or similarly shaped key slot 106, feature or opening in an end plate 36 such that when axle 102 is received within the key slot 106 of end plate 36 the axle 102 is prevented from rotating, while roller tube 12 is allowed to rotate. Once shaft of axle 102 is inserted within the key slot 106 of end plate 36, flange 104 prevents the axle 102 from unintentionally pulling out of the key slot 106.

Motor control assembly 18, may either be powered by electrical connection to an external power source by lead 30, or alternatively by connection to a plurality of batteries 28 positioned within the roller tube 12.

Motor Control Assembly Powered by Lead:

When powered by electrical connection to lead 30, a drive wheel 76 is connected to the inward end of motor housing 94 and facilitates driving rotation of roller tube 12. Drive wheel 76 is sized and shaped to fit within an end 68 of roller tube 12 and as such, when the hollow interior 70 of roller tube 12 is cylindrical in shape, drive wheel 76 is also generally cylindrical in shape. To facilitate the transfer of torque or rotation, drive wheel 76 includes mounting features 74 that mate with the mounting features 72 of roller tube 12 such that the drive wheel 76 may be inserted within the roller tube 12. Mounting features 72 may be formed of protrusions or rails, or alternatively grooves or recesses, or alternatively any combination of protrusions or rails and grooves or recesses. However, any other form of connection is hereby contemplated for use, such as connecting to the external surface of the roller tube 12, screwing, bolting, welding, adhering, snap fitting, friction fitting or connecting the two components together by any other manner method or means.

To install motor control assembly 18, the mounting features 74 of drive wheel 76 of motor control assembly 18 are aligned with the mounting features 72 of roller tube 12. Once aligned, the drive wheel 76 is slid into the hollow interior 70 of the roller tube 12, as is the length of motor housing 94 until fully inserted. Once fully inserted, the exterior surface of bearing members 100 engage the interior surface of the hollow interior 70 of roller tube 12 and the inward surface of flange 98 of stop collar 96 is adjacent or engages the end 68 of roller tube 12.

To remove the motor control assembly 18, the motor control assembly 18 is pulled away from the roller tube 12 thereby removing the drive wheel 76, motor housing 94 and stop collar 96 from the hollow interior 70 of the roller tube 12, which is a fast and easy process. Once removed, the motor control assembly 18 or a manual control assembly 16 can be replaced by simply aligning the mounting features 74 of drive wheel 76 of manual control assembly 16 or motor control assembly 18 with the mounting features 72 of the roller tube 12. Once aligned, the drive wheel 76 is slid into the hollow interior 70 of the roller tube 12 until fully inserted.

The motor housing 94 of motor control assembly 18 holds the electrical and mechanical components of the motor control assembly 18 including motor 20 and motor controller 22 as well as printed circuit board 108 (PCB 108), among other components.

PCB 108 is formed of any suitable size, shape and design and serves to house, hold, connect and interconnect the electronic components of the motor control assembly 18. In one arrangement, as is shown, PCB 108 is formed of a single, generally elongated, rectangular and generally planar board that extends a length between an interior end 112 and an exterior end 114. However any other shaped board, or multiple boards are hereby contemplated for use.

A socket 116 is connected at or near the exterior end 114. Socket 116 is formed of any suitable size, shape and design. In the arrangement shown, socket 116 is formed to receive a standard Ethernet plug, such as plug 118 shown on the interior end of lead 30, however any other form of a plug/socket arrangement is hereby contemplated for use as is the elimination of socket 116 and the use of direct wiring. Socket 116 serves to connect lead 30, and the wires therein, to the components of PCB 108 in a convenient, durable, fast and removable manner. Namely, socket 116 transmits power and control signals to and from PCB 108. A socket 116 is also shown at the end of lead 30 that similarly facilitates connection to another plug 118.

PCB 108 also includes a microprocessor 120 and memory 122. Any form of a microprocessor 120 and memory 122 is hereby contemplated for use. Microprocessor 120 serves to process information and output commands according to instructions or software stored in memory 122. Memory 122 is any form of an information storage device such as flash, ram, dram, a hard drive or the like. In this way, microprocessor 120 controls operation of motor 20 in the manner identified by instructions or software stored in memory 122. In one arrangement, microprocessor 120 and memory 122 are formed of a single combined package. In another arrangement microprocessor 120 and memory 122 are formed of separate devices or are formed of a combination multiple devices. Alternatively microprocessor 120 may be formed of multiple separate devices and/or memory 122 may be formed of multiple separate devices that when connected or combined cooperate to provide the function of controlling motor 20 in the desired manner.

In one arrangement, microprocessor 120 with memory 122 is an EM358x High-Performance, Integrated ZigBee/802.15.4 System-on-Chip Family manufactured by Silicon Laboratories. However, any other suitable microprocessor 120 is hereby contemplated for use. As is any other form of a communication protocol such as a proprietary communication scheme, Z-wave, or the like.

Microprocessor 120 receives control signals from through lead 30 while simultaneously receiving power therefrom as well.

In one arrangement, as is shown, motor control assembly 18 includes an antenna 124 connected to a radio 126.

Antenna 124 is any form of a device that receives and/or sends wireless signals and transfers them to other components, such as radio 126. When operating in a reception mode, antenna 124 receives wireless signals that are broadcast over the air and transfers these signals to radio 126 or other components of the system 10. When operating in a broadcast mode, antenna 124 receives signals and broadcasts them over the air. In one arrangement, as is shown, antenna 124 is a loop antenna, monopole antenna or fractal antenna that is formed as part of a disc that is positioned in the exterior end of the motor control assembly 18. In this position, antenna 124 is accessible to wireless signals. In an alternative arrangement, a monopole antenna extends outward from motor control assembly 18. Any other form of an antenna 124 is hereby contemplated for use.

Radio 126 is any form of a device which receives wireless control signals from antenna 62, filters the wireless control signals, processes them into a usable form and then forwards on the processed signals as output to microprocessor 120. When radio 126 is a one-way device, meaning it facilitates one-way communication, meaning it only receives signals from antenna 124 and forwards them on to microprocessor 120, radio 126 is known as a receiver. When radio 126 is a two-way device, meaning it facilitates two-way communication, meaning it not only receives signals from antenna 124 and forwards them on to microprocessor 120 but it also receives signals from microprocessor 120 and processes them and transmits or broadcasts them through antenna 124, radio 126 is known as a transceiver.

In the arrangement shown, the interior end 112 of PCB 108 connects to the exterior end 128 of motor 20. In one arrangement, a connector 130 is positioned between the PCB 108 and motor 20 that helps to facilitate connection between the two components. A drive shaft 132 extends outward from the exterior end 128 of motor 20 and into a recess 134 formed in the interior end 112 of PCB 108. A magnet 136 is connected to drive shaft 132. In one arrangement, as is shown, magnet 136 is formed of a magnet wheel that includes a plurality of magnet poles or fields. As the drive shaft 132 rotates so rotates magnetic wheel 136 and so rotates the magnetic fields of the magnetic wheel 136. A pair of sensors 138 are positioned adjacent recess 134, magnetic wheel 136 and drive shaft 132. In the arrangement shown, one sensor 138 is positioned on each side or opposing sides of recess 134, magnetic wheel 136 and drive shaft 132 and within sensing distance of magnetic wheel 136. As drive shaft 132 rotates, so rotates magnetic wheel 136 within recess 134, as magnetic wheel 136 rotates, sensors 138 sense the passing magnetic fields and transmits these signals to microprocessor 120 which tracks or counts these fields or ticks, wherein each passing magnetic field equates to a single tick. From this information, the total number of fields or ticks can be determined between a fully open position and a fully closed position. Also from this information, the position of the bottom bar 82 can be determined at all times. As an example, if there are 1,000 ticks between a fully open and fully closed position and the microprocessor 120 detects that the motor 20 has rotated 500 ticks or counts from a fully open or fully closed position, the microprocessor 120 recognizes that the bottom bar 82 is at a 50% open position. In this way, the microprocessor 120 using magnet 136 and sensors 138 can track the position of the shade material 14.

Sensors 138 can be any form of a sensor such as a mechanical sensor, an optical sensor, a magnetic sensor or any other form of a sensor that detects motion and/or rotation of motor 20, drive shaft 132 and/or magnet wheel 136. In one arrangement, as is shown, sensors 138 are a pair of Hall Effect sensors that detect the passing magnetic fields of magnetic wheel 136.

The interior end 140 of motor 20 is connected to gear box assembly 142. More specifically, a drive shaft 132 that extends outward from the interior end 140 of motor 20 connects to gear box assembly 142. In one arrangement, drive shaft 132 that extends out of the exterior end 128 of motor 20 and drive shaft 132 that extends out of the interior end 140 of motor 20 are one unitary drive shaft and rotate in unison with one another; in an alternative arrangement, they are separate components. Gear box assembly 142 reduces the number of rotations of drive shaft 132 to a more suitable speed for raising and lowering the shade material 14. That is, gear box assembly 142 serves as a gear reduction for the output of motor 20. That is, motor 20 tends to rotate at a speed higher than the desired open or close speed of bottom bar 82. As such, the output shaft 144 of gear box assembly 142 rotates at a slower rotational speed than the drive shaft 132 of motor 20. This gear reduction can be in the range of 10-to-1, 20-to-1, 30-to-1, 40-to-1, 50-to-1 60-to-1, 70-to-1, 80-to-1, 90-to-1, 100-to-1, 200-to-1, or more, or any range therein or there between. Specifically 20-to-1 to 80-to-1, and more specifically, depending on the particulars of the configuration of motor 20 and the amount of power provided to motor 20, examples of gear box assembly 142 include approximately 22-to-1, 42-to-1 and 73-to-1 gear ratios that have been tested with success and provide an aesthetically pleasing open and close speed.

By providing a low amount of power to motor 20, this causes motor 20 to rotate relatively slowly, this causes gear ratio of gear box assembly 142 to be lower, which reduces back drive when the shade material 14 or bottom bar 82 are manually moved, which allows for the shade material 14 and/or bottom bar 82 to be manually moved without breaking the gears of gear box assembly 142. This also allows the microprocessor 120 to track the position of the bottom bar 82/shade material 14 by sensors 138 when manually moved such that the microprocessor 120 constantly is aware of the present position of the bottom bar 82 and shade material 14. Because the magnetic wheel 136 is connected to the end of drive shaft 132 that is not gear reduced, this provides a high level of precision and allows for tracking of the position of the bottom bar 82/shade material 14 with tight error bands and high precision. In addition, this allows microprocessor 120 to be programmed to respond to a tug. That is, when the bottom bar 82 is moved by less than a predetermined displacement (a micro-tug) the microprocessor 120 detects this displacement and responds by moving the bottom bar 82 to the next intermediate position above the current position of the bottom bar 82 (which can be any pre-programmed or pre-determined position such as 75% open, 50% open, 25% open or 100% open or the like); or if the bottom bar 82 is moved by more than a predetermined displacement but less than a maximum displacement (a full tug or just tug) the microprocessor 120 detects this displacement and responds by moving the bottom bar 82 to the full open position; or if the bottom bar 82 is moved by more than a maximum displacement (a manual movement) the microprocessor 120 detects this displacement and responds by merely tracking the current position of the bottom bar 82 and not responding with a movement, thereby allowing the user to move the bottom bar 82 to a desired location and by not responding to this movement, the position to which the bottom bar 82 is moved is maintained.

In one arrangement, the gears of gear box assembly 142 are formed of a metallic material which provides superior strength and wear resistance. In an alternative arrangement, some or all of the gears of gear box assembly 142 are formed of a non-metallic material such as plastic, PVC, Nylon, composite or the like which tends to be quieter at the cost of some strength and wear resistance. However, to improve strength and wear resistance, the non-metallic gears are elongated or lengthened to provide additional surface area which provides greater strength and wear resistance for the plastic components. Also, in one arrangement, the gears of gear box assembly 142 are formed of straight gears, which operate in an effective manner. In an alternative arrangement, some or all of the gears of gear box assembly 142 are formed of a conical gear, that curves or twists. While conical gears are more complicated to manufacture and use, conical gears mesh with one another in a smoother manner as they engage along the length of the curved gears and therefore they provide smoother and quieter operation.

Output shaft 144 extends outward from the interior end 146 of gear box assembly 142. Output shaft 144 rotates at a reduced speed as compared to drive shaft 132 due to the gear reduction of gear box assembly 142. Output shaft 144 extends through an opening 148 in cover 150 and connects to drive wheel 76. In this way, output shaft 144 rotates drive wheel 76 which rotates roller tube 12.

Lead:

In arrangements wherein motor control assembly 18 is electrically connected to lead 30, lead 30 is formed of any suitable size, shape and design of a cable, wire, or electrical connecting member or the like that is capable of carrying power to the motor control assembly 18 and/or control signals. In one arrangement shown, as one example, lead 30 is a generally flat 8-wire cable, such as an Ethernet cable, or other Ethernet cable such as CAT5, CAT5e, CAT6 or the like, or similar multi-wire cable that is capable of carrying power as well as control signals.

The exterior end of lead 30 includes a socket 116 and the interior end of lead 30 includes a plug 118. In one arrangement, as is shown, socket 116 is sized and shaped to receive a standard Ethernet plug, and plug 118 is itself a standard Ethernet plug, also known as an “RJ45” jack (socket 116) and plug (plug 118).

In the arrangement wherein Ethernet cable is used as lead 30 to connect the components of system 10, such as a CAT5, CAT5e or CAT6 or similar standardized “Ethernet” cable, this type of cable is formed of eight independent wires or lines. Each line has specifications for the amount of information, current and voltage it is designed to carry.

In one arrangement, of the eight lines in Ethernet cable two lines are used to carry positive power and two lines are used to carry negative power, or stated another way two lines are connected to ground. In one arrangement the two positive power lines and the two negative power lines each carry 24 volts. By having two lines carry power in and power out of the shades motor control assembly 18 (and/or hardwired control 34), this provides greater capacity effective at the motor control assembly 18 (and/or hardwired control 34). This reduces the potential that the capacity of any line of lead 30 could be exceeded (which could lead to damage such as wire burn-out, shorting or the like) or failure to operate due to a lack of needed power. While each line of many forms of Ethernet cable are specified to carry up to 2.0 Amps of current, due to the efficiency of the configuration of system 10, due in large part to counterbalance assembly 24 and the low power draw of motor 20 presented herein, it has been tested and it is anticipated that the maximum current draw at maximum peak will not exceed 0.5 Amps, which is well below the maximum threshold for lead 30 when an Ethernet cable is used. As such, due to the efficiency of the motorized roller shade 10 presented herein this allows for power and control of the motorized window roller shade 10 using Ethernet cable as lead 30.

In another arrangement, instead of carrying positive power on two lines and negative power on two lines, an even greater level of security is provided by using six lines of lead 30 to carry power. That is, in this arrangement, positive power is carried on three lines and negative power is carried on three lines. This arrangement leaves two lines for control signals. This arrangement provides added power and protection to power spikes or surges over using just two lines for each of positive and negative power.

Of the eight lines of lead 30 when Ethernet cable is used, two lines are utilized to carry control signals, one line being a data line-in, that carries control signals into the motor control assembly 18 or other components of the system 10 (such as hardwired control 34), and one line being a data line-out, that carries control signals out of the motor control assembly 18 or other components of the system 10 (such as hardwired control 34), or the like.

Using Ethernet cable as lead 30 provides many advantages over using conventional 120 volt AC power. Namely, due to the fact that the lead 30 is carrying such a low voltage and amperage, lead 30 presents a much lower risk of causing a fire or other damage. As such, fewer precautions are needed when running lead through building 52 as compared to standard three-wire 120 volt AC wiring (such as running the wire through conduit). Because fewer precautions are needed, this can reduce the cost of running the lead 30, and in addition, in many situations a certified electrician is not needed to run lead 30, which further reduces costs. In addition, only a single lead 30 is needed to both power and control the system 10, which eliminates the complexity and cost and duplicity of running independent power and control lines. In addition, when Ethernet cable is used as lead 30, Ethernet cable is widely available, inexpensive, widely understood and easily used and installed. As such, there is no need to purchase an expensive proprietary or less-often used wire or cable and therefore using Ethernet cable as lead 30 provides many advantages.

Motor Control Assembly Powered by Batteries:

In many applications it is not possible or convenient to run lead 30 to the location of each motorized roller shade 10 that is part of the system 10. In these situations, motorized roller shades 10 that are powered by power source 26, such as one or more batteries 28, are desirable.

When motor control assembly 18 is powered by batteries 28, or remote power source 26 such as a solar cell, power cell or the like, the power source 26 may be positioned exterior to the roller tube 12 or alternatively within the roller tube 12.

When power source 26 is positioned exterior to roller tube 12, power source 26 is connected to motor control assembly 18 using lead 30 in the manner described herein. This allows power source 26 to essentially be positioned anywhere outside of the roller tube 12. Examples include, attaching the power source 26 to a wall 56 of the building 52 adjacent or behind the shade material 14, placing the power source 26 within the fascia 40, placing the power source 26 above or below the roller tube 12 or placing the power source 26 at any other location that is convenient. In one arrangement, as is shown, power source 26 is formed of a plurality of batteries 28 that are housed within a battery tube 152. Battery tube 152 is then connected to motor control assembly 18 by lead 30, as is described herein. In an alternative arrangement, one or more batteries 28 are included within motor control assembly 18. This one or more batteries 28 may be a rechargeable battery, such as a lithium-ion battery. In the event that battery 28 is rechargeable and is contained within the motor control assembly 18, the motor control assembly 18 includes a plug-in connection point that facilitates connection of lead 30 which facilitates recharging of battery 28. Alternatively, in the event that battery 28 is rechargeable and is contained within the motor control assembly 18, lead 30 connects to and extends into the motor control assembly 18 and facilitates recharging of battery 28. In this arrangement, lead 30 connects to an external power source, such as a battery pack, a solar cell, line power or any other power source.

When power source 26 is positioned within roller tube 12, in one arrangement power source 26 is connected directly to motor control assembly 18. In the arrangement shown, as one example, power source 26 is a battery tube 152 that houses a plurality of batteries 28 that is connected to an end of the motor control assembly 18. This allows power source 26 to be installed and removed from the roller tube 12 simultaneously with motor control assembly 18. In an alternative arrangement, power source 26/battery tube 152 are a separate component from the motor control assembly 18 that are electrically connected to one another by a lead 30 (such as a conventional wire or wires) within the roller tube 12. In one arrangement, herein.

In one arrangement, when motorized roller shade 10 is powered by power source 26 which is formed of a plurality of batteries 28 that are held within a battery tube 152 positioned within the hollow interior 70 of roller tube 12, an aperture 78 is positioned in the sidewall of roller tube 12 that allows the insertion and removal of batteries 28 thereby facilitating easier removal and replacement of batteries 28 without having to remove the battery tube 152 and/or motor control assembly 18 to replace the batteries 28.

In one arrangement, when powered by remote power source 26 that is positioned within the roller tube 12, the battery tube 152, batteries 28 and motor control assembly 18 rotate with the roller tube 12 as it rotates upon stationary axle 102. Alternatively, a drive wheel 76 is connected to motor control assembly 18 and rotates the roller tube 12 around the stationary battery tube 152, batteries 28 and motor control assembly 18. When not in use a door 80 covers the aperture 78 so as to continue the generally cylindrical exterior shape of the roller tube 12.

Battery tube 152 may house any number of batteries 28 or any form of a battery 28. As is shown, as examples, battery tube 185 can house 8 D-cell batteries, 6 D-cell batteries, 4 D-cell batteries, 3 D-cell batteries, 3 AA batteries (or four 4 AA batteries) or any other amount of batteries or arrangement of batteries 28.

When motorized window shades 10 are powered by batteries 28, power consumption is minimized to extend the life of the batteries 28 and maximize the interval between required replacements of the batteries 28. This is accomplished by various techniques such as utilizing sleep mode and polling for a wireless command signals as is described herein.

Counterbalance Assembly:

Counterbalance assembly 24 is formed of any suitable size, shape and design and serves to provide a counterbalance force that counteracts the forces inherent when opening or closing window shade 10. In the arrangement shown, as one example, counterbalance assembly 24 extends in a generally cylindrical manner from an exterior end to an interior end.

A stop collar 154 is connected to the outward end of counterbalance assembly 24. Stop collar 154 is formed of any suitable size, shape and design and is configured to engage an end 68 of the roller tube 12 and facilitate rotatable connection to roller tube 12. The outward end of stop collar 154 includes a flange 156 that is larger than the hollow interior 70 of roller tube 12 and thereby prevents insertion of the counterbalance assembly 24 into hollow interior 70 beyond flange 156.

An axle 102 extends outward from the outward end of stop collar 154. Axle 102 extends outward from stop collar 154 a distance before terminating in a flange 104 that is wider than the other portions of axle 102. In the arrangement shown, the shaft of axle 102 between the exterior surface of stop collar 154 and the inward surface of flange 104 is formed of a non-round shape. As one example, as is shown, this portion of the shaft of axle 102 has a rounded upper surface and a rounded lower surface with elongated straight walls that extend between the upper rounded end and the lower rounded end; however any other non-round shape is hereby contemplated for use such as square, rectangular, triangular, heptagonal, hexagonal, octagonal or the like. The non-round shape of this portion of the shaft of axle 102 is configured to be received within a mating or similarly shaped key slot 106, feature or opening in an end cap 38 such that when axle 102 is received within the key slot 106 of end cap 38 the axle 102 is prevented from rotating, while roller tube 12 is allowed to rotate. Once shaft of axle 102 is inserted within the key slot 106 of end cap 38, flange 104 prevents the axle 102 from unintentionally pulling out of the key slot 106.

As is shown, counterbalance assembly 24 is inserted in an end 68 of roller tube 12 that is opposite motor control assembly 18/manual control assembly 16. However, in an alternative arrangement, counterbalance assembly 24 may be connected to or inserted within the same end as motor control assembly 18/manual control assembly 16 or positioned at any point within or exterior to roller tube 12.

In the arrangement shown, the exterior surface of counterbalance assembly 24 includes mounting features 158 that mate with the mounting features 72 in the hollow interior 70 of roller tube 12.

Counterbalance assembly 24 includes one or more springs 160. In the arrangement shown, a pair of power springs (also known as a clock springs or ribbon springs) are shown contained within individual spring housings 162. This type of spring 160 is wrapped in a circular fashion around itself and one end of the spring 160 remains stationary as the roller tube 12 rotates whereas the other end of the spring 160 rotates as the roller tube 12 rotates. In this way, spring 160 builds up a force therein or loads as the roller tube 12 rotates in a first direction. This force is then released or unloaded when the roller tube 12 is rotated in a second direction, opposite the first direction.

The engagement of mounting features 158 of counterbalance assembly 24 with the mounting features 72 in the hollow interior 70 of roller tube 12 cause exterior end of springs 160 to rotate with the roller tube 12. In contrast, the interior end of springs 160 are configured to connect to shaft 164 that extends through springs 160 that remains stationary as roller tube 12 rotates. In the arrangement shown, as one example, shaft 164 includes features that allow the inward end of springs 160 to move over the shaft 164 when rotated in one direction, while the features hold the inward end of springs 160 when rotated in a second direction opposite the first direction. This configuration prevents the springs 160 from being back winded or back driven if the counterbalance assembly 24 is driven beyond its intended range, which can cause breakage or other significant problems.

In the arrangement shown where two springs 160 and spring housings 162 are used, spring housings 162 include locking features 166 that facilitate locking engagement of two or more spring housings 162 together. In the arrangement shown, as one example, locking features 166 are corresponding male and female members that can be inserted into one another and locked together.

In addition, while a power spring, clock spring or ribbon spring is shown being used, a torsion-type spring is also hereby contemplated for use. In this arrangement, one end of the torsion spring rotates with the roller tube 12 and the opposite end of the torsion spring remains stationary thereby loading and unloading the torsion spring.

In the arrangement shown, counterbalance assembly 24 also includes one or more bearings 168. Bearings 168 facilitate rotation of the roller tube 12 upon counterbalance assembly 24. In the arrangement shown, one or more bearings 168 are held within the opposing halves of stop collar 154.

In the arrangement shown, a cover 170 is connected to the inward end of the counterbalance assembly 24. In one arrangement, cover 170 includes the mounting features 158 in its exterior surface that engage the roller tube 12. Similarly, in one arrangement, spring housings 162 includes mounting features 158 in their exterior surface that align with the mounting features 158 in the cover 170 and/or the mounting features 158 in the stop collar 154.

Hardwired Control:

Motorized roller shade system 10 includes one or more hardwired controls 34. Hardwired control 34 is formed of any suitable size, shape and design and serves to control the components of system 10 through control signals carried through lead 30. In the arrangement shown, hardwired control 34 includes a faceplate 172, back plate 174 as well as internal components. In one arrangement, as is shown, faceplate 172 is sized and shaped to fit within a standardized large opening of a standard light switch cover plate. This standardized large opening is known as a “Decora®” switch or opening which is a newer style of device that has been widely adopted as standard in the industry. All Decora® devices fit into the same shape opening—a large rectangular opening roughly 1.25″ wide by 2.5″ tall. Decora® devices are alternately known as decorator, designer, rocker, paddle, block, flat or wide switches. The term “Decora” is a trademark of Leviton, a major manufacturer of electrical devices but the term is widely understood and adopted throughout the industry. By utilizing the standardized Decora® size and shape, this allows for the use of conventional and widely available parts. As such, the exterior peripheral shape of face plate 172 fits with close tolerances within the opening in conventional Decora® cover plate.

Like faceplate 172, back plate 174 is configured to conform to existing standards such that hardwired control 34 can be used seamlessly with existing and widely available components. More specifically, back plate 174 has an exterior periphery that is similarly sized and shaped like that of face plate 172. This configuration allows hardwired control 34 to fit within conventional electrical boxes, also known as gang boxes. To facilitate connection to conventional electrical boxes, back plate 134 includes tabs 176 that extend upward and downward from the upper side and lower side of back plate 174. Tabs 176 include ears 178 that extend outward to the side which help facilitate alignment with the electrical box and also include one or more openings 178 that allow for passage of a conventional fastener, such as a screw or bolt that facilitates connection to the electrical box.

Hardwired control 34 includes a plurality of buttons 176 that extend through openings in faceplate 172. When pressed, buttons 176 transmit wired control signals through lead 30 which is connected to hardwired control 34 by connection to socket 116 positioned in back plate 174. In one arrangement, a single column of buttons 176 are presented that extend vertically across the faceplate 172. In one arrangement, the uppermost button 176 is designated as an up button, which when pressed moves the shades 10 connected to hardwired control 34 to the up or open position, and the lowermost button 176 is designated as a down button, which when pressed moves the shades 10 connected to hardwired control 34 to the down or closed position. Any number of buttons 176 is positioned between the up button and down button. These additional buttons 176 are configured to move the shades 10 connected to the hardwired control 34 to preset positions. These preset positions can be custom set by the user. Alternatively, these preset positions can be factory set as defaults. In the arrangement wherein two buttons 176 are positioned between the up button and the down button, the default setting may be to assign a default setting of approximately 33% closed and 66% closed to the buttons 176, respectively, as an example. In the arrangement wherein three buttons 176 are positioned between the up button and the down button, the default setting may be to assign a default setting of approximately 25% closed, 50% closed and 75% closed to the buttons 176, respectively, as an example. Any other number of buttons 176 and configuration of buttons 176 are hereby contemplated for use.

In the arrangement, wherein only a single column of buttons 176 is presented in hardwired control 34, all motorized shades 10 connected to system 10 and assigned to respond to hardwired control 34 are controlled by the hardwired control 34. Alternatively, if the user wants to separate control of the motorized shades 10 into groups, such that not all motorized shades 10 respond to the single hardwired control 34, a second, third or more hardwired control 34 is added to the system 10 and the motorized shades 10 that are to be controlled by the hardwired control 34 are programmed to only respond to a specific hardwired control 34.

In an alternative arrangement, as an example, one configuration of hardwired control 34 includes two or more columns of buttons 176. In this arrangement, where two columns of buttons 176 are presented, motorized shades 10 connected to the system 10 can be controlled in two groups, or two banks, using only a single hardwired control 34. In an arrangement, wherein three columns of buttons 176 are presented, motorized shades 10 connected to the system 10 can be controlled in three groups, or three banks, using only a single hardwired control 34, and so on. In these arrangements, motorized shades 10 are programmed to respond to specific columns of buttons 176 while not responding to other columns of buttons 176.

Wireless Control:

System 10 includes one or more wireless controls 32. Wireless control 32 is formed of any suitable size, shape and design and serves to wirelessly control the components of system 10 through the transmission of wireless control signals. In the arrangement shown, wireless control 32 includes a faceplate 178, back plate 180 as well as internal components. In one arrangement, as is shown, like hardwired control 34, faceplate 178 and back plate 180 is sized and shaped to fit within a standardized large opening of a conventional cover plate, such as a Decora® opening described herein. This provides the advantage that wireless control 32 can be inserted within a standard cover plate which is widely available and will likely match an existing home or building's fixtures.

Wireless control 32 includes a plurality of buttons 182 thereon. In one arrangement, as is shown, wireless control 32 includes a single column of preset position buttons 180 are presented that extend vertically across a portion of faceplate 178. In one arrangement, the uppermost button 182 is designated as an up button 182, which when pressed moves the motorized shades 10 to the up or open position, and the lowermost button 182 is designated as a down button 182, which when pressed moves the motorized shades 10 to the down or closed position. Any number of preset position buttons 182 is positioned between the up button 182 and down button 182. These additional buttons 182 are configured to move the motorized shades 10 to preset positions. These preset positions can be custom set by the user. Alternatively, these preset positions can be factory set as defaults. In the arrangement wherein two buttons 182 are positioned between the up button 182 and the down button 182, the default setting may be to assign a default setting of approximately 33% closed and 66% closed to the buttons, respectively, as an example. In the arrangement wherein three buttons 182 are positioned between the up button 182 and the down button 182, the default setting may be to assign a default setting of approximately 25% closed, 50% closed and 75% closed to the buttons, respectively, as an example. Any other number of buttons 182 and configuration of buttons 182 are hereby contemplated for use.

Wireless control 32 also includes a toggle button 184. In the arrangement shown, toggle button 184 is rectangular in shape and vertically elongated. Toggle button 184 includes an upwardly pointing arrow positioned at an upper portion of toggle button 184, and a downwardly pointing arrow positioned at a lower portion of toggle button 184. When the upper portion of toggle button 184 is pressed, wireless control 32 transmits a signal to motorized shades 10 to move up an incremental or small amount; when the lower portion of toggle button 184 is pressed; wireless control 32 transmits a signal to motorized shades 10 to move down an incremental or small amount. This incremental or small amount may be in the form of moving a predetermined distance, such as one inch, two inches, three inches or the like; or moving a predetermined percentage of the travel distance between fully open and fully closed, such as one percent, two percent, three percent or the like; or moving a predetermined number of revolutions or counts or ticks sensed by sensors 138, such as one hundred counts, two hundred counts, three hundred counts or the like; or moving a predetermined percentage of revolutions or counts or ticks sensed by sensors 138, such as one percent, two percent, three percent or the like. This functionality allows a user to control the shades with finer movements than provided by merely using preset position buttons 182 and allows a user to choose positions between preset positions. These signals, that cause an incremental movement, are also known as jog signals.

In one arrangement, toggle button 184 provides dual functionality in that when pressed and released in less than a predetermined amount of time, wireless control 32 transmits a jog signal, or an incremental movement signal; whereas when pressed and held for more than a predetermined amount (which is known as a “dwell”) a second signal, or dwell signal is transmitted. A dwell signal may be in the form of move all the way up or all the way down, or move up or move down a predetermined amount which greater than the incremental amount of a jog signal, or move continuously until the toggle button 184 is released. In this way, the dual functionality of toggle button 184 with the dwell functionality provides a user with a greater level of control.

Wireless control 32 also includes a channel button 186. When pressed, channel button 186 toggles between a plurality of channels as are indicated by indicators 188. In the arrangement shown, five channels are presented and represented by an indicator 188. In one arrangement, each channel provides the ability to control a unique bank or group of shades 10. In one arrangement, one of the channels, such as the first or last channel, is an all channel and controls all motorized shades 10 associated with wireless control 32. As an example, in a room where motorized window shades 10 are placed on each of the North, East, South and West walls, when channel one is selected all of the motorized window shades 10 on the North wall are simultaneously and identically controlled, when channel two is selected all of the motorized window shades 10 on the East wall are simultaneously and identically controlled, when channel three is selected all of the motorized window shades 10 on the South wall are simultaneously and identically controlled, when channel four is selected all of the motorized window shades 10 on the West wall are simultaneously and identically controlled, and when channel five is selected all of the motorized window shades 10 on all walls are simultaneously and identically controlled. This arrangement provides a user with greater flexibility of control of a plurality motorized window shades 10.

In an alternative arrangement, when wireless control 32 includes a toggle button 184 and four buttons 182, pressing the upper portion of the toggle button 184 sends the motorized window shades 10 to the open position, pressing the lower portion of the toggle button 184 sends the motorized window shades 10 to the closed position, and the four buttons 182 are programmed for intermediary positions, which can be custom set but from the factory are set at 20% closed, 40% closed, 60% closed and 80% closed respectively.

Gateway:

In one arrangement, wireless control 32 communicates directly with motorized roller shades 10. That is, when a button is pressed on wireless control 32 a wireless signal is transmitted that is directly received by the antenna 124 of each motorized window roller shade 10. Once received, antenna 124 transmits the signal to the radio 126 which transmits the signal to the microprocessor 120 which controls the motorized roller shade 10 according to instructions stored in memory 122.

This direct control path provides some advantages. That is, the wireless control 32 communicates directly with the motorized window shade 10 and therefore no additional electronic components are necessary (such as a gateway 190 or other middle-man device) which can increase cost and complexity of a system. However, direct control also has some disadvantages. Namely, because wireless control 32 is inherently limited in power (due to being battery powered which enables it to be wireless) this essentially eliminates the ability for two-way communication between wireless control 32 and motorized roller shade 10. That is, wireless control 32 is limited in functionality to merely blasting out a control signal without the ability to confirm whether the motorized window shade 10 received and properly responded to the control signal. This can cause missed control signals and inconsistency in response to wireless control 32.

One way to resolve the disadvantages of one-way communication is to employ the use of a gateway 190 such as through the use of a ZigBee-like network or protocol or other mesh network or similar protocol also commonly referred to as the internet of things.

In the arrangement shown, utilizing a two-way communication protocol, such as ZigBee, gateway 190 serves as a middle man between wireless control 32 and motorized window shades 10. In this arrangement, gateway 190 includes an antenna 192, a radio 194, a microprocessor 196 and memory 198 (which are not shown in detail, but are housed within the body of gateway 190). These components are similar to if not identical to and cooperate and operate in a similar, if not identical, manner to the same components described with respect to motor control assembly 18, and those portions of the specification can be deemed repeated for gateway 190. Gateway 190 has the advantage of being connected to an unlimited source of power as gateway 190 is configured to plug into the building or home power source. As such, gateway 190 can have unlimited signal strength and gateway 190 can continuously listens for wireless control signals. In contrast, when motorized roller shades 10 are powered by a limited power source 26 such as a plurality of batteries 28, the motorized roller shade 10 is required to conserve power as possible. One way this is accomplished is by the battery powered motorized roller shade 10 going into an asleep state for a predetermined time and then periodically checking in with the continuously powered gateway 190 to determine if gateway 190 has received a control signal from a hardwired control 34 or wireless control 32.

Power Panel:

In one arrangement, motorized roller shade system 10 includes the use of a power panel 200. Power panel 200 is formed of any suitable size, shape and design and serves to distribute power as well as connect hardwired control(s) 32 to motorized roller shade(s) 110 through lead(s) 30. In the arrangement shown, power panel 200 is formed of a housing 202 and includes a plurality of sockets 204 that are connected to a power and signal distribution board 206. In one arrangement, sockets 204 are like sockets 116 and are sized and shaped to receive a conventional Ethernet plug or RJ45 connector. However, any other form of socket/plug design is hereby contemplated for use.

Power panel 200 allows for a plurality of motorized roller shades 10, or other components (such as other forms of shades or other electronic components) to be connected to power panel 200 through sockets 204. Power panel 200 also allows for one or more hardwired controls 34 to be connected to power panel 200.

In the event where the system 10 includes a greater number of hardwired controls 34 and/or motorized window shades 10 than a single power panel 200 has sockets, two or more power panels 200 can be connected together (in what is sometimes described as a “daisy chain”) by connecting a lead 30 between two power panels 200. In this way, an unlimited number of motorized window shades 10 and hardwired controls 34 and other components can be connected to one another and controlled as part of a single system 10.

Power panel 200 can also be connected, either wirelessly or through wired connection to the internet which facilitates control over the internet. This connection enables control of system 10 through the internet through other devices such as an internet enabled computer, tablet, phone or other device.

In one arrangement, power panel 200 is connected to a conventional power source, such as 120 volt AC power source and through a power converter that converts this power to 24 volt DC power.

Window Frame Clamps:

Many commercial buildings have various restrictions that do not allow screws, bolts or any other device to penetrate or damage the window frame 64 or window frame members 66. These restrictions pose substantial problems especially when installing motorized roller shades 10. To alleviate this problem while facilitating easy installation of motorized roller shades 10 in commercial applications, window frame clamps 42 are used which grip on to the exterior of the window frame members 66 of window frames 64.

Window frame clamps 42 are formed of any suitable size, shape and design and are configured to clamp to a window frame member 66 of window frame 64 or any other structural component of building 52. In the arrangement shown, as one example, window frame clamps 42 include a clamping member 208 that includes a center wall 210 and a pair of opposing end walls 212 that form a generally C-shaped member or U-shaped member. End walls 212 connect to the outward end of center wall 210. End walls 212 extend in approximate parallel spaced relation to one another. In one arrangement, end walls 212 extend in approximate perpendicular relation to center wall 210. In one arrangement, end walls 212 angle slightly inward toward one another as they extend away from center wall 210 which provides increased strength to the system as it essentially pre-stresses the clamping member 208 for tightening on window frame member 66. Clamping member 208 forms a window frame member receiving space 214 within the space defined between the center wall 210 and end walls 212. However any other shaped member is hereby contemplated for use as clamping member 208.

In the arrangement shown, end walls 212 include one or more fastening members 216. Fastening members 216 are formed of any suitable size, shape and design and is configured to tighten against window frame member 66 when positioned within the receiving space 214 of clamping member 208. In the arrangement shown, as one example, a pair of fastening members 216 are positioned in each end wall 212, one towards the upper end of end wall 212 and one toward the lower end of end wall 212. In the arrangement shown, as one example, fastening members 216 are formed of a fastener 218 that extends through an opening 220 in end wall 212 and threadably engages end wall 212 so as to facilitate tightening against window frame member 66. Also, in the arrangement shown, fastening member 216 includes a tightening member 224 that facilitates tightening of the fastener 218 once tightened in place. In the arrangement shown, as one example, tightening member 224 is a nut placed around the fastener 218 that threadably engages and meshes with fastener 218.

In use, fasteners 218 are extended through openings 220 and tightened in place against window frame member 66 by threaded engagement. Once the desired pressure is achieved against window frame member 66, tightening member 224 is tightened against the exterior surface of end wall 212. By doing so, tightening member 224 locks the position of fastener 218 relative to the position of end wall 212 and thereby prevents fastener 218 from coming loose over time.

In the arrangement shown, pads 226 are placed along the inward surfaces of end walls 212 and/or in engagement with the inward end of fasteners 218. Pads 226 are configured to engage the exterior surface of the window frame members 66 when fasteners 218 are tightened against the window frame members 66 thereby preventing the inward ends of fasteners 218 from directly engaging the window frame members 66 and damaging the window frame members 66.

In the arrangement shown, a mounting plate 228 is connected to clamping member 208. Mounting plate 228 is formed of any suitable size, shape and design and is configured to facilitate connection of window frame clamp 42 to other components of the system 10. In the arrangement shown, as one example, mounting plate 228 is a generally flat and planar member that connects to an end of center wall 210 and extends outward therefrom in an approximately perpendicular manner to center wall 210. In the arrangement shown, mounting plate 228 is positioned between end walls 212 and includes a pair of slots 230 that receive fasteners 232 that facilitate connection to other components of the system 10, such as pushup hood 48. Window frame clamps 42 can connect to motorized roller shade system 10 by any other manner, method, or means.

In many arrangements, a window frame clamp 42 is positioned adjacent each end 68 of the motorized roller shade 10 such that support is provided to both ends 68 of the motorized roller shade. Using a single window frame clamp 42 connected to each end 68 of motorized roller shade system 10 provides a strong and durable installation. However, any number of window shade clamps 42 are hereby contemplated for use during installation including one, three, four, five, six or more for each motorized roller shade 10, or alternatively, when two or more motorized roller shades 10 are installed together, it is contemplated that less than one window frame clamp 42 may be used per motorized roller shade 10 if the motorized roller shades 10 are connected together.

The use of window frame clamps 42 facilitates installation of motorized roller shade system 10 in a quick, rugged, simple and safe manner in a building where the window frame 64 or other structural members cannot be damaged.

Mounting Bracket and Mounting Clips:

Installation of motorized roller shades 10 can cause substantial problems during the construction phase of a building or space as it tends to be extremely time consuming, complex and difficult. In addition, timing of the installation is often an issue as well. This is partly due to how precisely motorized roller shades 10 must be installed. In addition, due to the bracketing used for motorized roller shade 10 installations, and that the motorized roller shades 10 include shade material 14 that must be kept extremely clean, motorized roller shades 10 are often required to be the last thing to be installed in a building or space. As such, if any issues occur with the installation of motorized roller shades 10 this can delay completion of a project.

To resolve these problems, and to allow for partial installation of the motorized roller shade system 10 prior to the completion of construction of the building 52, structural member 54, interior wall 56 and/or ceiling 58 that the motorized roller shade 10 is connected to or adjacent.

Mounting brackets 44 and mounting clips 46 are formed of any suitable size, shape and design and are configured to facilitate the installation of the mounting brackets 44 during construction or before completion of construction, and certainly before painting, of the building 52, structural member 54, interior wall 56 and/or ceiling 58 that the motorized roller shade 10 is connected to or adjacent. After construction is completed and the area where the motorized roller shade 10 is painted and finished the motorized roller shade 10 is installed by engaging the mounting clips 46 with the previously installed mounting brackets 44. This saves time as well as provides the ability to identify whether issues exist with the installation while having additional lead time to take corrective action. Said another way, mounting brackets 44 are configured to be installed prior to completion of the structural member 54 and the motorized roller shade system is configured to be installed onto the mounting brackets 44 after the structural member 54 is finished, whereas finishing may include painting, texturing, staining, sanding, taping, clear-coating, shellac, or the like processes.

In the arrangement shown, as one example, mounting brackets 44 include an upper wall 234 that connects to a back wall 236 at a corner section 238. Upper wall 234 and back wall 236 are generally flat and planar in shape and extend in approximate perpendicular alignment to one another. Corner section 238 extends between upper wall 234 and back wall 236 at an angle so as to provide relief in the corner of the building 52, structural member 54, interior wall 56, ceiling 58 window frame 64 and/or window frame member 66 that the mounting bracket 44 is connected to and allows for a less sensitive installation. Upper wall 234 and back wall 236 include slots 240 therein that are configured to receive fasteners therein that facilitate connection of the mounting bracket 44 to the building 52, structural member 54, interior wall 56, ceiling 58 window frame 64 and/or window frame member 66 that the mounting bracket 44 is mounted to. In the arrangement shown, single slot 240 is positioned along each side of the upper wall 234 and back wall 236, however any number of slots 240 is hereby contemplated for use such as one, three, four, five, or more. By having elongated slots 240 this allows for adjustment of the mounting bracket 44 after the fastener has been inserted through the slot 24. A forward wall 242 is connected to the forward end of upper wall 234. Forward wall 242 extends downward from upper wall 234 in approximate perpendicular alignment to the upper wall 234 and in approximate parallel spaced alignment to back wall 236.

Mounting brackets 44 include mounting features 244 therein that are configured to receive mounting features 246 of mounting clip 46. As one example, as shown, the mounting features 244 of mounting bracket 44 include a recess 244A positioned in the rearward side of forward wall 242 which is adjacent a stop surface 244B positioned in the lower surface of upper wall 234; the mounting features 244 of mounting bracket 44 also include a recess 244C in the forward side of back wall 236 that includes a stop surface 244D. In the arrangement shown, as one example, recess 244A is a generally rounded recess that facilitates the rotation of mounting clip 46 when positioned therein, and stop surface 244B is a generally flat plane that extends in approximate parallel spaced relation with the upper wall 234 and is intended to be positioned in horizontal alignment. In the arrangement shown, as one example, recess 244C has an angled upper wall, a generally vertical center wall and terminates in its lower end in stop surface 244D that is a generally flat plane that extends in approximate parallel spaced relation with the upper wall 234. Inside surface of the lower end of back wall 236 includes an angled surface 248 that causes the lower end of back wall 236 to get narrower as it extends away from recess 244C. This angled surface 248 helps to facilitate the insertion of the lower end of mounting clip 46 into the mounting bracket 44.

In the arrangement shown, as one example, mounting clips 46 include an upper wall 250 that is formed of three sections 250A, 250B, 250C, that connects to a back wall 252, that is formed of three section, 252A, 252B, 252C, that connect at a corner section 2254. Upper wall 234 and back wall 236, while formed of a plurality of sections, extend in approximate perpendicular alignment to one another.

A forward wall 256 is connected to the forward end of upper wall 250. Forward wall 256 extends upward from upper wall 250 in approximate perpendicular alignment to the upper wall 250 and in approximate parallel spaced alignment to back wall 252. The upper end of forward wall 256 includes a fascia mounting feature 258 that is configured to engage and receive and hold fascia 40 thereto. In the arrangement shown, as one example, fascia mounting feature 258 is a generally semi-circular shaped feature that includes an opening or slot in the forward side of the fascia mounting feature 258 and a generally circular opening through its middle.

A pair of screw bosses 260 is positioned in the upper wall 250. A first screw boss 260 is positioned between the first section 250A and the second section of 250B of the upper wall 250 and a second screw boss 260 is positioned between the second section 250B and the third section 250C of upper wall 250. These screw bosses 260 are configured to receive fasteners 92 that extend through end plates 36 and end caps 38 thereby tightening these components together. Like fascia mounting feature 258, screw bosses 260 are semi-circular shaped features that include an opening or slot in their forward side and a generally circular opening through their middle.

Mounting clips 46 include mounting features 246 therein that are configured to engage the mounting features 244 of mounting bracket 44. As one example, as is shown, the mounting features 246 of mounting clip 46 include a mounting arm 2464A that extends upward from and forward from the screw boss 260 positioned between the first section 250A and second section 250B of upper wall 250. Mounting arm 246A includes a rounded nose at its forward end that is configured to engage the recess 244A of mounting bracket 44. Mounting arm 246A also includes a stop surface 246B positioned in the upper surface of mounting arm 246A that is configured to engage the stop surface 244B in the lower surface of upper wall 234 of mounting bracket 44 when fully inserted therein. The mounting features 246 of mounting clip 46 also include a protrusion 244C in the rearward side of back wall 252 that includes a stop surface 246D that is configured to engage the stop surface 244d in the back wall 236 of mounting bracket 44 when fully inserted therein. In the arrangement shown, protrusion 246C includes a rounded upper surface that helps to facilitate entry into the recess 244C. Once inserted the generally flat and planar stop surface 246D of mounting clip 46 engages the generally flat and planar stop surface 244D of mounting bracket 44 in a locking arrangement that prevents unintentional removal of the mounting clip from the mounting bracket.

To remove the mounting clip 46 from the mounting bracket 44 once inserted therein, the lower end of the back wall 252 of mounting clip 46 is forced inward and away from the back wall 236 of mounting bracket 44 until the stop surface 246D of mounting clip 46 is free from the stop surface 244D of mounting bracket 44 at which point the mounting clip 46 is allowed to rotate downward upon the engagement between the forward end of mounting arm 246A with recess 244A allowing the motorized roller shade system 10 to be fully removed from the mounting bracket 33.

When mounting brackets 44 and mounting clips 46 are used fascia 40 includes a forward wall 246 and a bottom wall 248 that extend in approximate perpendicular alignment to one another. In the arrangement shown, a first mounting feature 268 is positioned in the upper rearward surface of the forward wall 246 and is configured to engage the fascia mounting feature 258 of mounting clip 46. In the arrangement shown, a pair of screw bosses 270 extends upward from the upper surface of bottom wall 248 and are configured to receive fasteners 92 that extend through end plates 36 and end caps 38 to facilitate assembly of the motorized roller shade 10.

Assembly & Installation—Using Mounting Brackets and Mounting Clips:

Motorized roller shade system 10 is assembled by installing an end plate 36 on each end 68 of the roller tube 12 by installing the axle 102 extending outward from the roller tube 12 in the key slot 106.

Mounting clips 46 and fascia 40 are joined together by installing the first mounting feature 268 of fascia 40 with the fascia mounting feature 258 of the mounting clip 46.

Next an end cap 38 is placed over the end plate 36 and fasteners 92 are passed through the end plate 36 and end cap 38. The screw bosses 260 of mounting clip 46 are aligned with the fasteners 92 that extend through the upper end of end plate 36 and end cap 38 and the fasteners 92 that extend the lower end of end plate 36 and end cap 38 are aligned with the screw bosses 170 of the bottom wall 266 of fascia 40. Once aligned in this manner, the fasteners 92 are tightened thereby tightly affixing these components together. This process essentially forms a self-contained and fully assembled cassette-type motorized roller shade 10 that only needs to be clipped into mounting brackets 44 to complete installation.

At any time during the construction process, mounting brackets 44 are installed in the building 52, structural member 54, interior wall 56, ceiling 58, window frame 64 or window frame member 66 by aligning the mounting bracket 44 in the proper position and inserting one or more fasteners through the slots 240 of mounting bracket 44 thereby tightening the mounting bracket 44 in place. This portion of the installation can be performed at any time during the construction process. This can certainly be performed before the surface to which the mounting bracket 44 is attached is painted, stained or even textured. Once the construction process is complete, meaning that the area where the motorized roller shade 10 is to be installed has been completed, including the walls or window frame being painted or stained, the installation of the motorized roller shade 10 is completed by simply aligning the mounting features 246 of the mounting clips 46 with the mounting features 244 of the mounting brackets 44 and then snapping the motorized roller shade 10 in place.

This process saves time and money and streamlines the installation process. In addition, by allowing partial installation earlier in the construction process this allows the installer to determine whether any issues are present and if there are the installer has additional time to rectify the problems earlier in the process which will hopefully allow correction without delaying the completion date.

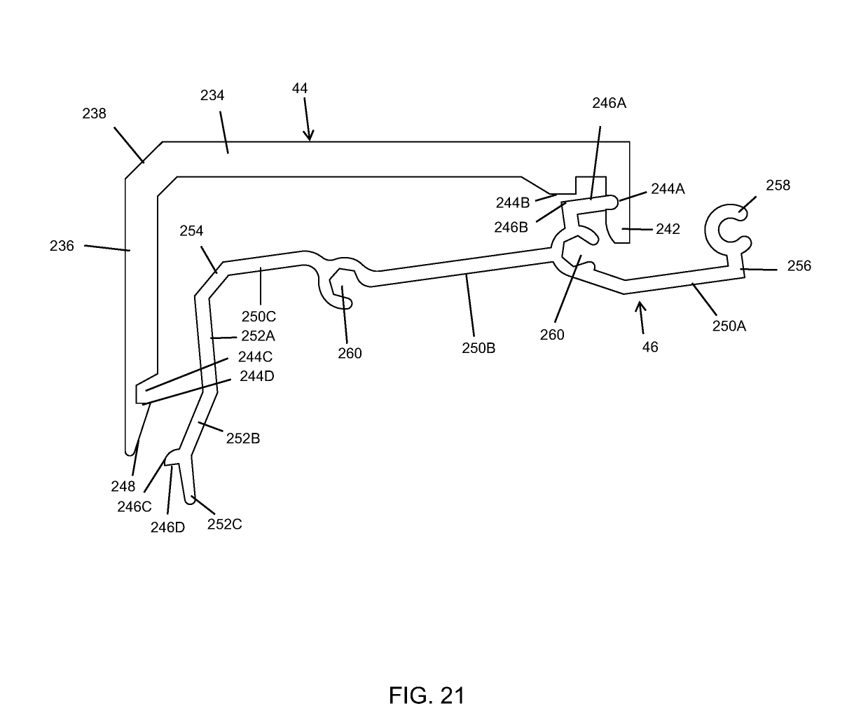

More specifically, to install the assembled motorized roller shade 10 having mounting clips 46 onto previously mounted mounting bracket 44, the forward end of mounting arm 246A of mounting clip 46 is placed in the recess 244A in the back surface of forward wall 242 of mounting bracket 44. This arrangement is shown in FIG. 21.

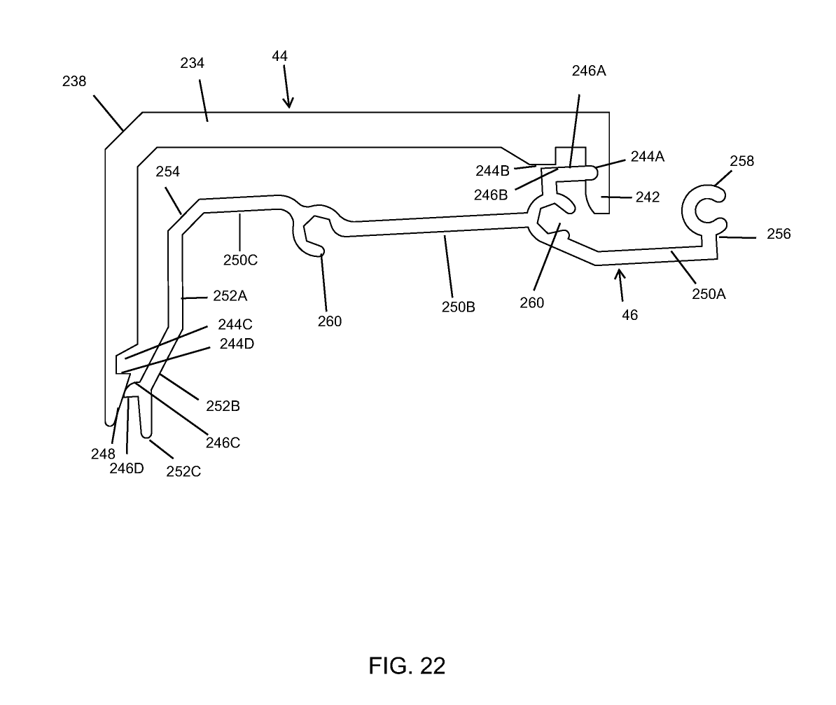

Next, the rearward end of the motorized roller shade 10 is rotated upward. This causes the upper surface of protrusion 246C of mounting clip 46 to engage the angled surface 248 of the back wall 236 of mounting bracket 44. This arrangement is shown in FIG. 22.

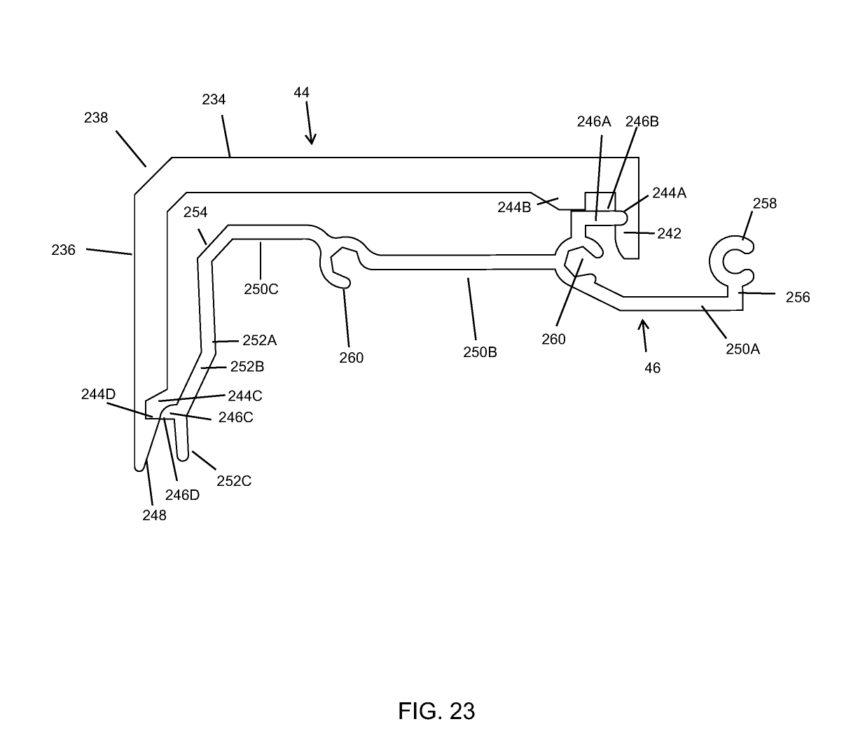

Next, the rearward end of the motorized roller shade 10 is further rotated upward. This causes the upper surface of protrusion 246C of mounting clip 46 to slide upward guided by the angle of angled surface 248 of the back wall 236 of mounting bracket 44. As the motorized roller shade 10 is further rotated upward this causes the back wall 252 of mounting clip 46 to bend or flex toward the upper wall 250 of mounting clip 46. This bending or flexing continues until the stop surface 246D in the lower surface of protrusion 246C meets or passes the stop surface 244D in recess 244C in the back wall 236 of mounting bracket 44. This arrangement is shown in FIG. 23.

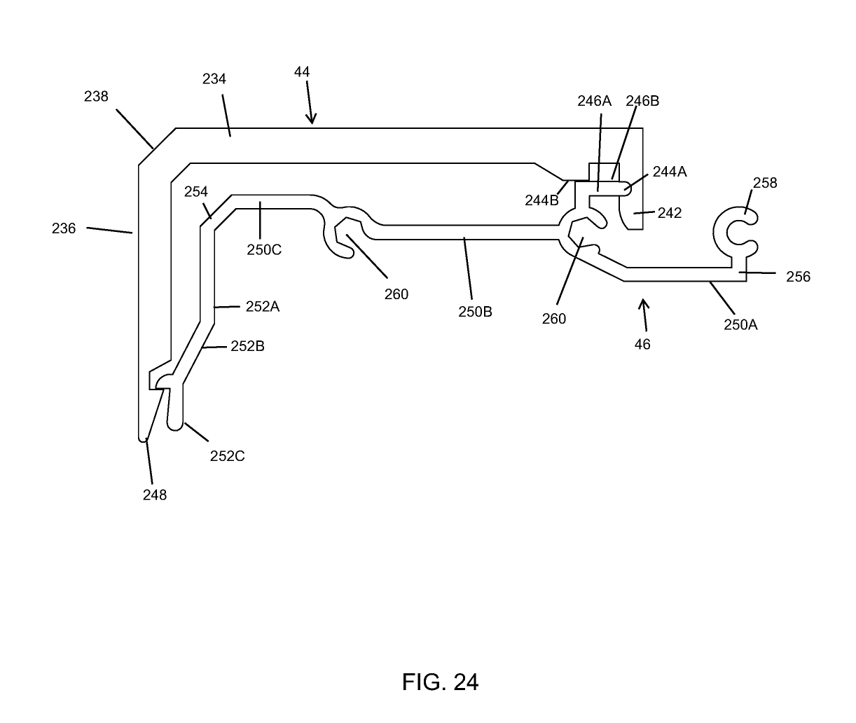

Next, once the stop surface 246D in the lower surface of protrusion 246C of mounting clip 46 passes the stop surface 244D in recess 244C in the back wall 236 of mounting bracket 44 the built up tension due to the bending or flexion of the mounting clip 46 as it is forced upward releases and the protrusion 246C of mounting clip 46 snaps into the recess 244C in the back wall 236 of mounting bracket 44. Once in this position, the stop surface 246D of mounting clip 46 is in generally flat and flush engagement with the stop surface 244D of the recess 244C of mounting bracket 44. Due to the flat and flush engagement between stop surfaces 244D and 246D the mounting clip 46 is locked into place and is prevented from rotating out of engagement with mounting bracket 244. Also in this position, the stop surface 246B in the upper surface of mounting arm 246A is in flat and flush engagement with the stop surface 244B in the lower surface of upper wall 234 of mounting bracket 44. This fully installed arrangement is shown in FIG. 24.

To remove the motorized roller shade 10 with mounting clips 46 from mounting brackets 44, the lower end of back wall 252 of mounting clip 46 is forced inward until thereby causing the mounting clip 46 to flex. Once the stop surface 246D clears and no longer engages the stop surface 244D the mounting clip 46, and the whole motorized roller shade 10 is allowed to rotate upon the engagement between the forward end of mounting arm 246A of mounting clip 46 with the recess 244A in the back surface of forward wall 242 of mounting bracket 44 until the motorized roller shade 10 can be lowered and removed.

As such, this arrangement allows for the quick and easy prior installation of the mounting brackets 44 during the construction process (before painting, staining, texturing and other finishing touches to the structural member 54 that the motorized roller shade 10 is installed to). Then, once construction is complete, including painting, staining, texturing and other finishing touches to the structural member 54 that the motorized roller shade 10 is installed to, the motorized roller shade 10 can be quickly and easily inserted in the mounting brackets 44 by aligning the mounting clips 46 with the previously installed mounting brackets 44 and forcing the rearward end of the motorized roller shade 10 upward until it snaps into place. This allows a single installer to quickly and easily install a great number of shades in a very short period of time without the use of any tools.

Pushup Hood and Pushup Clips:

In many applications, and in particular in many commercial applications, motorized roller shades 10 are installed in a ceiling 58 or a pocket places in or above a ceiling 58. Installing motorized roller shades 10 in this manner causes substantial difficulty due to the inaccessibility of the area of installation.

To resolve these problems, and to allow for easy installation of the motorized roller shade system 10 in or above a ceiling 58, pushup hoods 48 and pushup clips 50 are used.

Pushup hoods 48 and pushup clips 50 are formed of any suitable size, shape and design and are configured to facilitate the installation of motorized roller shade 10 simply pushing the motorized roller shade 10 having pushup clips 50 upward into pushup hoods 48 thereby easing and speeding the installation of motorized roller shades 10 in a ceiling, pocket or other area.

Pushup Hood:

In the arrangement shown, as one example, pushup hood 48, when viewed from the side, forms a generally square or rectangular member having an upper wall 272, a forward wall 274 and a rear wall 276 that define a hollow interior 278 therein that is configured to receive motorized roller shade 10, therein. Upper wall 272 is generally flat, straight and planar and connects to forward wall 274 at its forward end and connects to rear wall 276 at its rearward end. Forward wall 247 and rear wall 276 extend downward from upper wall 272 in approximate parallel spaced relation to one another and in approximate perpendicular alignment to upper wall 272 thereby forming a generally square or rectangular member. Rear wall 276 also extends upward above upper wall 272 a distance in a flange section 280 that includes a plurality of openings 282 that, in some applications, is used for installation purposes. Flange section 280 may be used to attach directly to structural member 54 by passing fasteners through openings 282 thereby screwing or bolting pushup hood 48 to the structural member 54. Alternatively, flange section 280 may be used to attach pushup hood 48 to another component that facilitates attachment of the pushup hood 48 to structural member 54, such as window frame clamps 42.

The inner surfaces of pushup hood 48 include a plurality of alignment members 284 that extend inward a distance into hollow interior 278. These alignment members 284 help ensure that the motorized roller shade 10 is properly aligned once positioned within the hollow interior 278. In one arrangement, alignment members 284 are a plurality of protrusions that create stop features within hollow interior 278. In another arrangement, alignment members 284 are formed of a slot 286 that receive an alignment feature 288 of pushup clip 50 therein that helps ensure proper installation.

The lower end of the forward wall 274 and rear wall 276 include a guide member 290. Guide members 290 help to guide the motorized roller shade 10 as it is inserted into the hollow interior 278 of the pushup hood 48. Guide members 290 extend inward a distance from the forward wall 274 and rear wall 276 and include a lower surface that angles inward toward hollow interior 278. This angled surface helps to guide the motorized roller shade 10 as it is inserted within the hollow interior 278.

The upper surface of guide members 290 establish a generally flat or planar surface that extends in approximate parallel spaced alignment with the plan of upper wall 272 and include one or more lock features 292 therein. Lock features 292 are any feature that engages and/or grips a lock feature 294 of pushup clips 50 once pushup clips 50 are inserted within pushup hood 48. In the arrangement shown, the lock features 292 of pushup hood 48 are one or more grooves or recesses in the generally planar upper surface of guide members 290 which is configured to receive a downward extending tongue of pushup clip 50 that serves as the lock feature 294 of pushup clip 50.

Pushup Clip:

In the arrangement shown, as one example, pushup clip 50, when viewed from the side, forms a generally square or rectangular member having an upper wall 296, a forward wall 298 and a rear wall 300 that define a hollow interior 302 therein that is configured to receive motorized roller shade 10, therein. Upper wall 296 is generally flat, straight and planar and connects to forward wall 298 at its forward end and connects to rear wall 300 at its rearward end. Forward wall 298 and rear wall 300 extend downward from upper wall 296 in approximate parallel spaced relation to one another and in approximate perpendicular alignment to upper wall 296 thereby forming a generally square or rectangular member.

The exterior surface of pushup clip 50 is generally flat, flush and smooth so as to facilitate smooth insertion within the hollow interior 278 of pushup clip 48. Once installed, the exterior surface of pushup clip 50 is engages the alignment members 284 in the interior surface of pushup hood 48. In the arrangement shown, an alignment feature 288 extends upward from upper wall 296 of pushup clip that is configured to be received within a slot 286 of pushup hood 48 once fully installed thereby providing alignment to motorized roller shade 10.

The inner surfaces of pushup hood 48 include a plurality of alignment members 284 that extend inward a distance into hollow interior 278. These alignment members 284 help ensure that the motorized roller shade 10 is properly aligned once positioned within the hollow interior 278. In one arrangement, alignment members 284 are a plurality of protrusions that create stop features within hollow interior 278. In another arrangement, alignment members 284 are formed of a slot 286 that receive an alignment feature 288 of pushup clip 50 therein that helps ensure proper installation.

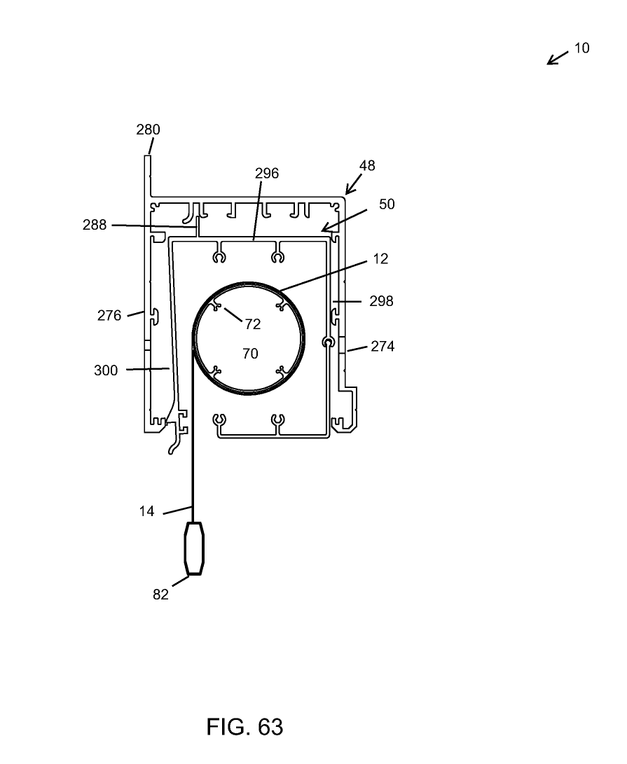

The lower end of the rear wall 300 includes a lock feature 294 that is configured to engage a lock feature 292 of pushup hood 48. In the arrangement shown, lock feature 294 of pushup clip 50 is a downward extending tongue that is configured to engage a lock features 292 of pushup hood 48 that is formed of one or more grooves or recesses in the generally planar upper surface of guide members 290. An angled surface 304 is positioned just above and leads to the lock feature 294 of pushup clip 50. As the pushup clip 50 is inserted into the pushup hood 48 the angled surface 304 of pushup clip 30 engages the angled surface of guide member 290 of pushup hood 48. As the pushup clip 50 is forced upward into the pushup hood 48, this engagement causes the lower end of rear wall 300 of pushup clip 50 to flex or bend inward. This arrangement is shown in FIG. 63. This flexion continues until the lower end of lock feature 294 of pushup clip 50 passes the upper surface of guide member 290 of pushup hood 48.

Once the lock feature 294 of pushup clip 50 passes the upper surface of guide member 290 of pushup hood 48, the pressure built up within the pushup clip 50 due to the bending or flexing of the pushup clip 50 releases and the lower end of rear wall 300 expands outward, or snaps back into place. In this position, the lock feature 294 of pushup clip 50 engages the lock feature 292 of pushup hood 48 thereby locking the two components together and preventing the motorized roller shade 10 from coming out of the hollow interior 278 of pushup hood 48.

To remove the motorized roller shade 10 from the pushup hood 48, once in place, the motorized roller shade 10 is lifted slightly, and tongue 306, positioned at the lower end of rear wall 300 is forced inward. This causes the rear wall 300 to flex slightly and provides clearance for the lock feature 294 of pushup clip 50 to clear the lock feature 292 of pushup hood 48 at which point the pushup clip 50 can be lowered out of the pushup hood 48.

A pair of screw bosses 308 is positioned in the upper wall 296 of pushup clip 50. Screw bosses 308 extend downward from the upper wall 296 a distance. These screw bosses 308 are configured to receive fasteners 92 that extend through end plates 36 and end caps 38 thereby tightening these components together. Screw bosses 308 are semi-circular shaped features that include an opening or slot in their forward side and a generally circular opening through their middle.

The lower end of forward wall 298 of pushup clip 48 includes a fascia mounting feature 310 that is configured to engage and receive and hold fascia 40 thereto. In the arrangement shown, as one example, fascia mounting feature 310 is a generally semi-circular shaped feature that includes an opening or slot in the lower side of the fascia mounting feature 310 and a generally circular opening through its middle.

When pushup hood 48 and pushup clips 50 are used, fascia 40 includes a forward wall 246 and a bottom wall 248 that extend in approximate perpendicular alignment to one another. In the arrangement shown, a first mounting feature 268 is positioned in the upper surface of the forward wall 246 and is configured to engage the fascia mounting feature 310 of pushup clip 50. In the arrangement shown, a pair of screw bosses 270 extends upward from the upper surface of bottom wall 248 and is configured to receive fasteners 92 that extend through end plates 36 and end caps 38 to facilitate assembly of the motorized roller shade 10.

Assembly & Installation—Using Pushup Hoods and Pushup Clips:

Motorized roller shade system 10 using pushup hoods 48 and pushup clips 50 is assembled by installing an end plate 36 on each end 68 of the roller tube 12 by installing the axle 102 extending outward from the roller tube 12 in the key slot 106.

Pushup clips 50 and fascia 40 are joined together by installing the first mounting feature 268 connected to the upper end of the front wall 264 of fascia 40 with the fascia mounting feature 310 of the pushup clip 50.

Next an end cap 38 is placed over the end plate 36 and fasteners 92 are passed through the end plate 36 and end cap 38. The screw bosses 308 of pushup clip 50 are aligned with the fasteners 92 that extend through the upper end of end plate 36 and end cap 38 and the fasteners 92 that extend the lower end of end plate 36 and end cap 38 are aligned with the screw bosses 270 of the bottom wall 266 of fascia 40. Once aligned in this manner, the fasteners 92 are tightened thereby tightly affixing these components together. This process essentially forms a self-contained and fully assembled cassette-type motorized roller shade 10 that only needs to be clipped into pushup hood 48 to complete installation.

At any time during the construction process, pushup hoods 48 are installed in the building 52, structural member 54, interior wall 56, ceiling 58, window frame 64 or window frame member 66 by any one of a number of installation manners or methods. In one arrangement, the pushup hoods 48 are placed in the proper position and fasteners are passed through the openings 282 in the flange section 280 of the pushup hood 48 and into a structural member 54 of building 52 thereby tightening the pushup hood 48 in place. In another arrangement, fasteners are passed through slots 312 in the forward wall 274 or rear wall 276 of pushup hood 48 and into a structural member 54 of building 52 thereby tightening the pushup hood 48 in place. In another arrangement, fasteners are passed through the upper wall 272 of pushup hood 48 and into a structural member 54 of building 52 thereby tightening the pushup hood 48 in place. In yet another arrangement, a window frame clamp 42 may be connected to pushup hood 48 by connection to upper wall 296 and/or flange section 280, or by connection in any other manner or method. Once assembled, pushup hood 48 is connected to a structural member 54 of building 52 in the manner described herein using window frame clamp 42. Any other manner, method or means is hereby contemplated for use to install pushup hoods 48 in building 52.

This arrangement allows the installation of pushup hoods 48 at an earlier time than the installation of the motorized roller shade 10 itself. This process saves time and money and streamlines the installation process. In addition, by allowing partial installation earlier in the construction process this allows the installer to determine whether any issues are present and if issues are present then the installer has additional time to rectify the problems earlier in the process. This will hopefully allow correction without delaying the completion date.

To install the assembled motorized roller shade 10 having pushup clips 50 into previously mounted pushup hoods 48, the assembled motorized roller shade 10 is aligned with the hollow interior 278 in the lower end of pushup hoods 48. Once aligned in this manner, the motorized roller shade 10 is pushed upward into the hollow interior 278 of the pushup hoods 48.

As the motorized roller shade 10 is pushed upward into the hollow interior 278 of the pushup hoods 48 the angled surfaces in the lower sides of guide members 290 engage the upper surface of pushup clips 50 and guide the motorized roller shade 10 into the hollow interior 278.

As the motorized roller shade 10 continues to be pushed up within the hollow interior 278 of the pushup hoods 48, the alignment members 284 in the interior surface of the pushup hood 48 engage the exterior surface of pushup clips 50 and help to guide the motorized roller shade within the hollow interior 278 of pushup hood 48.

As the motorized roller shade 10 is nearing full inserted within the hollow interior 278 of pushup hood 48, the alignment feature 288 of the pushup clip 50 is guided into the slot 286 in the lower surface of upper wall 272 by a combination of engagement of the pushup clip 50 with the alignment members 284 as well as engagement of the alignment feature 288 with the inwardly angled members the form the slot 286. Once motorized roller shade 10 is fully inserted within pushup hoods 48, the alignment feature 288 in the upper wall 296 of pushup clip 50 is held within the alignment slot 286 in the lower surface of the upper wall 272 of pushup hood 48. Also, in this position, the outward edges of the pushup clip 50 in engagement with or close proximity to the alignment members 284 positioned near the upper end of the hollow interior 278 of pushup hood 48. In this arrangement, the pushup clip 50 is held within pushup hood with close and tight tolerances if not with frictional engagement with these features.

Also, as the motorized roller shade 10 is nearing full inserted within the hollow interior 278 of pushup hood 48 upper angled surface 304 of the rear wall 300 of pushup clip 50 engages the angled lower surface of guide member 290 of pushup hood 48 and the upper angled surface 304 of the rear wall 300 of pushup clip 50 causes the rear wall 300 of the pushup clip 50 to bend or flex inward toward the hollow interior 302 of pushup clip 50 as the angled surface 304 of the rear wall 300 of pushup clip 50 slides upward upon the angled lower surface of guide member 290 of pushup hood 48. This arrangement is shown in FIG. 63. This continues until the lock feature 294 of pushup clip 50 passes the guide member 290 of pushup hood 48.

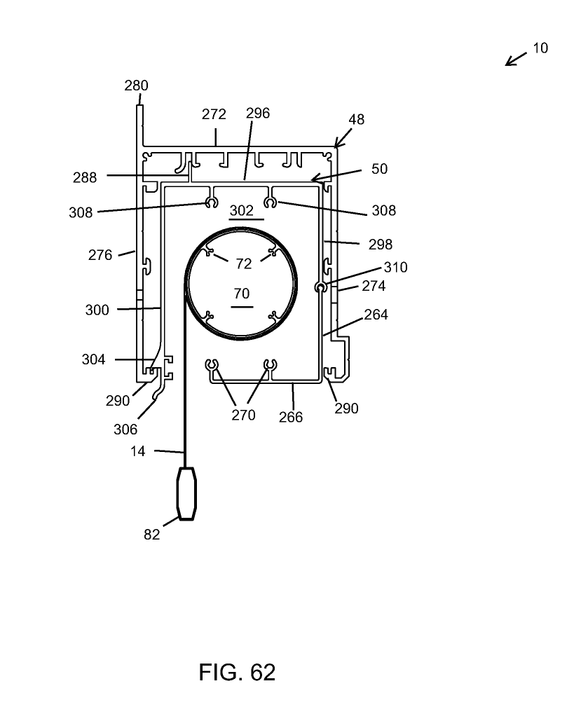

Next, once the lock feature 294 of pushup clip 50 passes guide member 290 of pushup hood 48 the built up tension due to the bending or flexion of the pushup clip 50 as it is forced upward releases and the rear wall 300 of the pushup clip 50 moves back to or closer to its original position. In this position, the lock feature 294 of pushup clip 50 engages the lock feature 292 in the upper surface of the guide member 290 of pushup hood 48 thereby locking the motorized roller shade 10 within the pushup hood 48 and preventing the motorized roller shade 10 from unintentionally coming out of the pushup hood 48. This fully installed arrangement is shown in FIG. 62.

To remove the motorized roller shade 10 with pushup clips 50 from pushup hoods 48, the motorized roller shade 10 is raised slightly within the hollow interior 278 of pushup hoods 48 to provide clearance between the lock feature 292 of the pushup hood 48 and the lock feature 294 of the pushup clip 50. Once the lock feature 294 of the pushup clip 50 is clear of the lock feature 292 of the pushup hood 48, which can be done by pushing upward on the bottom wall 266 of fascia 40, pressure is applied to the lower end of rear wall 300 of pushup clip 50 forcing the lower end of rear wall 400 away from the rear wall 276 of pushup hood 48. This can be accomplished by pressing on tongue 306. Once the lock feature 294 of pushup clip 50 clears the lock feature 292 of pushup hood 48, the pushup clip 50 and motorized roller shade 10 can be lowered out of the pushup hood 48.

As such, this arrangement allows for the quick and easy prior installation of the pushup hoods 48 during the construction process. Then, once construction is complete the motorized roller shade 10 can be quickly and easily inserted in the pushup hoods 48 by aligning the pushup clips 50 with the previously installed pushup hoods 48 and forcing the pushup clips 50 and motorized roller shade 10 upward it snaps into place. This allows a single installer to quickly and easily install a great number of motorized roller shades 10 in a very short period of time without the use of any tools.

Venting:

One substantial benefit to the use of pushup hood 48 and pushup clip 50 is that pushup hood 48 and pushup clip 50 can be used to install motorized roller shade 10 in such a way that heated air trapped between the shade material 14 and the window 62 is be vented into a plenum 60 above the ceiling 58. This provides great energy efficiency benefits by keeping the occupied space of a building 52 cooler while venting heated air into the unoccupied plenum 60 space above the ceiling 58.

Many commercial buildings include plenums 60. A plenum 60 is the space between the ceiling 58, which in many commercial buildings is a drop-ceiling formed of a plurality of ceiling tiles, and the floor of the above story. Plenum 60 provides space for running wires, cables, pipes and heating and air conditioning components among other components of the building 52. Plenums 60 can vary widely in size, shape and volume.

Since the main purpose of a plenum 60 is to house and provide access to mechanical components of a building 52, venting heated air into the plenum 60, and thereby preventing this heated air from entering the occupied space of the building, improves energy efficiency of the building and helps to maintain a more-stable or consistent temperature of the building 52.

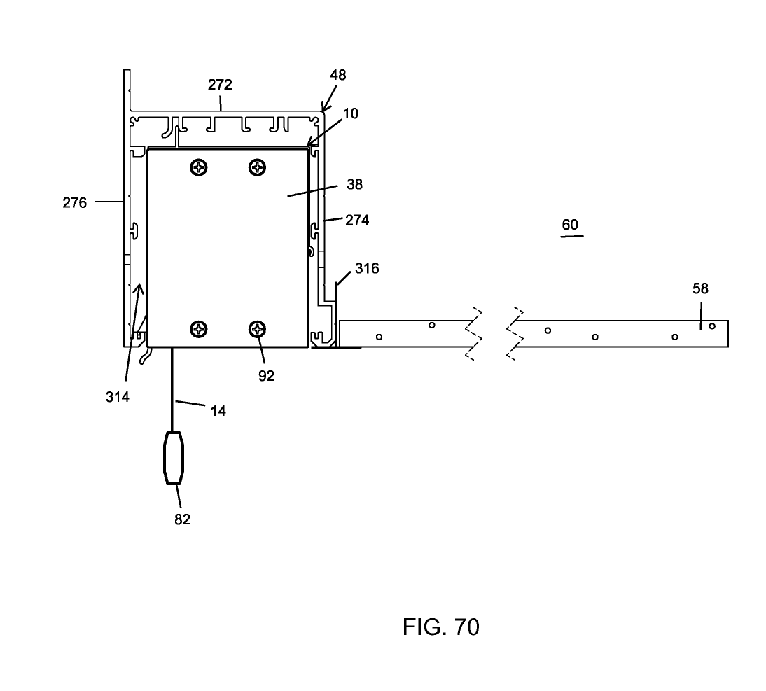

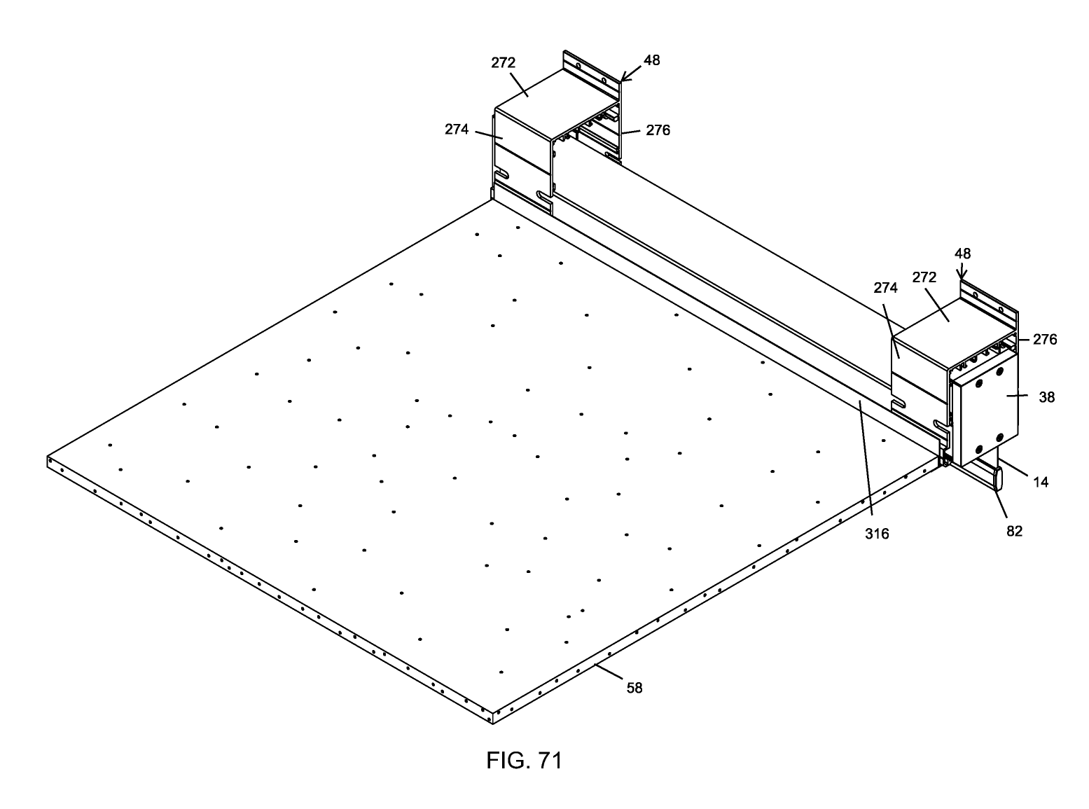

As an example, as is shown in FIGS. 70 and 71, the room side of pushup hood 48 is installed in alignment with or sealed to ceiling 58 while a gap 314 is positioned between the shade material 14 and the window 62 that connects to, and thereby vents to, the plenum 60. In the arrangement shown, when installed, the lower end of forward wall 274 and rear wall 276 are in approximate alignment with the bottom surface of ceiling 60. In this arrangement, when motorized roller shade 10 is installed within the pushup hood 48, the lower surface of bottom wall 266 of fascia 40 is also in flush and flat and sealed alignment with the lower end of forward wall 274 as well as the lower surface of ceiling 60.

In one arrangement, this is accomplished by installing a ceiling bracket 316 that engages the lower end of forward wall 274 of the pushup hood 48 on one side as well as ceiling 58 on the other side. In the arrangement shown, as one example, ceiling bracket 316 is an inverted T-shaped member that includes a center wall that is positioned between the outward surface of the lower end of the forward wall 274 of pushup hood 48 and the edge of ceiling 58. In this arrangement, the inverted T-shaped member seals the ceiling 58 to the pushup hood 48 as well as provides a resting surface that holds the ceiling tile 58 in place.

This arrangement prevents or largely prevents heat transfer and mixing of heated air on the room-side of the shade material 14. This is due to the alignment or seal of the pushup hood 48 and fascia 40 with the ceiling 58.

A gap 314 is positioned between the shade material 14 and the window 62 that connects to plenum 60. As such, heated air trapped between the window 62 and the shade material 14, the natural tendency is for the heated air to rise. As the heated air rises it passes through gap 314 and into plenum 60 where it is held from the occupied space of the room. As the ceiling 58 is sealed to the fascia 40 and pushup hood 48, the heated air cannot pass back down around the motorized roller shade 10. As such, in this arrangement, once the heated air enters the plenum 60 it is sequestered from the occupied space of the room.

Venting heated air into the plenum 60 above the ceiling 58 improves energy efficiency and has the ability to keep a room cooler as the temperature of the plenum 60 does not need to be closely maintained as does the occupied space of the room. This energy efficiency can be further improved by monitoring or even predicting temperature spikes and using the motorization provided by motorized roller shades 10 to close motorized window shades 10 and vent the heated air into the plenum 60 instead of allow substantial heat gain through windows 62. This can be controlled through a building-control-system or other system that monitors various factors such as inside temperature, outside temperature, sun position, cloud cover, among countless other variables or factors and controls the motorized window shades 10 of building 52 en masse in response thereto. As such, this arrangement can be used on a large scale manner to substantially reduce the energy costs of a building 52.

Manual to Motorized Conversion:

One persistent problem in the window shading industry is that often times the party purchasing the window shade is not the ultimate user of the window shade. This often occurs when a developer or builder purchases the shades, and for the cost they purchase manual shades, when the ultimate user (the purchaser of the house or apartment) would have spent the extra money for motorization shades.

When this occurs, the user must face one of two unpalatable decisions, endure undesirable manually operated shades or uninstall and throw away a perfectly functional manual shade and purchase an entire new motorized shade which then must be installed.

To alleviate this problem, as is presented herein, the various embodiments of shades presented herein are provided in a manually operable configuration using manual control assembly 16. These manually operable shades can be quickly and easily swapped over to motorized roller shades 10 by simply removing the manual control assembly 16 and replacing it with a motor control assembly 18, end plate 36 and end cap 38.

This allows the builder or developer to purchase a shade that has the lower cost manual control assembly 16. This allows the user, after they have purchased the property, to simply replace the manual control assembly 16 with motor control assembly 18 to convert the manual shade to a motorized shade. This allows the user to use the same bracketing, the same roller tube 12, and the same shade material 14. In addition, in the arrangement shown, counterbalance assembly 24 is closely matched to counteract the weight of the shade material 14 in the entire operating range, from fully closed to fully opened. As such, the same counterbalance assembly 24 provides smooth, easy and light operation as a manually operated shade, while also facilitating efficient motorized operation when motor control assembly 18 is installed. In addition, by counterbalance assembly 24 closely matching the weight of the shade in the entire operating range, from fully closed to fully opened, this reduces the amount of force that must be applied by motor 20 and thereby reduces the noise generated by motor 20. In addition, this reduces the cost to the user to upgrade their shades to motorized shades as the user only needs to purchase the motor control assembly 18.

In addition, by closely matching the counterbalance force of the counterbalance assembly 24 to the weight or torque profile of the shade material 14 this allows the motor control assembly 18 to have a low gear ratio which provides for low back drive which allows for manual operation of the shade material 14 without breaking the gears of gear box assembly 142 when the motor control assembly 18 is in place. Not only does this allow for the manual operation of the motorized roller shade 10, this also allows for motorized movement in response to a tug. A tug is a manual movement of the shade material 14. When the shade material 14 is tugged, the motor control assembly 18 senses the manual movement. The motor control assembly 18 may be programmed to respond to the sensed tug in various ways depending on how far the shade material 14 is tugged. In one arrangement, when the shade material 14 is manually moved more than a first predetermined amount but less than a second predetermined amount (e.g. between one quarter of an inch and one inch; or between 100 ticks and 400 ticks; or 25 rotations and 100 rotations) the motor control assembly 18 responds to the sensed tug by moving the shade material 14 the immediately above preprogrammed intermediary position such as 75% closed, 50% closed, 25% closed, or the like. This is known as a “micro-tug”. When the shade material 14 is manually moved more than a second predetermined amount but less than a third predetermined amount (e.g. between one inch and two inches; or between 400 ticks and 800 ticks; or 100 rotations and 200 rotations) the motor control assembly 18 responds to the sensed tug by moving the shade material 14 the fully open position. This is known as a “tug”. When the shade material 14 is manually moved more than a third predetermined amount but less than a third predetermined amount (e.g. more than two inches; or 800 ticks; or 200 rotations) the motor control assembly 18 recognizes that the user desires to move the shade material 14 manually to a manually set position and as such, the motor control assembly 18 tracks the position of the shade material 14 but does not move in response. This is known as a “manual movement”.

As such, the arrangement presented herein provides a great number of configurations of shades that can be easily converted from manual operation to motorized operation, or vice versa for that matter.

Battery Power or Power and Bidirectional Communication Lead:

The arrangement presented herein teaches a great number of configurations of motorized roller shade 10. Each configuration can be either powered by batteries 28 and utilize wireless communication, or powered by electrical connection to lead 30 which also provides a direct, wired, line of communication to and from the motorized roller shade 10.

Utilizing battery power provides unsurpassed simplicity of installation and installation flexibility as no lead 30 is required. This comes at the cost of having to take various steps to maximize battery life. This also requires wireless communication with and control of the motorized roller shade 10, which has its disadvantages and complexities. This is especially true in many industrial or commercial applications that have a lot of wireless signals that can cause interference problems.

Utilizing electrical connection to lead 30 provides the great benefit having essentially an unlimited amount of power which eliminates the need to periodically replace batteries. In addition, due to the direct wired communication of motorized roller shade 10 through lead 30, there is essentially no chance that a control signal transmitted over lead 30 does not get to the motorized roller shade 10 and is not acted upon. Instead, the wired communication through lead 30 to motorized roller shade 10 is almost assured. In addition, lead 30 facilitates bi-directional communication. Meaning that the motorized roller shade 10 communicates information back to the control device, such as hardwired control 34 or any other computing device that controls operation of the motorized roller shade.

This bidirectional communication provides great benefits when controlling a large number of shades, such as in a building control system of a commercial building. Bidirectional communication allows the motorized roller shades 10 to confirm they received control signals, respond with position information, report if an error occurred, report if an obstruction was detected, or report any other information. Direct connection through lead 30 allows for greater certainty in commercial applications due to the elimination of the impact of radio frequency noise has on wireless control. However, the motorized roller shades 10 can also be wirelessly controlled using antenna 124.

In addition, the hardwired controlled motor control assembly 18 can be easily replaced with a battery powered and wirelessly controlled motor control assembly 18 (or alternatively with a manual control assembly 16 for that matter). As described herein, these motorized roller shades 10 can be assembled and installed in a great number of configurations. The choice between manual control assembly 16, hardwired motor control assembly 18 or battery powered motor control assembly 18 provides even greater flexibility that allows the selection of the proper motorized window shade 10.

As such, the arrangement presented herein provides a great number of configurations of shades that can be easily converted from manual operation to motorized operation, or vice versa for that matter.

End Caps:

End caps 38 are formed of any suitable size, shape and design and are configured to cover the end of the motorized roller shade system 10 and provide a desirable aesthetic appearance. In one arrangement, as is shown, end caps 38 are generally square in shape when viewed from the end of motorized roller shade system 10 and are generally planar in shape when viewed from the front, rear, top or bottom side of the motorized roller shade system 10. End caps 38 are configured to engage and hold end plates 36 therein and facilitate fastening connection to other components of the system 10 such as fascia 40, mounting clips 46 and pushup clips 50.

In many arrangements it is not desirable for the bottom bar 82 to enter the space formed by fascia 40. In these arrangements a hard stop member 318 is used to stop the upward progress of bottom bar 82. In one arrangement, as one example, as is shown, hard stop member 318 is attached to the inward facing surface of one or both end caps 38. In the arrangement shown, as one example, hard stop member 318 is a pair of flanges positioned in spaced alignment to one another that extend inward from the inward surface of end cap 38. In this arrangement, these flanges are spaced wide enough to allow shade material 14 to pass there though, however bottom bar 82 is wider than the spacing between these flanges of hard stop member 318. As such, as the shade material 14 is raised the shade material freely passes between the flanges of hard stop member 318. Once the bottom bar 82 reaches the hard stop member 318, the bottom bar 82 is captured between the opposing spaced flanges and the upward progression of bottom bar 82 is stopped. The hard stop member 318 defines the fully opened position. The hard stop member 318 and performing a hard stop can be used to periodically reset the counter and known position of the bottom bar 82 so as to prevent position drift over time as the microprocessor 120 is programmed to know that when a hard stop occurs the shade material 14 is at a fully opened position and the counter should be at or reset to zero counts when a hard stop occurs.

This arrangement provides a simple yet effective manner of performing a hard stop at a known position. In the arrangement shown, the hard stop member 318 is placed at the lower end of end caps 38 and in this position the bottom bar 82 remains below the bottom wall 266 of fascia 40 when a hard stop occurs. In another arrangement, the hard stop member 318 may be moved upward on end plate 38 thereby allowing the bottom bar 82 to enter the fascia 40 or move above the bottom wall 266 of fascia 40 if so desired.

Wired and Wireless Control:

One benefit of the motorized roller shade system 10 presented herein is that the motor control assembly may be controlled through wired communication through direct wired connection to lead 30 as well as through the use of antenna 124. Being controllable through wired communication, as well as through wireless communication, provides substantial flexibility and ease of use. The motorized roller shades 10 may be controlled in a great number of ways. In addition, this allows for remotely positioned and battery powered motorized roller shades 10 to operate seamlessly and functionally equivalent as the hardwired controlled motorized roller shades 10.

From the above discussion, it will be appreciated that the motorized window shade systems, configurations and methods of use and installation presented herein improves upon the state of the art.

Specifically, the motorized window shade systems, configurations and methods of use and installation presented: are easier to install over prior art motorized window shades; can be installed in new ways; provide improved functionality over prior art motorized window shades; provide improved features over prior art motorized window shades; can be utilized with two way communication; can be installed on a variety of structures; can be installed in a variety of manners; can be used in a predictive manner; are energy efficient; operate quietly; can be powered in a variety of manners; can be controlled in a variety of manners; can be attached to vertical window frame members; can be attached to horizontal window frame members; can be installed by clamping onto window frame members; vent heated air into a plenum above a ceiling; are high quality; have a long useful life; can be installed prior to completion of construction; are easy to use; are easy to install; save time; save labor; are safe to install; are safe to use; are convenient to use; are energy efficient; have a rugged design; and can be used in association with a building control system or automation system, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A motorized roller shade system, comprising:
a roller tube;
the roller tube extending a length from a first end to a second end;
the roller tube having a hollow interior;
the roller tube having an axis of rotation;
a shade material;
the shade material operatively connected to the roller tube;
the shade material configured to wrap around the roller tube as the roller tube rotates around its axis of rotation;
a motor;
the motor positioned within the hollow interior of the roller tube;
the motor operatively connected to the roller tube such that operation of the motor causes rotation of the roller tube;
a counterbalance assembly;
the counterbalance assembly positioned within the hollow interior of the roller tube;
the counterbalance assembly having at least one spring;
the counterbalance assembly operatively connected to the roller tube and configured to apply a counterbalance force to the roller tube;
a first window frame clamp;
the first window frame clamp operatively connected to the roller tube and configured to support the roller tube;
wherein the first window frame clamp is configured to clamp onto a first frame member of a window frame thereby connecting the motorized roller shade to the window frame.

2. The system of claim 1, further comprising:
a second window frame clamp;
the second window frame clamp operatively connected to the roller tube and configured to support the roller tube;
wherein the second window frame clamp is configured to clamp around and hold onto a second frame member of the window frame.

3. The system of claim 1, wherein the first window frame clamp includes a clamping member that is formed in a shape that fits around the first frame member.

4. The system of claim 1, wherein the first window frame clamp includes a plurality of fasteners that are configured to tighten against the first frame member.

5. The system of claim 1, wherein the motor is positioned in an end of the roller tube and the counterbalance assembly is positioned in an opposite end of the roller tube.

6. The system of claim 1, wherein the motor is electrically connected to a lead, wherein the lead is configured to supply power to the motor from an external power source.

7. The system of claim 1, wherein the motor is electrically connected to a lead, wherein the lead is configured to supply power to the motor from an external power source as well as control signals.

8. The system of claim 1, wherein the motor and a motor controller are held within a motor housing, wherein the motor controller is electrically connected to the motor and configured to control operation of the motor.

9. The system of claim 1, wherein the first window frame clamp is connected to a pushup hood; wherein the pushup hood is configured to receive the roller tube therein.

10. The system of claim 1, further comprising:
a first axle connected to the first end of the roller tube and a second axle connected to the second end of the roller tube;
the first axle connected to a first end plate;
the second axle connected to a second end plate;
the first end plate and the second end plate connected to a fascia, wherein the fascia is configured to maintain the spacing of the first end plate and the second end plate.

11. The system of claim 1, further comprising:
a first axle connected to the first end of the roller tube and a second axle connected to the second end of the roller tube;
the first axle connected to a first end plate;
the second axle connected to a second end plate;
the first end plate and the second end plate connected to a fascia;
a pushup hood connected to the first window frame clamp;
wherein the fascia is configured to fit within and connect to the pushup hood.

12. The system of claim 1, further comprising a first power source electrically connected to the motor, the first power source formed of at least one battery, wherein the first power source is positioned within the roller tube.

13. The system of claim 1, further comprising a first power source electrically connected to the motor, the first power source formed of at least one battery, wherein the first power source is positioned exterior to the roller tube.

14. The system of claim 1, further comprising a first power source electrically connected to the motor, the first power source formed of at least one battery, wherein the first power source is an external battery tube.

15. The system of claim 1, further comprising a first power source electrically connected to the motor, the first power source formed of at least one battery, wherein the first power source is positioned within the fascia.

16. A method of installing a motorized roller shade, the steps comprising:
providing a first mounting bracket, the first mounting bracket having mounting features, the first mounting bracket configured to be connected to a structural member of a building during construction;
mounting the first mounting bracket to the structural member prior to finishing the structural member;
finishing the structural member after the first mounting bracket is mounted to the structural member;
providing a roller shade assembly having:
a roller tube;
the roller tube having a hollow interior;
shade material operatively connected roller tube and configured to wrap around the roller tube as the roller tube rotates;
a motor;
the motor positioned within the hollow interior of the roller tube;
the motor operatively connected to the roller tube such that operation of the motor causes rotation of the roller tube;
a counterbalance assembly;
the counterbalance assembly positioned within the hollow interior of the roller tube;
the counterbalance assembly having at least one spring;
the counterbalance assembly operatively connected to the roller tube and configured to apply a counterbalance force to the roller tube;
a first mounting clip;
the first mounting clip having mounting features;
installing the roller shade assembly on the structural member by mating the mounting features of the first mounting clip with the mounting features of the first mounting bracket.

17. The method of claim 16, wherein finishing the structural member includes painting the structural member.

18. The method of claim 16, wherein the structural member is a window frame.

19. The method of claim 16, further comprising the steps of:
providing a second mounting bracket, the second mounting bracket having mounting features, the second mounting bracket configured to be connected to the structural member of the building during construction;
mounting the second mounting bracket to the structural member prior to the structural member being finished;
installing the roller shade assembly on the structural member by mating the mounting features of a second mounting clip with the mounting features of the second mounting bracket.

20. The method of claim 16, wherein the structural member is an interior wall or a ceiling of the building.

21. The method of claim 16, wherein the motor is positioned in an end of the roller tube and the counterbalance assembly is positioned in an opposite end of the roller tube.

22. The method of claim 16, wherein the motor is electrically connected to a lead, wherein the lead is configured to supply power to the motor from an external power source.

23. The method of claim 16, wherein the motor and a motor controller are held within a motor housing, wherein the motor controller is electrically connected to the motor and configured to control operation of the motor.

24. The method of claim 16, wherein the roller shade assembly further includes:
a first axle connected to a first end of the roller tube and a second axle connected to a second end of the roller tube;
the first axle connected to a first end plate;
the second axle connected to a second end plate;
the first end plate and the second end plate connected to a fascia, wherein the fascia is configured to maintain the spacing of the first end plate and the second end plate.

25. The method of claim 16, further comprising a first power source electrically connected to the motor, the first power source formed of at least one battery, wherein the first power source is positioned within the roller tube.

26. The method of claim 16, wherein the roller shade further includes:
a second mounting clip;
a fascia;
wherein the first mounting clip and second mounting clip connect to one another by the fascia.

27. A method of installing a motorized roller shade, the steps comprising:
providing a first mounting bracket and a second mounting bracket, the first mounting bracket and second mounting bracket having mounting features, the first mounting bracket and second mounting bracket configured to be connected to a structural member of a building during construction;
mounting the first mounting bracket and the second mounting bracket to the structural member prior to finishing the structural member;
finishing the structural member after the first mounting bracket is mounted to the structural member;
providing a roller shade system having:
a roller tube;
the roller tube having a hollow interior;
shade material operatively connected roller tube and configured to wrap around the roller tube as the roller tube rotates;
a motor;
the motor positioned within the hollow interior of the roller tube;
the motor operatively connected to the roller tube such that operation of the motor causes rotation of the roller tube;
a counterbalance assembly;
the counterbalance assembly positioned within the hollow interior of the roller tube;
the counterbalance assembly having at least one spring;
the counterbalance assembly operatively connected to the roller tube and configured to apply a counterbalance force to the roller tube;
a fascia;
a first mounting clip and a second mounting;
the first mounting clip and second mounting clip having mounting features;
the first mounting clip and second mounting clip connected to the fascia;
installing the roller shade system on the structural member by mating the mounting features of the first mounting clip with the mounting features of the first mounting bracket and the mounting features of the second mounting clip with the mounting features of the second mounting bracket.

28. A motorized roller shade system, comprising:
a roller tube;
the roller tube extending a length from a first end to a second end;
the roller tube having a hollow interior;
the roller tube having an axis of rotation;
a shade material;
the shade material operatively connected to the roller tube;
the shade material configured to wrap around the roller tube as the roller tube rotates around its axis of rotation;
a motor;
the motor positioned within the hollow interior of the roller tube;
the motor operatively connected to the roller tube such that operation of the motor causes rotation of the roller tube;
a counterbalance assembly;
the counterbalance assembly positioned within the hollow interior of the roller tube;
the counterbalance assembly having at least one spring;
the counterbalance assembly operatively connected to the roller tube and configured to apply a counterbalance force to the roller tube;
a fascia;
the roller shade system mounted in a ceiling adjacent a window such that the ceiling seals to the fascia;
a gap positioned between the shade material and the window that vents to a plenum positioned above the ceiling such that heated air between the shade material and the window vents into the plenum.

29. The system of claim 28, wherein the fascia encloses a bottom side of the motorized roller shade system.

30. The system of claim 28, wherein the roller tube is operatively connected to the fascia.

31. The system of claim 28, wherein the motor is electrically connected to a lead, wherein the lead is configured to supply power to the motor from an external power source.

32. The system of claim 28, wherein the motor is electrically connected to a lead, wherein the lead is configured to supply power to the motor from an external power source as well as control signals.

33. The system of claim 28, wherein the motor and a motor controller are held within a motor housing, wherein the motor controller is electrically connected to the motor and configured to control operation of the motor.

34. The system of claim 28, further comprising:
a first axle connected to the first end of the roller tube and a second axle connected to the second end of the roller tube;
the first axle connected to a first end plate;
the second axle connected to a second end plate;
the first end plate and the second end plate connected to the fascia, wherein the fascia is configured to maintain the spacing of the first end plate and the second end plate.

35. The system of claim 28, further comprising:
a first axle connected to the first end of the roller tube and a second axle connected to the second end of the roller tube;
the first axle connected to a first end plate;
the second axle connected to a second end plate;
the first end plate and the second end plate connected to the fascia;
a pushup hood connected to the first window frame clamp;
wherein the fascia is configured to fit within and connect to the pushup hood.

36. The system of claim 28, further comprising a first power source electrically connected to the motor, the first power source formed of at least one battery, wherein the first power source is positioned within the roller tube.

37. A method of installing a motorized roller shade system, the steps comprising:
providing a first pushup hood, the first pushup hood configured to receive a motorized roller shade system;
installing the first pushup hood adjacent a window in a ceiling having a plenum above the ceiling;
providing a motorized roller shade assembly having:
a roller tube;
the roller tube having a hollow interior;
a shade material operatively connected roller tube and configured to wrap around the roller tube as the roller tube rotates;
a motor;
the motor positioned within the hollow interior of the roller tube;
the motor operatively connected to the roller tube such that operation of the motor causes rotation of the roller tube;
a counterbalance assembly;
the counterbalance assembly positioned within the hollow interior of the roller tube;
the counterbalance assembly having at least one spring;
the counterbalance assembly operatively connected to the roller tube and configured to apply a counterbalance force to the roller tube;
a fascia;
a first pushup clip;
installing the motorized roller shade system into the first pushup hood such that once installed the fascia is in approximate alignment with the ceiling;
venting heated air between the shade material and the window through a gap between the shade material and the window and into the plenum above the ceiling.
